(19) United States
(12) Patent Application Publication
(10) Pub. No.: US 2015/0215621 A1
(43) Pub. Date: Jul. 30, 2015

(54) RATE CONTROL USING COMPLEXITY IN VIDEO CODING

(71) Applicant: QUALCOMM Incorporated, San Diego, CA (US)

(72) Inventors: Meng Liu, San Diego, CA (US); Hsiao-Chiang Chuang, San Diego, CA (US); Hariharan Ganesh Lalgudi, San Diego, CA (US); Srikanth Alaparthi, San Diego, CA (US); Cheng-Teh Hsieh, San Diego, CA (US); Harikrishna Madadi Reddy, San Jose, CA (US); Kai Wang, San Diego, CA (US)

(21) Appl. No.: 14/332,192

(22) Filed: Jul. 15, 2014

Related U.S. Application Data
(60) Provisional application No. 61/933,513, filed on Jan. 30, 2014.

(51) Int. Cl. H04N 19/124; H04N 19/184; H04N 19/147

(52) U.S. Cl. CPC H04N 19/124; H04N 19/147; H04N 19/184

(57) ABSTRACT

In one example, a method of encoding video data includes allocating, based on a complexity of a reference frame and a quantity of bits allocated to a current frame, a quantity of bits to a current largest coding unit (LCU) included in the current frame. In this example, the method also includes determining, based on the quantity of bits allocated to the current LCU, a quantization parameter (QP) for the current LCU, and encoding the current LCU with the determined QP.

### RELATED APPLICATION

This application claims the benefit of U.S. Provisional Application No. 61/933,513, filed Jan. 30, 2014, the entire content of which is hereby incorporated by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, the VP8 standard, the VP9 standard, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a picture or a portion of a picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the spatial domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for performing rate control when encoding video data. For example, this disclosure describes techniques for allocating bits amongst frames (also referred to as “pictures,” as noted below) of a video sequence, and techniques for allocating bits amongst blocks (e.g., coding units (CUs)) and determining the quantization parameter (QP) for each block of the frames. In some examples, the rate control techniques of this disclosure may be performed when encoding video data in accordance with the High Efficiency Video Coding (HEVC) standard.

In one example, a method of encoding video data includes allocating, based on a complexity of a reference frame and a quantity of bits allocated to a current frame, a quantity of bits to a current largest coding unit (LCU) included in the current frame. In this example, the method also includes determining, based on the quantity of bits allocated to the current LCU, a QP for the current LCU, and encoding the current LCU with the determined QP.

In another example, a device for encoding video data includes a video encoder. In this example, the video encoder is configured to allocate, based on a complexity of a reference frame and a quantity of bits allocated to a current frame, a quantity of bits to a current LCU included in the current frame. In this example, the video encoder is also configured to determine, based on the quantity of bits allocated to the current LCU, a QP for the current LCU, and encode the current LCU with the determined QP.

In another example, a device for encoding video data includes means for allocating, based on a complexity of a reference frame and a quantity of bits allocated to a current frame, a quantity of bits to a current LCU included in the current frame. In this example, the device also includes means for determining, based on the quantity of bits allocated to the current LCU, a QP for the current LCU, and means for encoding the current LCU with the determined QP.

In another example, a computer-readable storage medium has stored thereon instructions that, when executed, cause one or more processors to allocate, based on a complexity of a reference frame and a quantity of bits allocated to a current frame, a quantity of bits to a current LCU included in the current frame. In this example, the instruction also cause the one or more processors to determine, based on the quantity of bits allocated to the current LCU, a QP for the current LCU, and encode the current LCU with the determined QP.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a flow diagram illustrating example operations of a video encoder to allocate bits, in accordance with one or more aspects of this disclosure.

FIG. 5 is a block diagram illustrating example components of a video encoder, in accordance with one or more aspects of this disclosure.

FIGS. 6-45B are conceptual and flow diagrams illustrating example details of operations of a video coder to perform rate control, in accordance with one or more aspects of this disclosure.

### DETAILED DESCRIPTION

In general, this disclosure relates to techniques for allocating bits amongst frames (also referred to as “pictures,” as noted below) of a video sequence, and techniques for allocating bits amongst blocks (e.g., coding units (CUs)) and determining the quantization parameter (QP) for each block of the frames. For example, a video encoder may determine a target number of bits for a frame of video data, and, based on the determined target number of bits, determine a quantization parameter (QP) for the frame of video data. As another example, a video encoder may determine a target number of bits for a largest coded unit (LCU) of video data, and, based on the determined target number of bits, determine a QP for the LCU of video data.

Video coders, such as video encoders and video decoders, are generally configured to code individual pictures of a sequence of pictures using either spatial prediction (or intra-prediction) or temporal prediction (or inter-prediction). More particularly, video coders may predict blocks of a picture using intra-prediction or inter-prediction. Video coders may code residual values for the blocks, where the residual values correspond to pixel-by-pixel differences between a predicted block and an original (that is, uncoded) block. Video coders may transform a residual block to convert values of the residual block from a pixel domain to a frequency domain. Moreover, video coders may quantize transform coefficients of the transformed residual block using a particular degree of quantization indicated by a quantization parameter (QP).

The value of the QP utilized by a video coder has a significant impact on the number of bits used to represent the video. With respect to the High Efficiency Video Coding (HEVC) standard, as an example, a higher QP will typically result in relatively fewer bits used when compared to a lower QP and vice versa. As the link between a video encoder and a video decoder has a limited bandwidth, it may be desirable to control the QP, and therefore, to control the amount of information that must be communicated via the link. In other words, it may be desirable to control the data rate (bits per period of time) using a QP.

In some examples, the data rate may be controlled with the use of a basic unit and a linear model. The basic unit can be a frame, a slice, or block, such as a macroblock (MB) or CU. The linear model may be used to predict the mean absolute difference (MAD) between a current basic unit in a current frame and a previous basic unit in the co-located position of a previous frame. A quadratic rate-distortion (R-D) model may be used to calculate the corresponding quantization parameter, which may then be used for the rate distortion optimization for each MB in the current basic unit. In some examples, a quadratic pixel-based unified rate-quantization (URQ) model may also be used for rate control.

In some examples, the data rate may be controlled with the use of an R-λ model. For instance, an R-λ model may achieves the allocated bit rate by: λ=α·bpp^{β} (where X is the slope of R-D curve, and bpp is bit per pixel) and then calculating the QP using the logarithm algorithm: QP=4.2005 ln λ+13.7122.

In some examples, the data rate may be controlled by using the following equation: R=α×X/qscale, where a is the model parameter, R is the coding rate, X is the complexity estimation for the current picture, and qscale is the quantization scale.

However, rate control using the above examples may be undesirable in some instances. For instance, the above examples require the use of relatively complicated models and model parameters. Specifically, in the above examples, the parameters are always updated using Least-squares estimation, and the parameters of the rate control models may not be accurate and may need to update LCU by LCU which may be time consuming. Additionally, in the above examples, the prediction models may need to be updated LCU by LCU, which is based on information of previously coded LCUs, and requires using the average information of previous LCUs. However, because the content characteristics of different LCUs may be quite different, the models may produce large errors. Additionally, in the above examples, the content of LCU may not be fully used, and the QP of I frame may not be properly determined, because I frame data is either from a previous inter frame model or the current I frame, which is far away from current I frame. Finally, in the above examples, the complexity may be too high and not suitable for hardware.

In other words, rate control is an important technique in video coding in order to ensure that a bit-stream meets transmission bandwidth and/or storage constraints. However, there may be some problems in rate control that prevent a good bit rate control accuracy and good rate distortion performance from being achieved, especially under the constraint of hardware and performance. LCU rate control, which may be implemented in hardware, may have many limitations which may lead to inaccurate bit allocation in different LCUs and inaccurate QP determination. The content and information of LCUs and their neighbors may not be fully utilized in different algorithms due to limitations of hardware and the complexity of algorithms. Therefore, it may be desirable to design an algorithm in hardware for better bit allocation for LCU level rate control, better LCU level and frame level QP estimation, and to satisfy hardware performance and implementation limitation.

In accordance with the techniques of this disclosure, a video encoder may use rate control techniques to allocate a specified number of bits amongst frames, and for each frame, allocate the bits amongst blocks such as LCUs. The encoder may utilize frame level rate control to determine QPs for one or more frames. In some examples, the encoder may utilize LCU level rate control to determine the QPs for one or more LCUs. In some examples, the encoder may utilize the ρ-domain, such as when allocating bits, because the ρ-domain may provide a simple yet very efficient relationship between the bits and percentage of zero quantization parameters. Additionally, the encoder may utilize information from the rate control techniques to perform byte based slicing (i.e., to determine the slice boundary for each frame).

To perform frame level rate control, an encoder may determine a number of target bits to allocate to a time window. A time window may be set to include certain number of frames and the window may move along time slot. In some examples, the encoder may allocate the bits to the sliding time window in accordance with equation (1) where Wᵢ is the target bits for time window at time i, R/f is the average bits for each frame, B_{coded} is the coded bit of frame i−1.

$${W}_{i} = {W}_{i - 1} + \frac{R}{f} - {B}_{coded} \qquad ( 1 )$$

In some examples, the encoder may further allocate the bits to each frame according to the complexity of different hierarchical level frames. For example, the encoder may allocate the bits in accordance with equation (2), below, where k is the layer index, j is the frame number, Nᵢ is the number of frames in layer i, δ is a step, and Cᵢ is the complexity of layer i. In some examples, the encoder may determine the complexity of a layer i in accordance with equation (3) where QPᵢ^{coded} is the QP of frame i and Bitᵢ^{coded} is the number of bits used to encode frame i.

$$\begin{matrix}{Bit}_{k}^{j} = \frac{{C}_{k}}{{Σ}_{i = 0}^{3} {C}_{i} \cdot {N}_{i}} \cdot {W}_{j} + δ ( {Buffer}_{target} - {Buffer}_{current} ) & ( 2 ) \\ {C}_{i} = {QP}_{i}^{coded} \cdot {Bit}_{i}^{coded} & ( 3 )\end{matrix}$$

In some examples, the complexity may be updated according to different hierarchical layers such that each different hierarchical layer may have its own complexity and may be updated in the same layer frame by frame. The target bits may then be used to determine the QP. As shown in equation (2), the status of a buffer may be considered when allocating bits. For instance, the status of a hypothetical reference decoder (HDR) buffer, which is related to the delay of video application, may be considered in rate allocation such that the buffer is less likely to overflow or underflow.

In some examples, the encoder may determine the percentage of zero quantized coefficients. For instance, the encoder may utilize a linear R-ρ model to determine the percentage of zero quantized coefficients in accordance with equation (4) where R is the target bits of current frame (which may correspond to Bitₖ^{j} of equation (2), above), R_{header} is the predicted header bits of current frame, ρ is the percentage of zero quantization parameters, and θ is one parameter which is decided by the complexity of picture, and it may be predicted from previous frames

R−R_{header}=θ(1−ρ) (4)

In some examples, the encoder may determine ρ in accordance with equation (5) where p(x) is the distribution of DCT coefficient x, and 4 is the dead zone which may be determined by the quantization step.

ρ(Δ)=Σ_{x<Δ}p(x) (5)

In some examples, the encoder may determine the target ρ based on the target bits R, and parameter θ. The encoder may then use the determined ρ to look up the p-Q table and determine the QP of current frame.

In some examples, when performing frame-level RC, the encoder may use ρ-QP tables of different levels to determine a QP for a current frame QP. In some examples, the encoder may generate the ρ-QP tables by using ρ-QP table management techniques which may be controlled by ρ-QP model. For instance, ρ-QP table entries corresponding to operating QP range may be generated by a HW ρ-QP table management module which may be included in the encoder.

In some examples, a ρ-QP table may include the number of nonzero quantization coefficients and the corresponding QP. However, in some examples, the encoder may only update a portion of ρ-QP table entries. Therefore, in accordance with one or more techniques of this disclosure, the size of the ρ-QP lookup table can be reduced. For example, the size of the ρ-QP lookup table for I pictures may be reduced by one-half (½). As another example, the size of the ρ-QP lookup table for other picture types (e.g., P pictures and B pictures) may be reduced by one-eighth (⅛).

In some examples, when performing ρ-QP table management, the encoder may consider an operating QP range when generating a ρ-QP table. The operating QP range may be determined based on a current frame QP value, a minusDeltaQP value, and a plusDeltaQP value. In some examples, the minusDeltaQP value and the plusDeltaQP value may be specified by user and may operate to constrain QP variations between adjacent frames. In other words, if the QP of the current frame is known, the QP values outside of minusDeltaQP and plusDeltaQP will not be used when determining the QP of the next frame because the QP of the next frame is limited by the minusDeltaQP value and the plusDeltaQP value. As such, the encoder may generate ρ-QP table entries from QP-minusDeltaQP to QP+plusDeltaQP for a given current frame QP. In other words, ρ-QP table entries from QP-minusDeltaQP to QP+plusDeltaQP may be maintained in order to reduce complexity.

In some examples, the nonzero quantization coefficients may be accumulated if the coefficient is larger than a scale step. For instance, the nonzero quantization coefficients may be accumulated if equation (6) evaluates as true, where C is the coefficient, and S(QP) is the scale step.

C>S(QP)?1:0) (6)

In some examples, the number of computations may be reduced if equation (7) evaluates as true because these coefficients will be zero for all these QPs in the QP range.

C<S(QP−minusDeltaQP) (7)

Similarly, in some examples, the number of computations may be reduced if equation (8) evaluates as true because these coefficients will be one for all these QPs in the QP range.

C>S(QP−plusDeltaQP) (8)

In other words, the encoder may only need the scale step of each QP in the QP range. In some examples, such as examples involving the HEVC standard, the scale step may be the same for all the frequencies but may vary according to size of TU and QP.

In some examples, the scale QP table may be fixed. In some examples, the scale QP table may be calculated in firmware (FW) and sent to transform and rate control engine (TRE) from software interface (SWI). In some examples, the scale QP table may be determined in accordance with equation (9) where uiQ is a QP-dependent scaling factor which may be based on QP mod 6 in accordance with Table 1, below, iAddQ is an offset for rounding that may be determined in accordance with equation (10), and iQbits is a value that may be determined in accordance with equation (11).

| | |
|---|---|
| scaleQPTable[QP] = (((1 << iQBits) − iAddQ) << 3)/uiQ | (9) |
| if(sliceType == I_SLICE) | |
| iAddQ = 171 << (iQBits − 9) | (10) |
| else | |
| iAddQ = 85 << (iQBits − 9) | |
| iQBits = 21 + [QP/6] − log₂(tu_size) | (11) |

TABLE 1

| QP % 6 | 0 | 1 | 2 | 3 | 4 | 5 |
|---|---|---|---|---|---|---|
| uiQ | 26214 | 23302 | 20560 | 18396 | 16384 | 14564 |

In some examples, the scale QP table may be determined for a particular TU size and other TU sizes may be accommodated by shifting the scale QP table. In some examples, the particular TU size for which the scale QP table may be determined is four (4). An example scale QP table for used with inter frame coding is shown in Table 2, and an example scale QP table for used with intra frame coding is shown in Table 3.

TABLE 2

| | | | | | | | | |
|---|---|---|---|---|---|---|---|---|
| Inter | QP | 0 | 1 | 2 | 3 | 4 | 5 | 6 |
| frame | Scale | 134 | 150 | 170 | 190 | 214 | 240 | 267 |
| | QP | 7 | 8 | 9 | 10 | 11 | 12 | 13 |
| | Scale | 300 | 341 | 381 | 427 | 481 | 534 | 601 |
| | QP | 14 | 15 | 16 | 17 | 18 | 19 | 20 |
| | Scale | 681 | 761 | 854 | 961 | 1068 | 1201 | 1361 |
| | QP | 21 | 22 | 23 | 24 | 25 | 26 | 27 |
| | Scale | 1521 | 1708 | 1922 | 2135 | 2402 | 2722 | 3043 |
| | QP | 28 | 29 | 30 | 31 | 32 | 33 | 34 |
| | Scale | 3416 | 3843 | 4270 | 4804 | 5445 | 6085 | 6832 |
| | QP | 35 | 36 | 37 | 38 | 39 | 40 | 41 |
| | Scale | 7686 | 8540 | 9608 | 10889 | 12170 | 13664 | 15372 |
| | QP | 42 | 43 | 44 | 45 | 46 | 47 | 48 |
| | Scale | 17081 | 19215 | 21778 | 24339 | 27328 | 30743 | 34161 |
| | QP | 49 | 50 | 51 | | | | |
| | Scale | 38430 | 43555 | 48678 | | | | |

TABLE 3

| | | | | | | | | |
|---|---|---|---|---|---|---|---|---|
| Inter | QP | 0 | 1 | 2 | 3 | 4 | 5 | 6 |
| frame | Scale | 107 | 120 | 136 | 152 | 171 | 192 | 213 |
| | QP | 7 | 8 | 9 | 10 | 11 | 12 | 13 |
| | Scale | 240 | 272 | 304 | 341 | 384 | 427 | 480 |
| | QP | 14 | 15 | 16 | 17 | 18 | 19 | 20 |
| | Scale | 544 | 608 | 682 | 767 | 853 | 959 | 1087 |
| | QP | 21 | 22 | 23 | 24 | 25 | 26 | 27 |
| | Scale | 1215 | 1364 | 1535 | 1705 | 1918 | 2174 | 2430 |
| | QP | 28 | 29 | 30 | 31 | 32 | 33 | 34 |
| | Scale | 2728 | 3069 | 3410 | 3836 | 4348 | 4860 | 5456 |
| | QP | 35 | 36 | 37 | 38 | 39 | 40 | 41 |
| | Scale | 6138 | 6820 | 7673 | 8696 | 9719 | 10912 | 12276 |
| | QP | 42 | 43 | 44 | 45 | 46 | 47 | 48 |
| | Scale | 13640 | 15345 | 17392 | 19437 | 21824 | 24552 | 27281 |
| | QP | 49 | 50 | 51 | | | | |
| | Scale | 30690 | 34783 | 38874 | | | | |

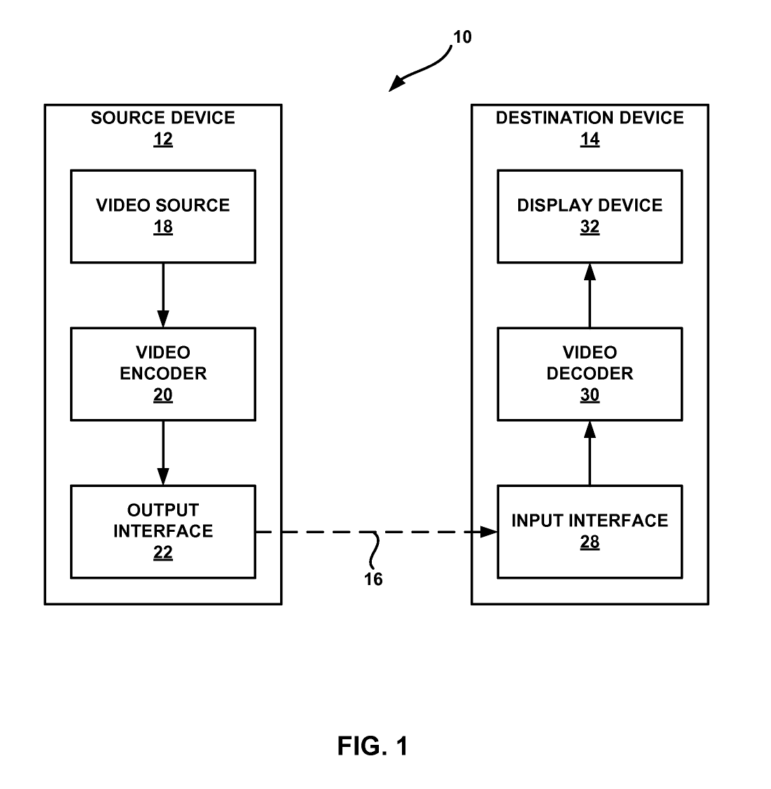

As stated above, the values included in the scale-QP look-up table (LUT) may be based on QP, intra or inter slices, and transform unit (TU) (described below, for example, with respect to FIG. 1 and HEVC) size. Additionally, as stated above, because the encoder can calculate LUTs with the same mode (i.e., intra or inter) by shifting from another one, only one LUT for each mode may be needed. In other words, in some examples, only the LUTs for 4×4 TU for each slice may be used. As a result, the encoder may operate more efficiently because it may only load the LUT once per slice. The HW ρ-QP Table Manager of the encoder may receive a DCT coefficient and may determine a scale step to generate nonzero level after quantization from the Scale-QP LUT. The entry number in ρ-QP Table, which may be specified by the Scale-QP LUT, may increase by one. Encoder 20 may then calculate the ρ for each QP. In some examples, the Scale-QP LUT may be 52*2*16 bits, and the ρ-QP table may be 52*24 bits.

In some examples, when performing frame level RC, the encoder may also need the coded ρ of each frame (the number of nonzero quantization coefficients). In some examples, the nonzero coefficients may be counted and feedback to firmware.

To perform LCU level rate control, the encoder may determine a QP for each LCU. In some examples, the encoder may base the QP determination on, but not necessarily only, the previously coded blocks and the remaining bits. In some examples, the encoder may store the complexity of every LCU for bit allocation and QP determination. In some examples, the encoder may derive the complexity information directly from a motion estimation block such that no extra cost is increased.

In some examples, LCU level rate control may only be enabled when frame rate control is enabled. In some examples, if frame level rate control is disabled, the encoder may not utilize the LCU level rate control blocks including rho-QP (ρ-QP) management block. However, even if LCU rate control is not enabled, if frame level rate control is enabled, the encoder may still utilize the ρ-QP management block for frame level rate control.

Due to the spatial variety of different LCUs, it may useful to allocate the bit budget to every LCU according to the complexity of each LCU. The complexity of current LCU may be generated during motion estimation and compensation (MEC). The encoder may then allocate the bit budget of current LCU based on the complexity of a complexity reference frame. In some examples, the complexity reference frame may be the previous frame.

The encoder may allocate the remaining bits to the current LCU based on the ratio of complexity of current LCU and the remaining complexity of current frame. However, because the remaining complexity of the current frame has not yet been determined, the encoder may use the ratio of collocated LCU and the remaining complexity of previous frame in place of the remaining complexity of the current frame. For instance, the encoder may allocate the remaining bits in accordance with equation (12) where B_{currLCU} is the target bits for current LCU, B_{frame} the target bits for current frame, B_{coded} is the bits coded, C_{remaining}^{prevFrame} is the complexity of collocated previous frame LCUs of remaining LCUs in current frame, C_{Collocated}^{prevFrame} is the collocated LCU in previous frame.

$${B}_{currLCU} = \frac{{B}_{frame} - {B}_{coded}}{{C}_{remaining}^{prevFrame}} \cdot {C}_{Collocated}^{prevFrame} \qquad ( 12 )$$

The encoder may then determine which neighbor (e.g., top left, top, and top right) of the current LCU is most similar to the current LCU. In some examples, the most similar LCU may be the LCU with the minimum complexity difference between the reference and the current LCU (i.e., min|C_{currLCU}^{real}−C_{candidate}^{real}|). The encoder may then use the ratio between the most similar neighboring LCU and the current LCU to determine the QP for the current LCU. For instance, the encoder may determine the ratio in accordance with equation (13) where C_{currLCU}^{real} is the complexity of the current LCU (which may be determined during MEC), B_{CodedLCU} and C_{CodedLCU}^{real} are the bits and complexity of the reference LCU of the most similar neighboring LCU. As the encoder may not be able to determine the value of C_{currLCU}^{real}, the value of the collocated LCU in the reference frame (i.e., C_{Collocated}^{prevFrame}) may be used in its place.

$$Ratio = \frac{{B}_{currLCU} \text{/} {C}_{currLCU}^{real}}{{B}_{CodedLCU} \text{/} {C}_{CodedLCU}^{real}} \qquad ( 13 )$$

In some examples, it may be desirable to perform certain calculations without division. As such, equations (12) and (13) may be rewritten into equation (14) such that no division is used.

Ratio·B_{CodedLCU}·C_{currLCU}^{real}·C_{remaining}^{prevFrame}=(B_{frame}−B_{coded})·C_{Collocated}^{prevFrame}·C_{CodedLCU}^{real} (14)

In some examples, the encoder may select the most similar neighboring LCU as the neighboring LCU with the smallest complexity difference as compared to the current LCU. For instance, the encoder may compare the complexity of each neighboring LCU with the complexity of the current LCU in accordance with equation (15) where C_{currLCU}^{real} is the complexity of the current LCU, and C_{candidate}^{real} is the complexity of one of the neighboring LCUs. Again, as the encoder may not be able to determine the value of C_{currLCU}^{real}, the value of the collocated LCU in the reference frame (i.e., C_{Collocated}^{prevFrame}) may be used in its place.

min|C_{currLCU}^{real}−C_{candidate}^{real}| (15)

In some examples, the encoder may determine the availability of the neighboring LCUs because, if a neighboring LCU is skipped, the skipped LCU would not be considered as a candidate. In some examples, such as where all neighboring LCUs are skipped, the encoder may use the average ration of the current frame as a reference. In some examples, the encoder may determine the average ratio in accordance with equation (16) where C^{currentFrame} is the complexity of current frame.

$$Ratio = \frac{{B}_{currLCU} \text{/} {C}_{currLCU}^{real}}{{B}_{frame} \text{/} {C}^{current frame}} \qquad ( 16 )$$

However, as the actual value of C^{currentFrame} is not yet available, the encoder may predict the value of C^{currentFrame} based on the previous frame. For instance, the encoder may predict the value of C^{currentFrame} in accordance with equation (17) where C_{coded}^{currFrame} is the complexity of coded LCUs in current frame, and C_{coded}^{prevFrame} is the complexity of collocated coded LCUs in previous frame.

$${C}^{currFrame} = {C}^{prevFrame} \cdot \frac{{C}_{coded}^{currFrame}}{{C}_{coded}^{prevFrame}} \qquad ( 17 )$$

Typically, the previous frame of an I frame is a B frame and the previous frame of the first B frame after an I frame will be the I frame. However, in some examples, the rate control techniques may be effected by the differences between intra coded frames and inter coded frames. As such, in some examples, when performing rate control on the first B frame after an I frame, the encoder may use the last B frame as the complexity reference. Additionally, in some examples, when performing rate control on an I frame, the encoder may use the complexity of the best intra mode in previous B frame as its complexity reference, e.g., because the previous I frame may be too far away, and thus may not have a complexity similar to the current frame. In this way, the encoder may increase the accuracy of the reference frame complexity information.

As discussed above, the encoder may also use the complexity information to determine the frame level QP when performing frame level rate control. Therefore in some examples, the encoder may also utilize these techniques when selecting a complexity reference frame when performing frame level rate control. For example, when performing frame level rate control on an I frame, the encoder may use the best intra complexity of previous B frame to adjust the accumulating updated I frame complexity to get much better complexity for the current I frame. In this way, the encoder may improve the accuracy of the I frame rate control which may benefit the whole group of picture (GOP) because the rate control of the following B frame may also be improved.

In some examples, the encoder may also adjust the lambda (λ) of each LCU. In other words, because the lambda may have a role in the mode decision which may affect the bits to code the LCU greatly, the lambda of each LCU may be adjusted.

FIG. 1 is a block diagram illustrating an example video encoding and decoding system 10 that may perform the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, link 16 may correspond to a storage medium that may store the encoded video data generated by source device 12 and that destination device 14 may access as desired via disk access or card access. The storage medium may include any of a variety of locally accessed data storage media such as Blu-ray discs, DVDs, CD-ROMs, flash memory, or any other suitable digital storage media for storing encoded video data. In a further example, link 16 may correspond to a file server or another intermediate storage device that may hold the encoded video generated by source device 12 and that destination device 14 may access as desired via streaming or download. The file server may be any type of server capable of storing encoded video data and transmitting that encoded video data to the destination device 14 Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the file server may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also be stored onto a storage medium or a file server for later access by destination device 14 for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on a data storage medium, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 may operate according to a video compression standard, such as the High Efficiency Video Coding (HEVC) standard, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. For example, while certain aspects of this disclosure may be described with respect to HEVC, the techniques may be applied to other proprietary or non-proprietary standards such as H.264, MPEG4, VP8 and VP9. Other examples of video compression standards include MPEG-2 and ITU-T H.263.

With respect to HEVC, the HEVC standardization efforts are based on a model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard, but is not tied to a particular size. A slice includes a number of consecutive treeblocks in coding order. A video frame or picture may be partitioned into one or more slices. Each treeblock may be split into coding units (CUs) according to a quadtree structure. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be square or non-square in shape. Syntax data associated with a CU may also describe, for example, partitioning of the CU into one or more TUs according to a quadtree. A TU may be partitioned to be square or non-square in shape.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0 or List 1) for the motion vector.

In general, a TU is used for the transform and quantization processes. A CU having one or more PUs may also include one or more TUs. Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. According to aspects of this disclosure, video encoder 20 may perform the techniques of this disclosure to provide rate control for an encoded bitstream including, for example, allocating bits by controlling quantization parameters (QPs), as described herein.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), probability interval partitioning entropy codes (PIPE), or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In addition to signaling the encoded video data in a bitstream to video decoder 30 in destination device 14, video encoder 20 may also decode the encoded video data and reconstruct the blocks within a video frame or picture for use as reference data during the intra- or inter-prediction process for subsequently coded blocks.

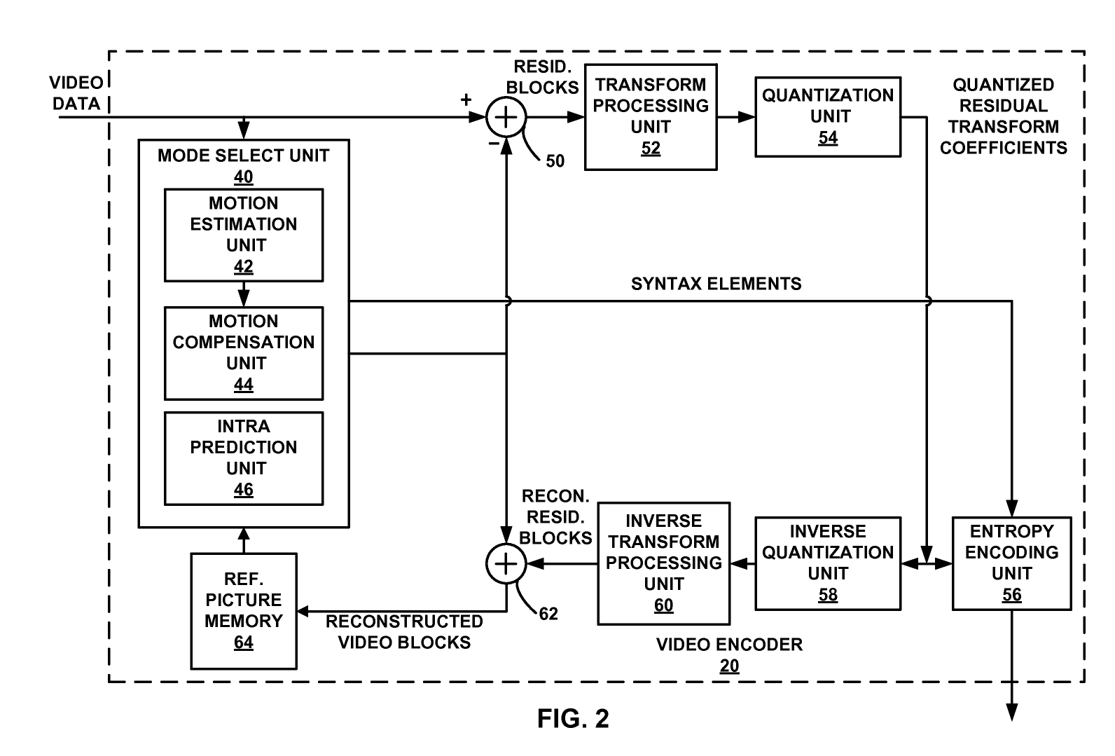

FIG. 2 is a block diagram illustrating an example of video encoder 20 that may implement the techniques described in this disclosure for performing rate control. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes mode select unit 40, motion estimation unit 42, motion compensation unit 44, intra prediction processing unit 46, reference picture memory 64, summer 50, transform processing unit 52, quantization unit 54, and entropy encoding unit 56. For video block reconstruction, video encoder 20 also includes inverse quantization unit 58, inverse transform processing unit 60, and summer 62.

As shown in FIG. 2, video encoder 20 receives a current video block within a video slice to be encoded. The slice may be divided into multiple video blocks. Mode select unit 40 may select one of the coding modes, intra or inter, for the current video block based on error results. If the intra or inter modes are selected, mode selection unit 40 provides the resulting intra- or inter-coded block to summer 50 to generate residual block data and to summer 62 to reconstruct the encoded block for use as a reference block within a reference picture stored in reference picture memory 64. Intra prediction processing unit 46 performs intra-predictive coding of the current video block relative to one or more neighboring blocks in the same frame or slice as the current block to be coded to provide spatial compression. Motion estimation unit 42 and motion compensation unit 44 perform inter-predictive coding of the current video block relative to one or more predictive blocks in one or more reference pictures to provide temporal compression.

In the case of inter-coding, motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may calculate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

After motion compensation unit 44 generates the predictive block for the current video block, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter (QP). In some examples, quantization unit 54 may then perform a scan of the matrix including the quantized transform coefficients. Alternatively, entropy encoding unit 56 may perform the scan.

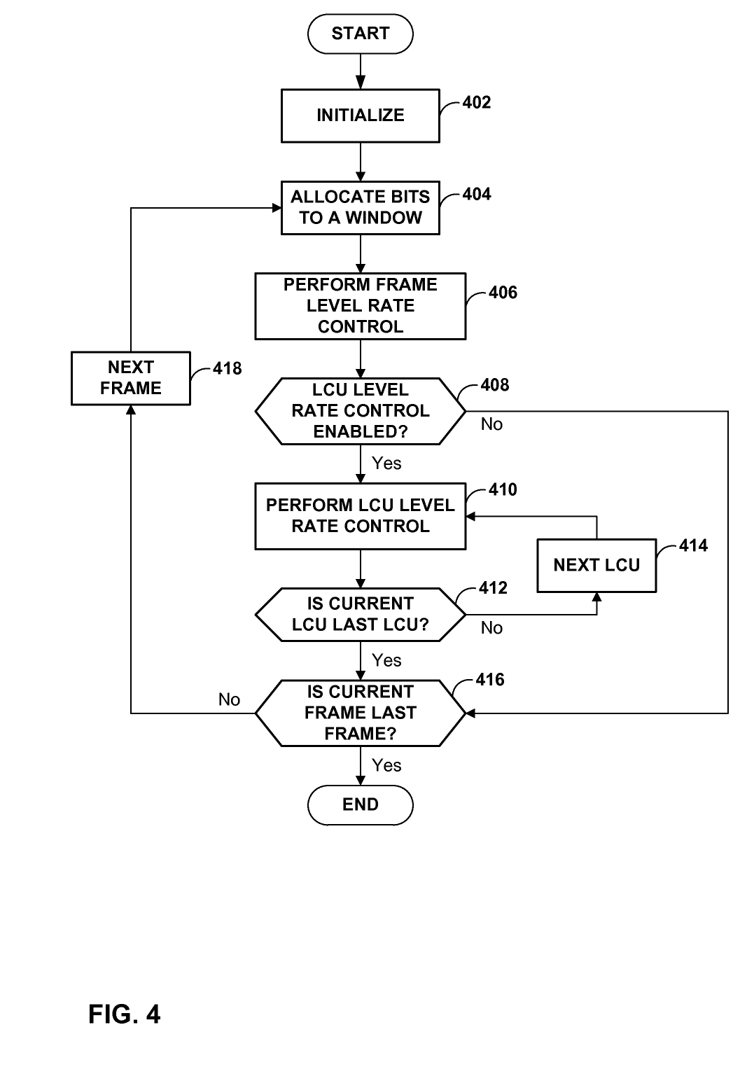

In accordance with the techniques of this disclosure, video encoder 20 may use rate control techniques to allocate a specified number of bits amongst frames, and for each frame, allocate the bits amongst LCUs. In some examples, quantization unit 54 of video encoder 20 may perform one or more operations to allocate a specified number of bits amongst frames, and for each frame, allocate the bits amongst LCUs. Video encoder 20 may utilize frame level rate control to determine QPs for one or more frames. In some examples, video encoder 20 may utilize LCU level rate control to determine the QPs for one or more LCUs. In some examples, the encoder may utilize information from the rate control techniques to perform byte based slicing (i.e., to determine the slice boundary for each frame). Further details of example rate control techniques are provided below with reference to FIG. 4.

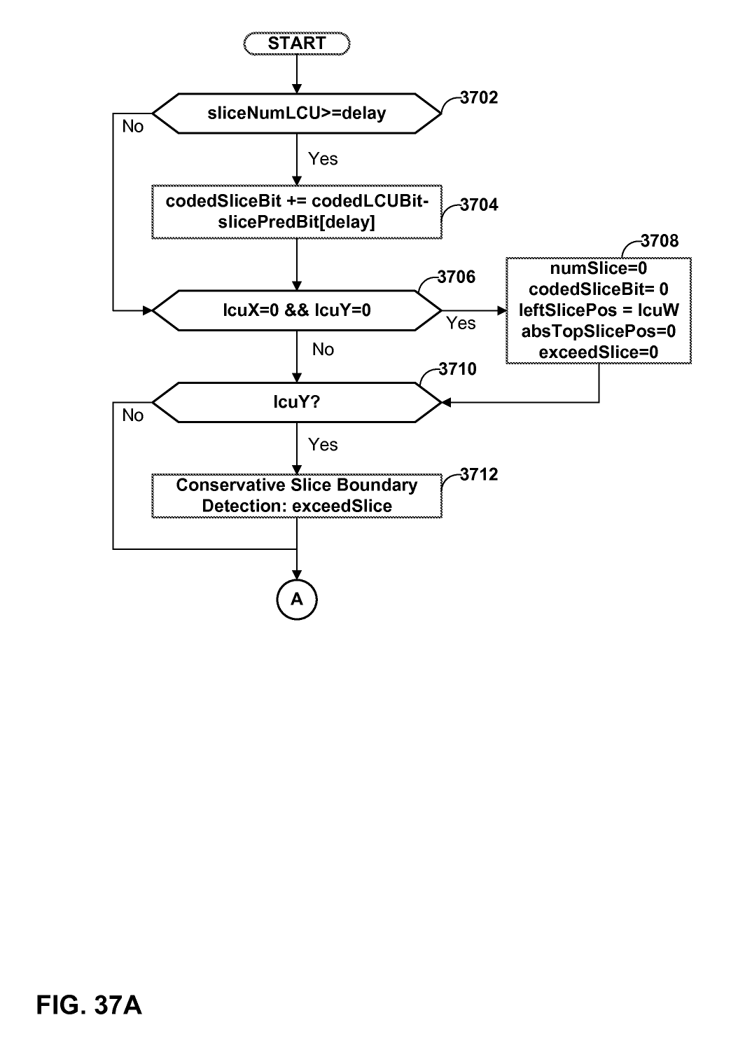

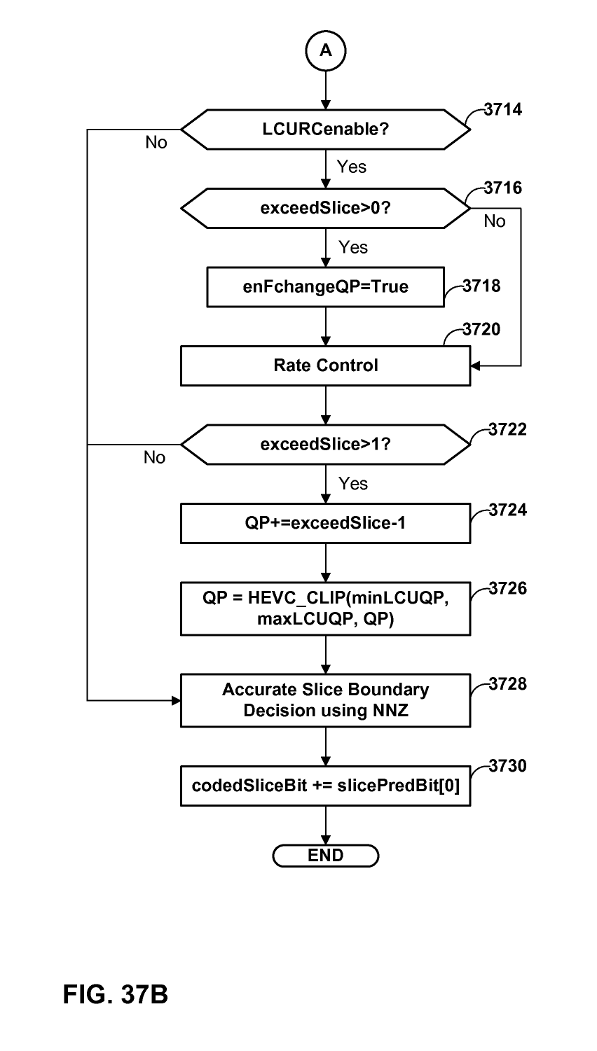

In some examples, video encoder 20 may utilize the information from the rate control techniques to perform slicing. Video encoder 20 may use slicing to determine the slice boundary for each frame. When slicing, video encoder 20 may attempt to predict the bits for the current slice and prevent it from exceeding the target for each slice. In some examples, such as a 1D single stage case, bit feedback may be used to perform accurate byte-slicing. In some examples, bin count may be used to perform accurate byte-slicing. In some examples, video encoder 20 may perform slicing in accordance with the techniques of FIGS. 37A-37B.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), or another entropy encoding technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block of a reference picture for storage in reference picture memory 64. The reference block may be used by motion estimation unit 42 and motion compensation unit 44 as a reference block to inter-predict a block in a subsequent video frame or picture.

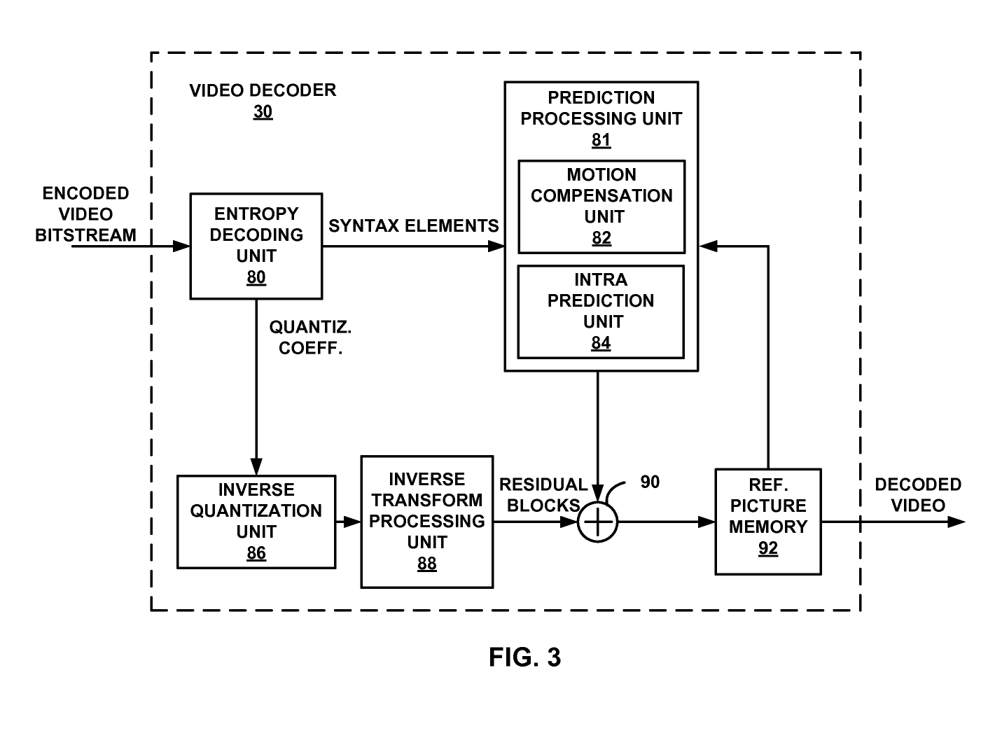

FIG. 3 is a block diagram illustrating an example of a video decoder 30 that may implement the techniques described in this disclosure. In the example of FIG. 3, video decoder 30 includes an entropy decoding unit 80, a prediction processing unit 81, an inverse quantization unit 86, an inverse transform processing unit 88, a summer 90, and a reference picture memory 92. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20. When the represented video blocks in the bitstream include compressed video data, entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at a sequence level, a picture level, a slice level and/or a video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B or P) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. Motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. The decoded video blocks in a given picture are then stored in reference picture memory 92, which stores reference pictures used for subsequent motion compensation. Reference picture memory 92 also stores decoded video for later presentation on a display device, such as display device 32 of FIG. 1.

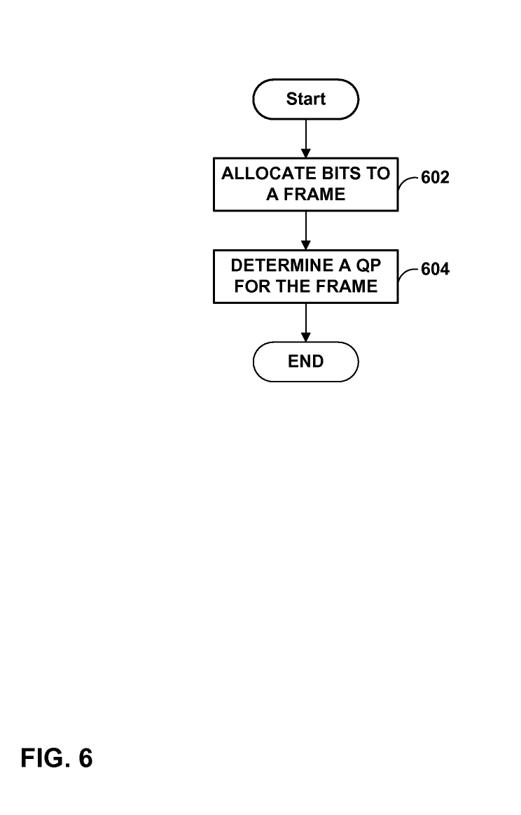

FIG. 4 is a flow diagram illustrating example operations of a video coder to perform rate control, in accordance with one or more examples of this disclosure. The techniques of FIG. 4 may be performed by a video encoder, such a video encoder 20 illustrated in FIG. 1 and FIG. 2, or a variety of other processor(s) configured for coding video data. For purposes of illustration, the techniques of FIG. 4 are described within the context of video encoder 20 of FIG. 1 and FIG. 2, although video encoders having configurations different than that of video encoder 20 may perform the techniques of FIG. 4. Example details of the techniques are discussed below with reference to FIGS. 6-45B.

In accordance with one or more techniques of this disclosure, video encoder 20 may perform one or more operations to initialize (402). For instance, video encoder 20 may receive video data to be encoded. Video encoder 20 may determine a number of target bits to allocate to a time window i (404). A time window may be set to include certain number of frames and the window may move along time slot. In some examples, video encoder 20 may allocate the bits to the sliding time window in accordance with equation (1), above, where Wᵢ is the target bits for time window at time i, R/f is the average bits for each frame, B_{coded} is the coded bit of frame i−1.

Video encoder 20 may perform frame level rate control (406). For instance, video encoder 20 may allocate a quantity of bits to a current frame and determine a QP for the current frame. In some examples, video encoder 20 may perform frame level rate control in accordance with the techniques of FIG. 6.

Video encoder 20 may determine whether or not LCU level rate control is enabled for the LCUs included in the current frame (408). For instance, one or more configuration settings of video encoder 20 may indicate whether or not LCU level rate control is enabled for the LCUs included in the current frame. In some examples, LCU level rate control may only be enabled when frame rate control is enabled. In some examples, if frame level rate control is disabled, video encoder 20 may not utilize the LCU level rate control blocks including rho-QP management block. However, even if LCU rate control is not enabled, if frame level rate control is enabled, video encoder 20 may still utilize the ρ-QP management block for frame level rate control.

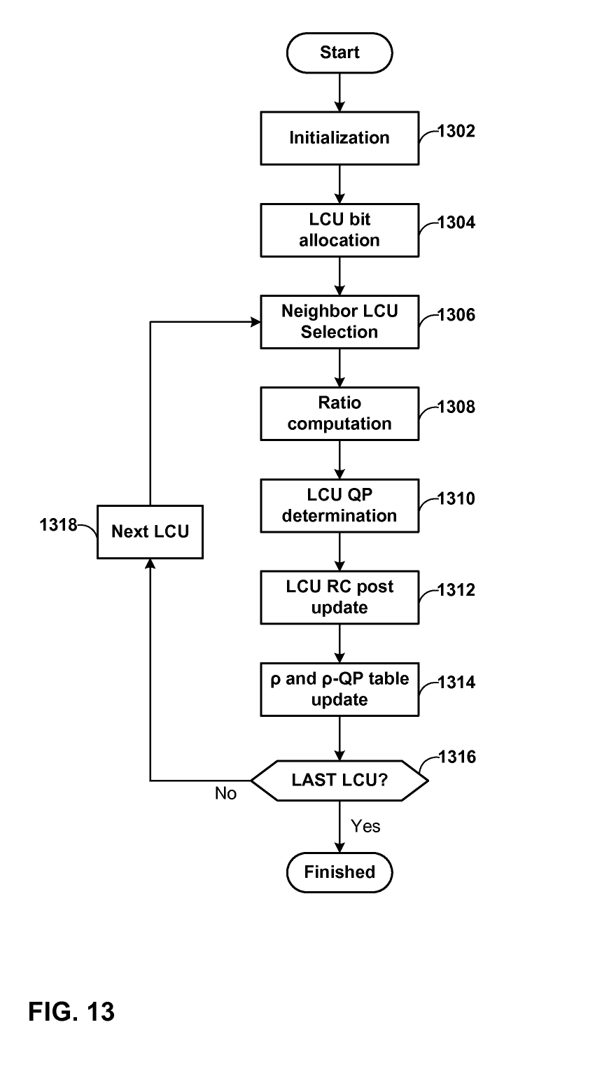

If LCU level rate control is enabled for the LCUs included in the current frame (“Yes” branch of 408), video encoder 20 may perform LCU level rate control for the LCUs included in the current frame (410). In some examples, to perform LCU level rate control, encoder 20 may determine a QP for each LCU. For instance, video encoder 20 may allocate a quantity of bits to a current LCU and determine a QP for the current LCU. In some examples, encoder 20 may base the QP determination on, but not necessarily only, the previously coded blocks and the remaining bits. In some examples, video encoder 20 may store the complexity of every LCU for bit allocation and QP determination. In some examples, video encoder 20 may derive the complexity information directly from a motion estimation block such that no extra cost is increased. In some examples, video encoder 20 may perform LCU level rate control in accordance with the techniques of FIG. 13.

Video encoder 20 may determine whether or not the current LCU is the last LCU in the current frame (412). If the current LCU is not the last LCU in the current frame (“No” branch of 412), video encoder 20 may advance to the next LCU (414), and perform LCU level rate control for the next LCU (410). If the current LCU is the last LCU in the current frame (“Yes” branch of 412) or if LCU level rate control is not enabled for the LCUs included in the current frame (“No” branch of 408), video encoder 20 may determine whether or not the current frame is the last frame (416). If the current frame is not the last frame (“No” branch of 416), video encoder 20 may advance to the next frame (418), and allocate bits to a window based on the next frame (404). If the current frame is the last frame (“Yes” branch of 416), video encoder 20 complete the rate control techniques.

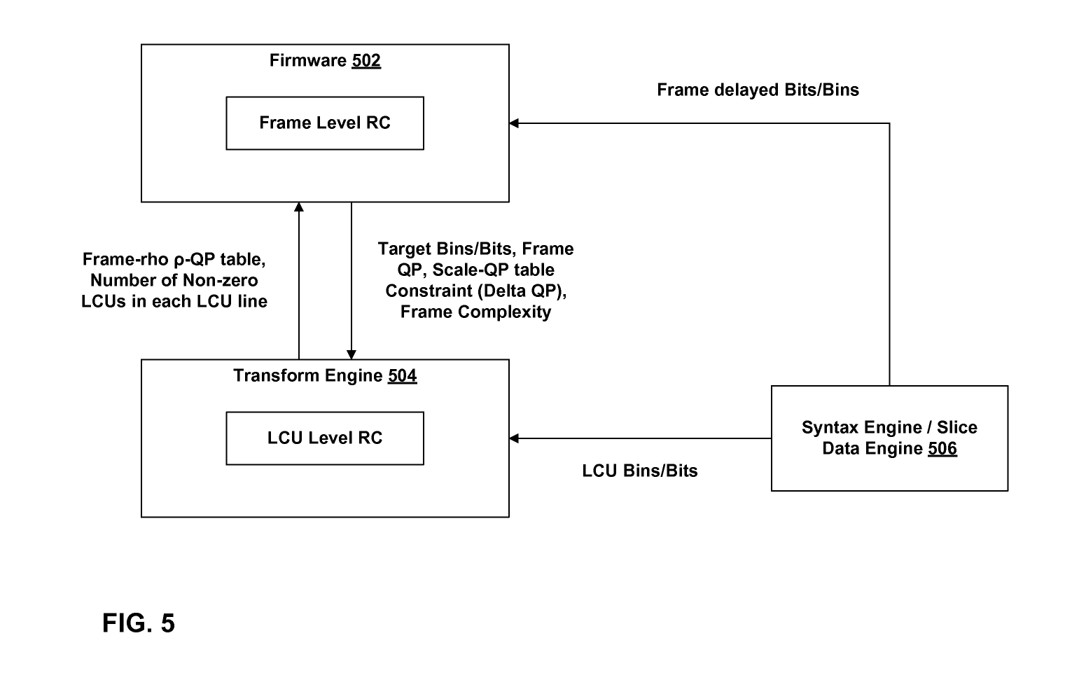

FIG. 5 is a block diagram illustrating example components of a video encoder configured to perform rate control, in accordance with one or more aspects of this disclosure. As illustrated in FIG. 5, video encoder 20 may include firmware (FW) 502, transform engine (TE) 504, and syntax engine/slice data engine (SE/SDE) 506. In some examples, SE/SDE 506 may provide frame delayed bits/bins to FW 502 and/or LCU bins/bits to TE 504. In some examples, FW 502 perform frame level rate control and may provide one or more of: target bins/bits, a frame QP value, one or more scale-QP table constraint (Delta QP), and frame complexity data to TE 504. In some examples, TE 504 may perform LCU level rate control and may provide one or more of a frame-rho ρ-QP table, and a number of non-zero LCUs in each LCU line to FW 502.

FIGS. 6-45B are conceptual and flow diagrams illustrating example details of operations of a video coder to perform rate control. The techniques of FIGS. 6-45B may be performed by a video encoder, such a video encoder 20 illustrated in FIG. 1 and FIG. 2, or a variety of other processor(s) configured for coding video data. For purposes of illustration, the techniques of FIGS. 6-45B are described within the context of video encoder 20 of FIG. 1 and FIG. 2, although video encoders having configurations different than that of video encoder 20 may perform the techniques of FIGS. 6-45B.

As discussed above, in some examples, video encoder 20 may perform frame level rate control in accordance with the techniques of FIG. 6. As illustrated in FIG. 6, video encoder 20 may allocate a quantity of bits to a current frame (602). In some examples, video encoder 20 may allocate the quantity of bits to the frame based on the complexity of different hierarchical level frames. For example, the encoder may allocate the bits in accordance with equation (2), above, where k is the layer index, j is the frame number, Nᵢ is the number of frames in layer i, δ is a step, and Cᵢ is the complexity of layer i. In some examples, video encoder 20 may determine the complexity of a layer i in accordance with equation (3), above, where QPᵢ^{coded} is the QP of frame i and Bitᵢ^{coded} is the number of bits used to encode frame i.

In some examples, the complexity may be updated according to different hierarchical layers such that each different hierarchical layer may have its own complexity and may be updated in the same layer frame by frame. The target bits may then be used to determine the QP. As shown in equation (2), above, the status of a buffer may be considered when allocating bits. For instance, the status of a HDR buffer, which is related to the delay of video application, may be considered in rate allocation such that the buffer is less likely to overflow or underflow.

In some examples, video encoder 20 may determine the percentage of zero quantized coefficients. For instance, video encoder 20 may utilize a linear R-ρ model to determine the percentage of zero quantized coefficients in accordance with equation (4), above, where R is the target bits of current frame, R_{header} is the predicted header bits of current frame, ρ is the percentage of zero quantization parameters, and θ is one parameter which is decided by the complexity of picture, and it may be predicted from previous frames

In some examples, video encoder 20 may determine ρ in accordance with equation (5), above, where p(x) is the distribution of DCT coefficient x, and Δ is the dead zone which may be determined by the quantization step. In some examples, video encoder 20 may determine the target ρ based on the target bits R, and parameter θ.

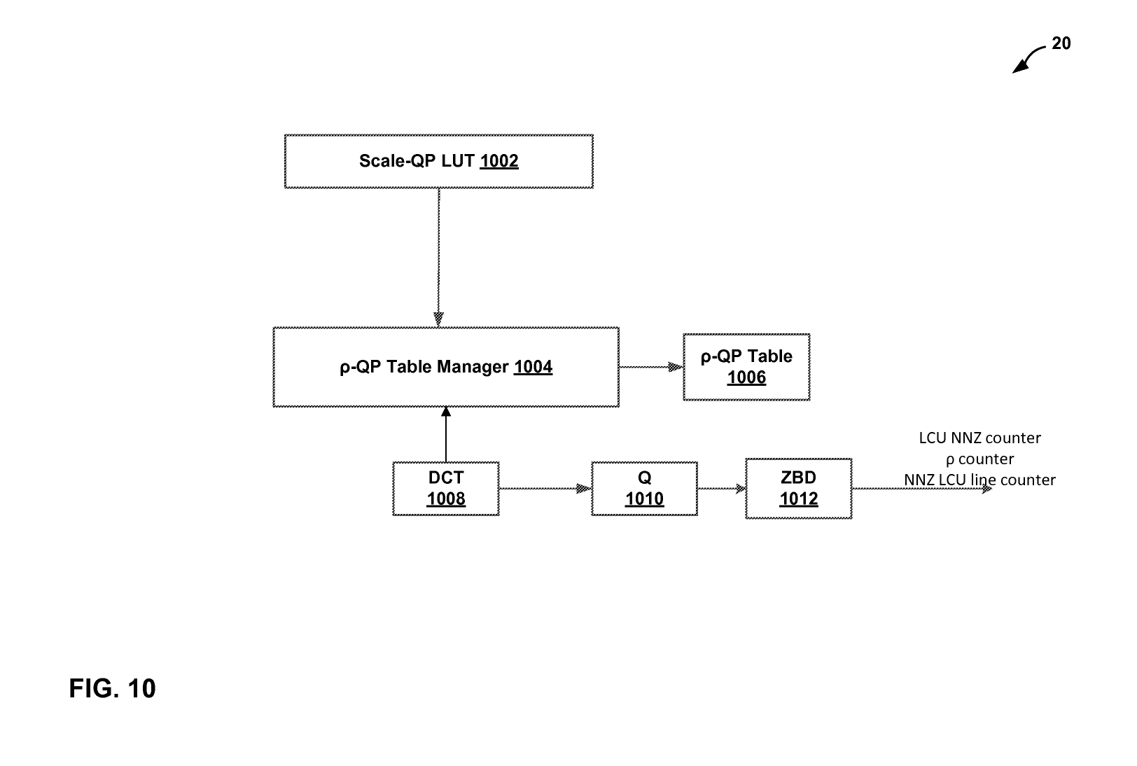

Video encoder 20 may then determine a QP for the current frame based at least on the quantity of bits allocated to the current frame (604). In some examples, video encoder 20 may use a ρ-QP table to determine the QP for the current frame based on the determined ρ value. In some examples, video encoder 20 may use ρ-QP tables of different levels to determine a QP for a current frame. In some examples, encoder 20 may generate the ρ-QP tables by using ρ-QP table management techniques which may be controlled by ρ-QP model. For instance, ρ-QP table entries corresponding to operating QP range may be generated by a HW ρ-QP table management module which may be included in video encoder 20. In some examples, video encoder 20 may perform ρ-QP table management in accordance with the techniques of FIG. 10.

In some examples, a ρ-QP table may include the number of nonzero quantization coefficients and the corresponding QP. However, in some examples, video encoder 20 may only update a portion of ρ-QP table entries. Therefore, in accordance with one or more techniques of this disclosure, the size of the ρ-QP lookup table can be reduced. For example, the size of the ρ-QP lookup table for I pictures may be reduced by one-half (½). As another example, the size of the ρ-QP lookup table for other picture types (e.g., P pictures and B pictures) may be reduced by one-eighth (⅛).

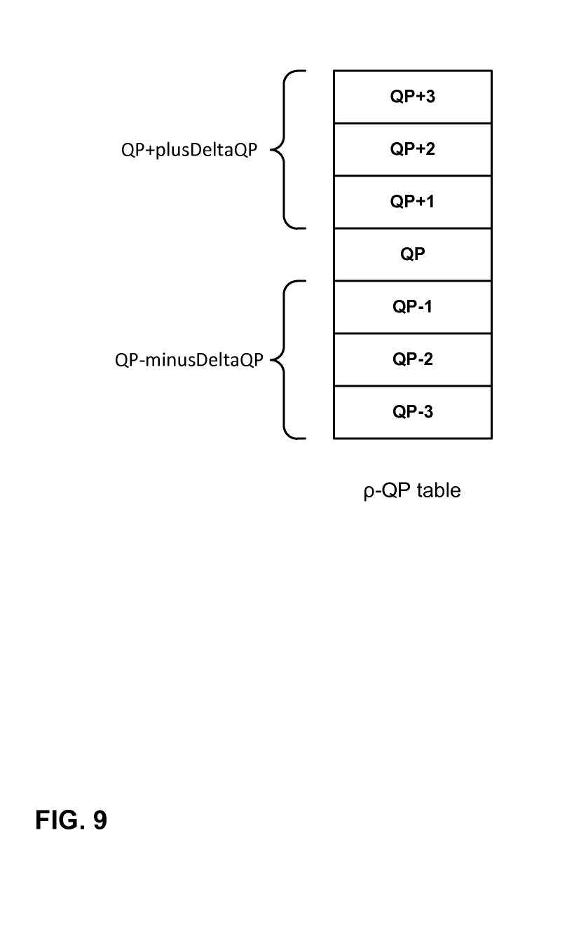

In some examples, when performing ρ-QP table management, video encoder 20 may consider an operating QP range when generating a ρ-QP table. The operating QP range may be determined based on a current frame QP value, a minusDeltaQP value, and a plusDeltaQP value. In some examples, the minusDeltaQP value and the plusDeltaQP value may be specified by user and may operate to constrain QP variations between adjacent frames. In other words, if the QP of the current frame is known, the QP values outside of minusDeltaQP and plusDeltaQP will not be used when determining the QP of the next frame because the QP of the next frame is limited by the minusDeltaQP value and the plusDeltaQP value. As such, video encoder 20 may generate ρ-QP table entries from QP-minusDeltaQP to QP+plusDeltaQP for a given current frame QP. In other words, ρ-QP table entries from QP-minusDeltaQP to QP+plusDeltaQP may be maintained in order to reduce complexity. In some examples, video encoder 20 may generate ρ-QP table entries from QP-minusDeltaQP to QP+plusDeltaQP for a given current frame QP in accordance with the techniques of FIG. 9.

In some examples, the nonzero quantization coefficients may be accumulated if the coefficient is larger than a scale step. For instance, the nonzero quantization coefficients may be accumulated if equation (6), above, evaluates as true, where C is the coefficient, and S(QP) is the scale step.

In some examples, the number of computations may be reduced if equation (7), above, evaluates as true because these coefficients will be zero for all these QPs in the QP range. Similarly, in some examples, the number of computations may be reduced if equation (8), above, evaluates as true because these coefficients will be one for all these QPs in the QP range.

In other words, video encoder 20 only needs the scale step of each QP in the QP range. In some examples, such as examples involving the HEVC standard, the scale step may be the same for all the frequencies but may vary according to size of TU and QP.

In some examples, the scale QP table may be fixed. In some examples, the scale QP table may be calculated in firmware (FW) and sent to TRE from SWI. In some examples, the scale QP table may be determined in accordance with equation (9), above, where uiQ is a QP-dependent scaling factor, iAddQ is an offset for rounding that may be determined in accordance with equation (10), above, and iQbits is a value that may be determined in accordance with equation (11), above.

In some examples, the scale QP table may be determined for a particular TU size and other TU sizes may be accommodated by shifting the scale QP table. In some examples, the particular TU size for which the scale QP table may be determined is four (4). An example scale QP table for used with inter frame coding is shown in table (1), above, and an example scale QP table for used with intra frame coding is shown in table (2), above.

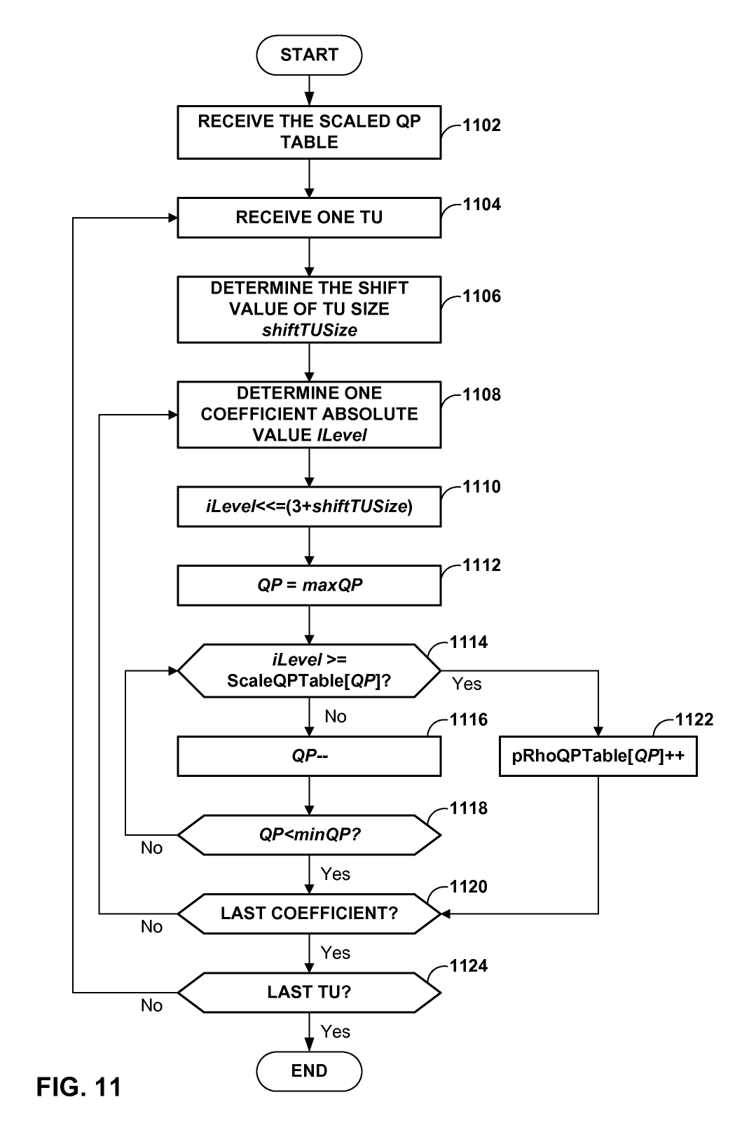

As stated above, the values included in the scale-QP LUT may be based on QP, intra or inter slices, and TU size. Additionally, as stated above, because video encoder 20 can calculate LUTs with the same mode (i.e., intra or inter) by shifting from another one, only one LUT for each mode may be needed. In other words, in some examples, only the LUTs for 4×4 TU for each slice may be used. As a result, video encoder 20 may operate more efficiently because it may only load the LUT once per slice. The HW ρ-QP Table Manager of video encoder 20 may receive a DCT coefficient and may determine a scale step to generate nonzero level after quantization from the Scale-QP LUT. The entry number in ρ-QP Table, which may be specified by the Scale-QP LUT, may increase by one. Encoder 20 may then calculate the ρ for each QP. In some examples, video encoder 20 may generate the ρ-QP table in accordance with the techniques of FIG. 11.

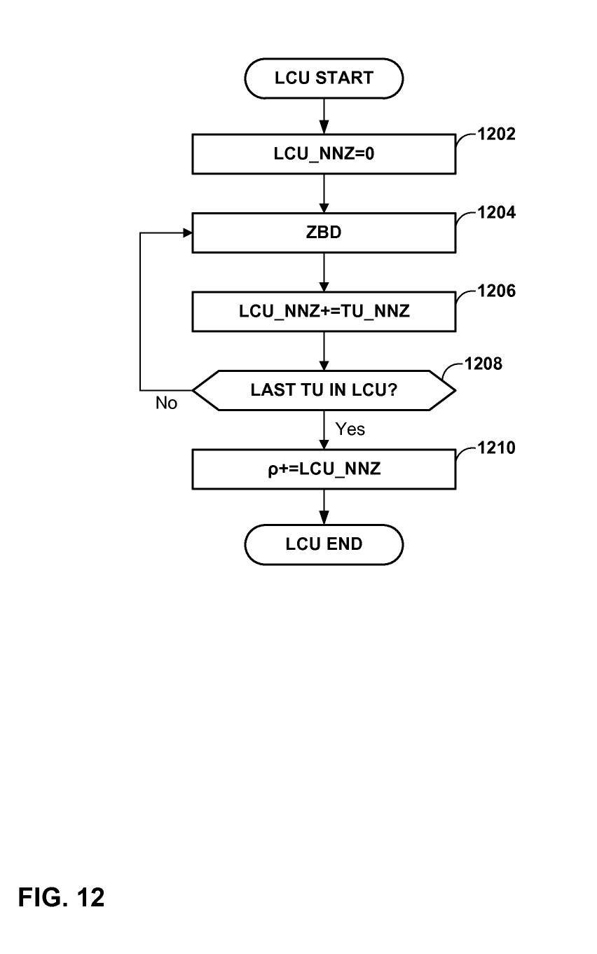

In some examples, when performing frame level RC, video encoder 20 may also need the coded ρ of each frame (the number of nonzero quantization coefficients). In some examples, the nonzero coefficients may be counted and feedback to firmware. In some examples, video encoder 20 may determine the coded ρ of each frame in accordance with the techniques of FIG. 12.

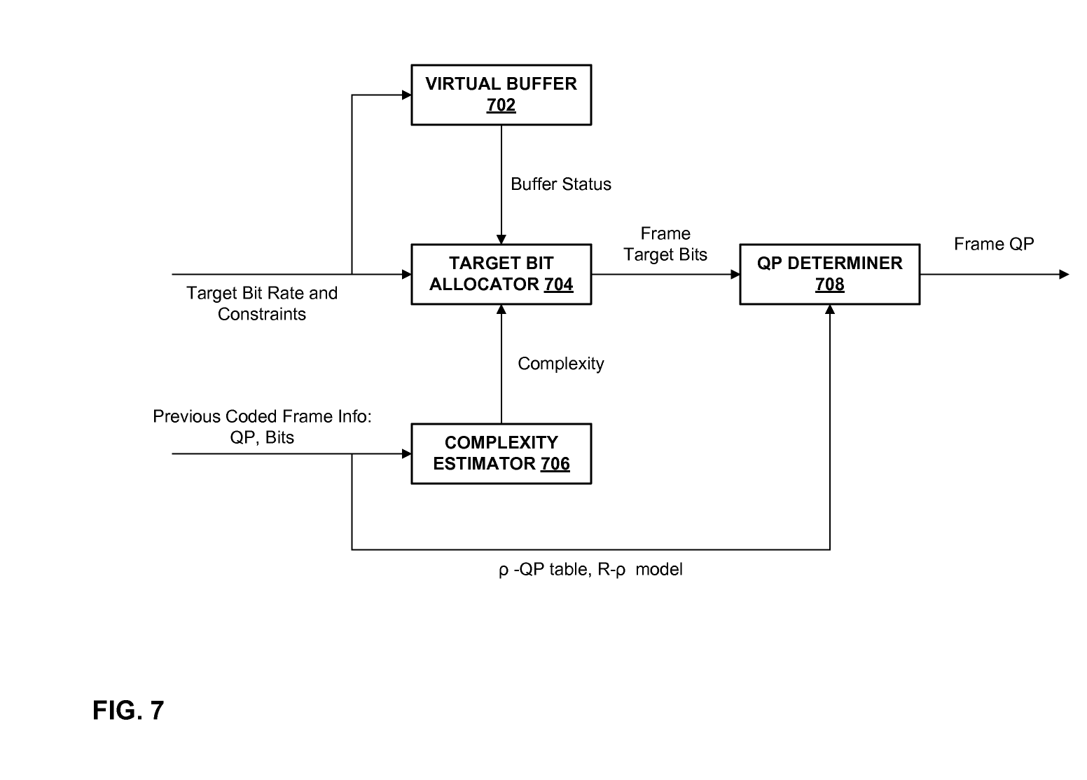

FIG. 7 is a conceptual diagram illustrating an example data flow within a video encoder performing frame level rate control. The example of FIG. 7 includes virtual buffer 702, target bit allocator 704, complexity estimator 706, and QP determiner 708. In some examples, video encoder 20 (FIG. 2) may implement the data flow of FIG. 7, e.g., using mode select unit 40, quantization unit 54, or other units.

In accordance with one or more techniques of this disclosure, virtual buffer 702 may receive one or more of: a target bit rate value, and one or more constraints. Virtual buffer 702 may output buffer status information to target bit allocator 704. For instance, virtual buffer 702 may output a value to target bit allocator 704 that indicates how much space is currently available in virtual buffer 702.

Complexity estimator 706 may receive one or more of: a quantity of bits used to code a previous frame, and a QP used to quantize the previous frame. Based on the received values, complexity estimator 706 may determine a complexity value for one or more previously coded frames and provide the one or more determined complexity value to target bit allocator 704.

Target bit allocator 704 may receive the one or more determined complexity values, the buffer status, the target bit rate value, and the one or more constraints. Based on the received values, target bit allocator 704 may determine a quantity of bits to be allocated to a current frame and provide the determined quantity of bits to QP determiner 708. In some examples, target bin allocator 704 may be configured to perform one or more of the operations of FIG. 6, such as allocate bits to current frame 602.

QP determiner 708 may receive one or more of: the determined quantity of bits, a ρ-QP table, and an R-ρ model. Based on the received values, QP determiner 708 may determine a QP for the current frame. In some examples, target bin allocator 704 may be configured to perform one or more of the operations of FIG. 6, such as determine QP for the current frame 604. In this way, video encoder 20 may determine a QP for a current frame.

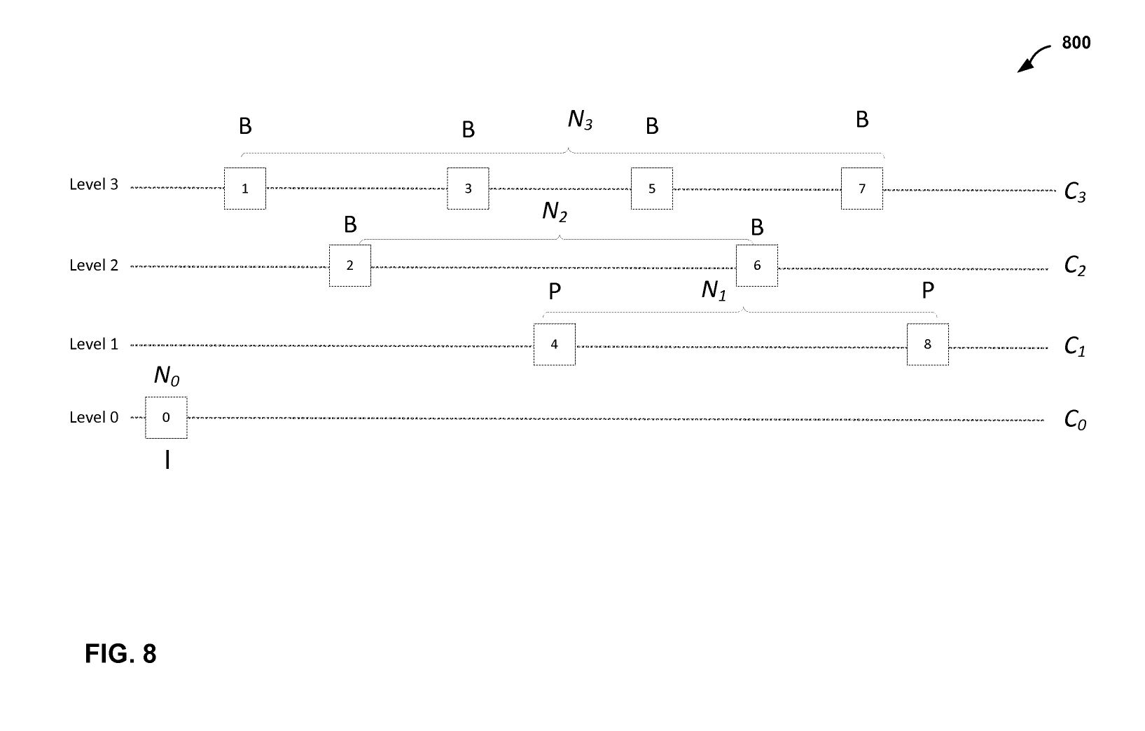

FIG. 8 is a conceptual diagram illustrating a plurality of frames of different hierarchical levels. As illustrated in FIG. 8, video data 800 includes level 0, level 1, level 2, and level 3. Also, as illustrated in FIG. 8, level 0 includes a single frame (i.e., N₀=1), frame 0 and has associated complexity value C₀; level 1 includes two frames (i.e., N₁=2), frame 4 and frame 8 and has associated complexity value C₁; level 2 includes two frames (i.e., N₂=2), frame 2 and frame 6 and has associated complexity value C₂; and level 3 includes four frames (i.e., N₃=4), frame 1, frame 3, frame 5, and frame 7 and has associated complexity value C₃.

As discussed above, in some examples, video encoder 20 may generate ρ-QP table entries from QP-minusDeltaQP to QP+plusDeltaQP for a given current frame QP in accordance with the techniques of FIG. 9. As illustrated in FIG. 9, where the value of DeltaQP is three, video encoder 20 may generate ρ-QP table entries from QP-3 to QP+3. In other words, if the QP for a current frame is five and DeltaQP is three, video encoder 20 may generate ρ-QP table entries from two (QP-minusDeltaQP) to eight (QP+plusDeltaQP) and may limit the determined QP value for the next frame to between two and eight.

As discussed above, in some examples, video encoder 20 may perform ρ-QP table management in accordance with the techniques of FIG. 10. As illustrated in FIG. 10, video encoder 20 may include scale-QP LUT 1002, ρ-QP table manager 1004, ρ-QP table 1006, discrete cosine transformer (DCT) 1008, quantizer (Q) 1010, and zero block detector (ZBD) 1012. In some examples, DCT 1008 may be an example of transform processing unit 52 of FIG. 2. In some examples, Q 1010 may be an example of quantization unit 54 of FIG. 2. In some examples, Scale-QP LUT 1002 may be 52*2*16 bits, and ρ-QP table 1006 may be 52*24 bits. In some examples, ZBD 1012 may be configured to determine whether to code the quantized coefficients, or to set all of the coefficients to 0, depending on which has the better rate distortion (RD) performance.

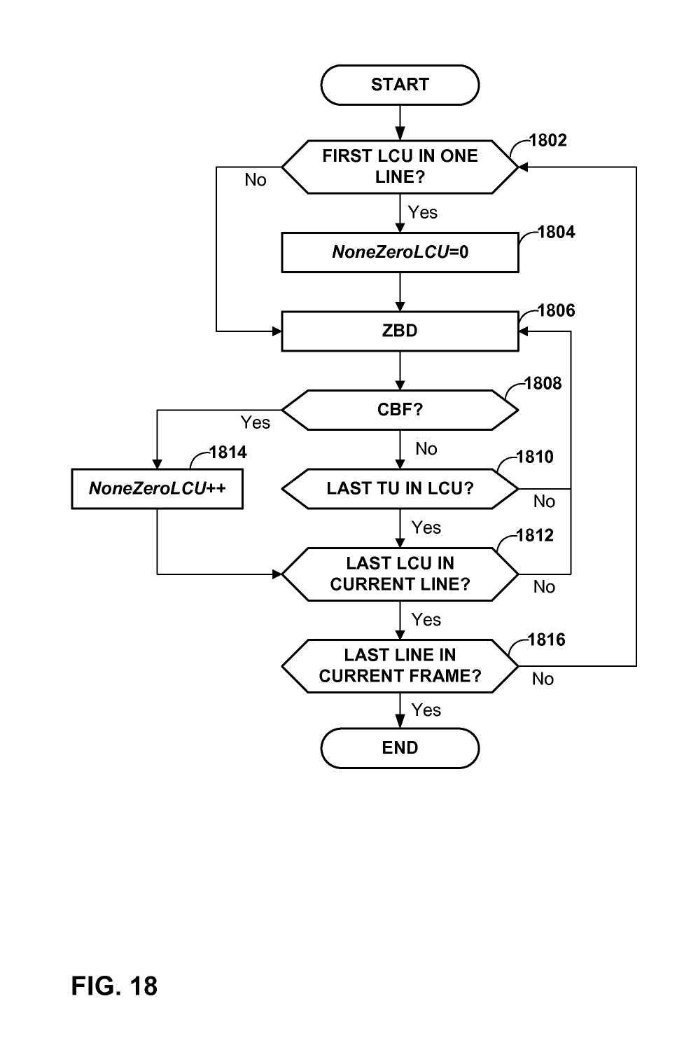

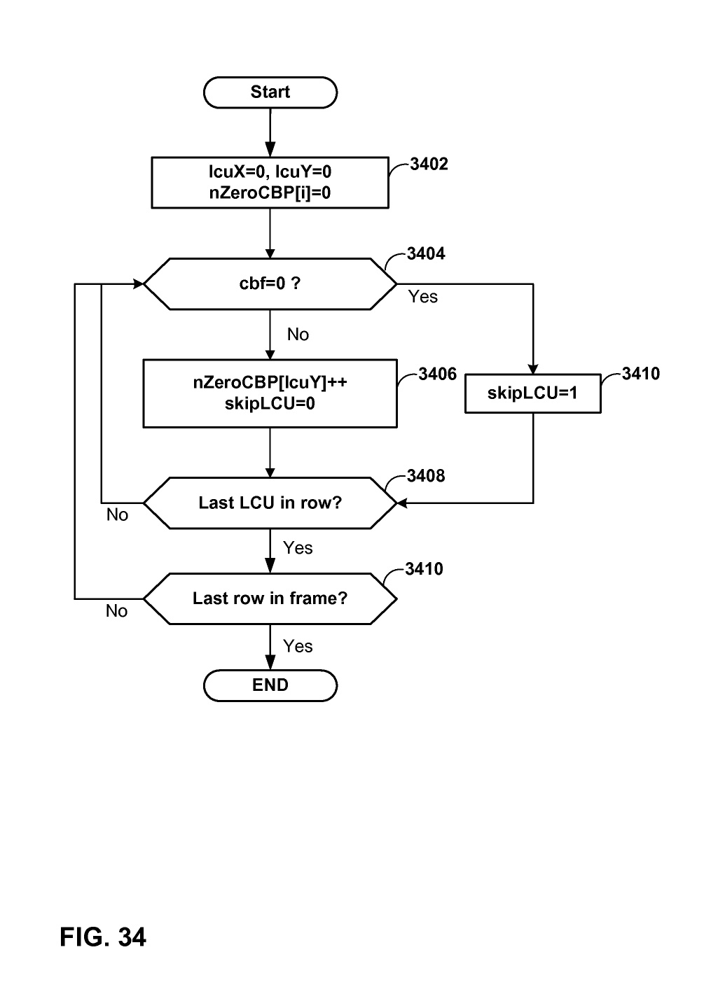

In some examples, the output of ZBD 1012 may be provided to a LCU NNZ counter which may determine a quantity of LCUs with non-zero transform coefficients in a frame. In some examples, the LCU NNZ counter may determine the quantity of LCUs with non-zero transform coefficients in the frame in accordance with the techniques of FIG. 12. In some examples, the output of ZBD 1012 may be provided to a LCU NNZ Line counter which may determine a quantity of LCUs with non-zero transform coefficients in a frame. In some examples, the LCU NNZ Line counter may determine the quantity of LCUs with non-zero transform coefficients in each line of the frame in accordance with the techniques of FIG. 18 and/or FIG. 34.

As discussed above, in some examples, video encoder 20 may generate the ρ-QP table in accordance with the techniques of FIG. 11. As illustrated by FIG. 11, video encoder 20 may receive (e.g., fetch) a scaled QP table (1102), receive (e.g., get) a current transform unit (TU) of a current frame (1104), determine (e.g., get) the shift value of TU size (e.g., shiftTUSize) (1106), determine (e.g., get) a current coefficient absolute value (e.g., iLevel) (1108), assign the value of the coefficient absolute value based on the shift value of the TU size (1110), assign a maximum QP value to a variable that indicates a QP value (1112), and determine whether or not the coefficient absolute value is greater than or equal to a value from a ScaleQPTable that corresponds to the QP value (1114). If the coefficient absolute value is not greater than or equal to the value resulting from the ScaleQPTable that corresponds to the QP value (“No” branch of 1114), video encoder 20 may decrement the QP value (1116), and determine whether the decremented QP value is less than a minimum QP value (1118). If the decremented QP value is not less than the minimum QP value (“No” branch of 1118), video encoder 20 may determine whether or not the coefficient absolute value is greater than or equal to the value resulting from the ScaleQPTable that corresponds to the QP value (1114). If the decremented QP value is less than the minimum QP value (“Yes” branch of 1118), video encoder 20 may determine whether the current coefficient is the last coefficient in the current TU (1120). If the coefficient absolute value is greater than or equal to a value resulting from the ScaleQPTable that corresponds to the QP value (“Yes” branch of 1114), video encoder 20 may increment a value of a rho-QP table that corresponds to the QP value (1122), and determine whether the current coefficient is the last coefficient in the current TU (1120).

If the current coefficient is not the last coefficient in the current TU (“No” branch of 1120), video encoder 20 may advance to the next coefficient and determine the absolute value of the next coefficient (1108). If the current coefficient is the last coefficient in the current TU (“Yes” branch of 1120), video encoder 20 may determine whether the current TU is the last TU in the current frame (1124). If the current TU is not the last TU in the current frame (“No” branch of 1124), video encoder 20 may advance to the next TU (1104). If the current TU is the last TU in the current frame (“Yes” branch of 1124), video encoder 20 may complete generation of the ρ-QP table.

As discussed above, in some examples, video encoder 20 may determine the coded ρ of each frame in accordance with the techniques of FIG. 12. As illustrated by FIG. 12, video encoder 20 may assign the value of zero to a variable that indicates a quantity of non-zero transform coefficients in a current LCU (e.g., LCU_NNZ) (1202). Video encoder 20 may perform zero block detection (ZBD) to determine a quantity of blocks in a current TU in the current LCU that include any non-zero transform coefficients (1204), add the determined quantity of blocks in the current TU that include any non-zero transform coefficients (e.g., TU_NNZ) to the variable that indicates the quantity of non-zero transform coefficients in a current LCU (1206), and determine whether the current TU is the last TU in the current LCU (1208). If the current TU is not the last TU in the current LCU (“No” branch of 1208), video encoder 20 may advance to the next TU and perform ZBD to determine a quantity of blocks in the next TU that include any non-zero transform coefficients (1204). If the current TU is the last TU in the current LCU (“Yes” branch of 1208), video encoder 20 may add the value of the variable that indicates the quantity of non-zero transform coefficients in the current LCU to a variable that indicates a quantity of non-zero transform coefficients in the current frame (e.g., p) (1210).

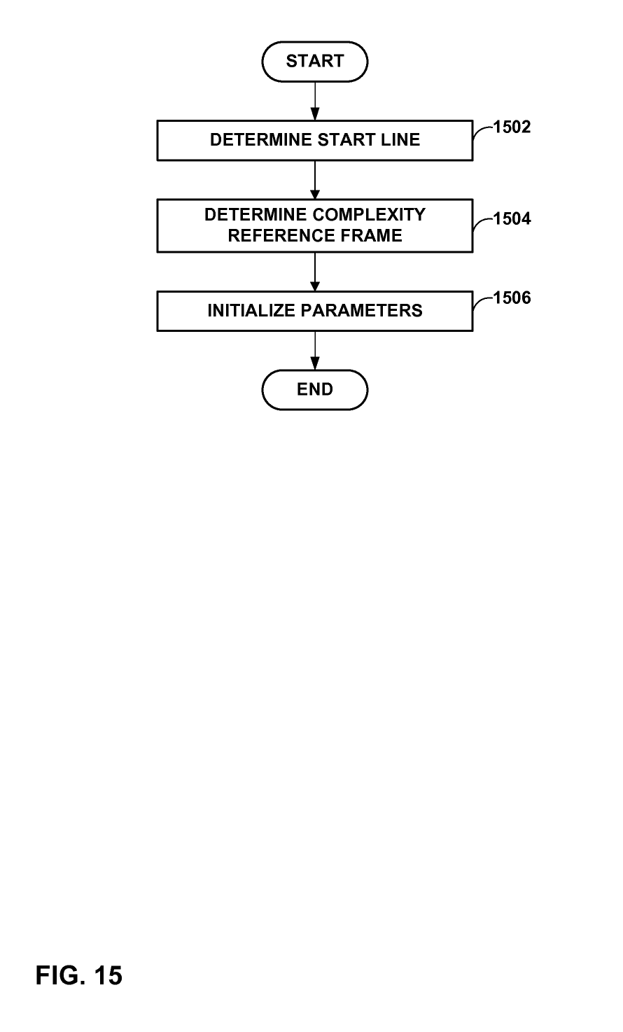

As discussed above, in some examples, video encoder 20 may perform LCU level rate control in accordance with the techniques of FIG. 13 to determine the QP for the current LCU. As illustrated in FIG. 13, video encoder 20 may perform one or more initialization operations (1302). For instance, video encoder 20 may perform one or more initialization operations such as determining a start line, determining a complexity reference, and initializing one or more parameters. For example, when initializing LCU level rate control, video encoder 20 may determine a start line based on the LCUs of the previous frame. In some examples, video encoder 20 may perform one or more initialization operations in accordance with the techniques of FIG. 15.

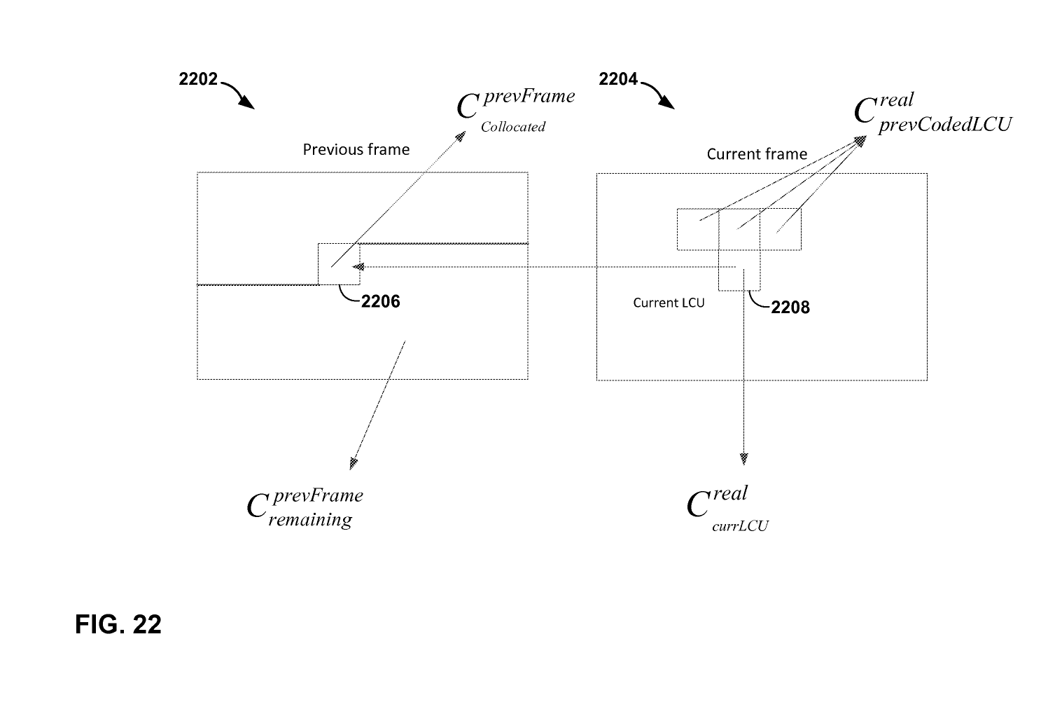

Video encoder 20 may perform LCU bit allocation (1304). For instance, video encoder 20 may allocate a quantity of bits to a current LCU of a current frame based on a complexity value of a reference frame and a quantity of bits allocated to the current frame. In some examples, video encoder 20 may perform LCU bit allocation operations in accordance with the techniques of FIG. 22.

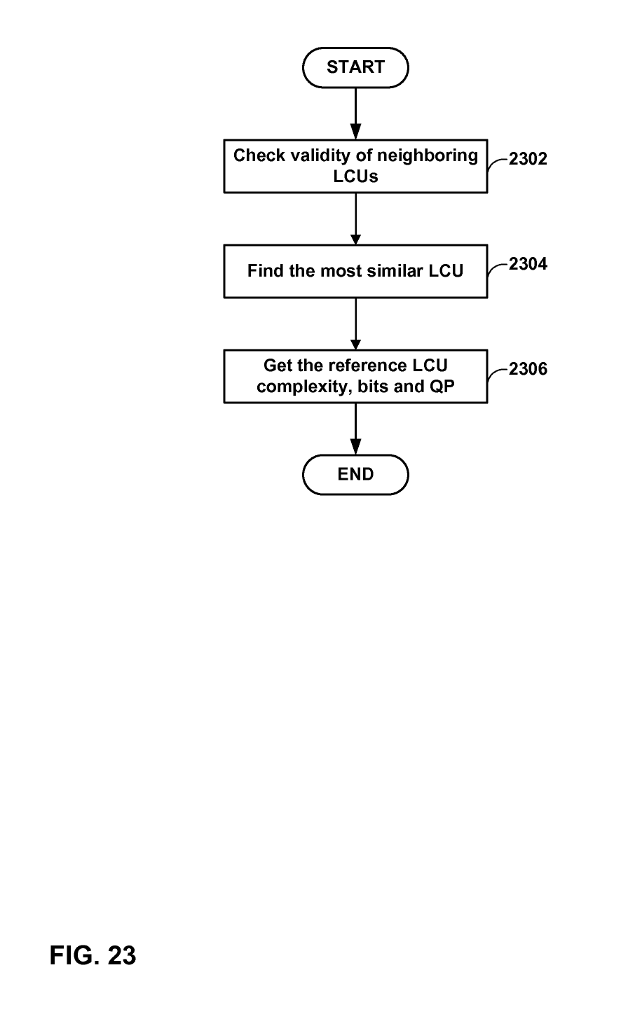

Because the information of previously coded LCU in the current frame may be used for LCU rate control, video encoder 20 may select a neighboring LCU of the current LCU (1306). For instance, video encoder 20 may select a neighboring LCU of the current LCU to be used as a reference LCU. In some examples, video encoder 20 may determine the reference LCU in accordance with the techniques illustrated in FIG. 23. For instance, video encoder 20 may check the validity of the neighboring LCUs, find the most similar LCU, and get the complexity, bits, and QP of the most similar LCU.

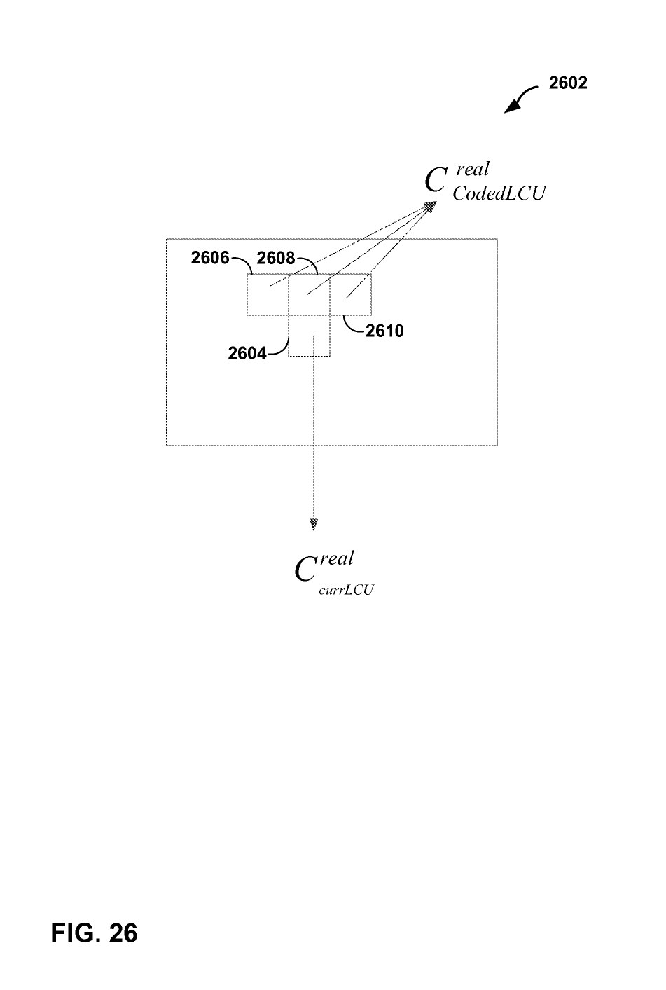

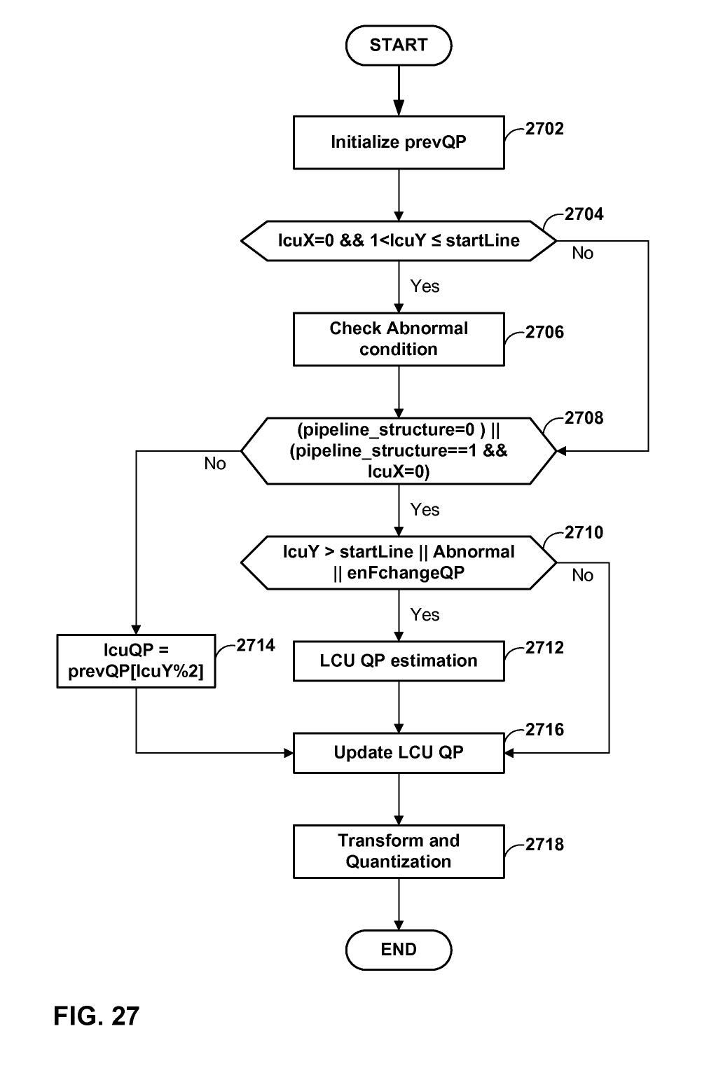

Video encoder 20 may determine a ratio for the current LCU (1308). For instance, video encoder 20 may determine a ratio of the quantity of bits allocated to the current LCU and a complexity value of an LCU of the complexity reference frame to a complexity value of the selected neighboring LCU and a quantity of bits used to code the selected neighboring LCU. Video encoder 20 may determine a QP for the current LCU (1310). For instance, video encoder 20 may determine the QP for the current LCU based on the determined ratio. In some examples, video encoder 20 may determine the ratio and QP for the current LCU in accordance with the techniques of FIGS. 26-27.

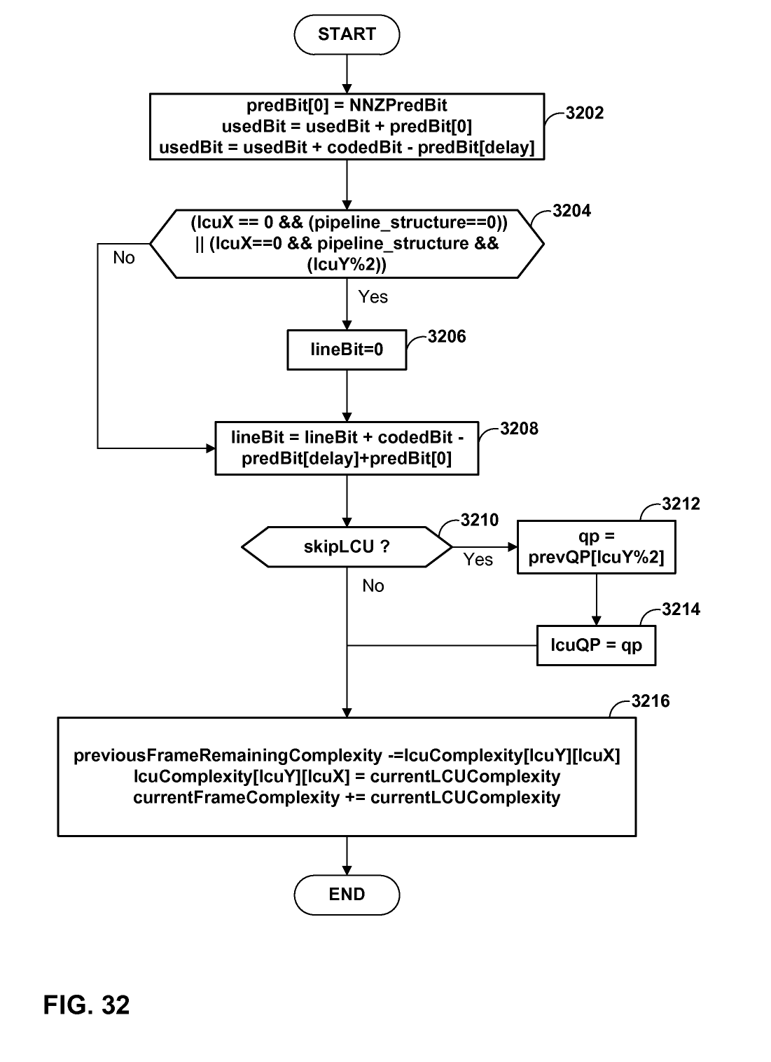

Video encoder 20 may perform a LCU rate control post update (1312). For instance, video encoder 20 may update one or more parameters based on the determined QP. In some examples, video encoder 20 may perform a LCU rate control post update in accordance with the techniques of FIGS. 32-36. Video encoder 20 may update the ρ value and the ρ-QP tables (1314). In some examples, video encoder 20 may update the ρ-QP tables in accordance with the techniques of FIG. 11.

Video encoder 20 may determine whether the current LCU is a last LCU in the current frame (1316). If the current LCU is not the last LCU in the current frame (“No” branch of 1316), video encoder 20 may advance to the next LCU in the current frame (1318) and select a neighboring LCU of the next LCU (1306). If the current LCU is not the last LCU in the current frame (“Yes” branch of 1316), video encoder 20 may complete LCU level rate control for the current frame.

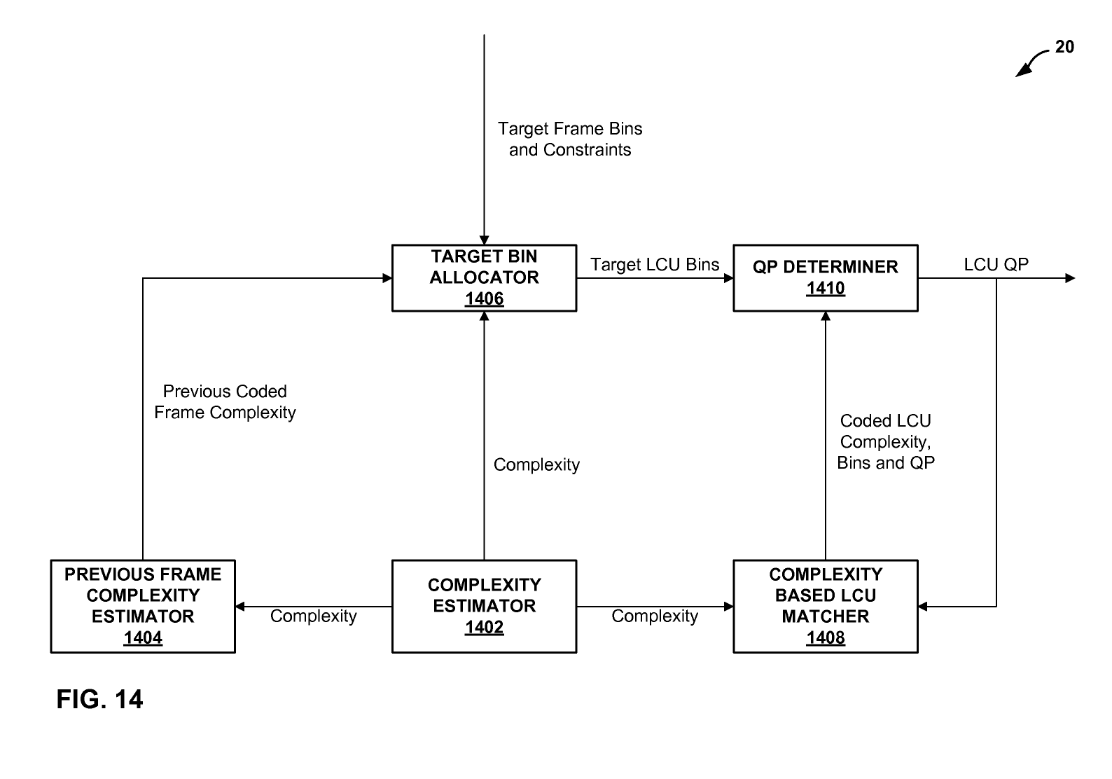

FIG. 14 is a conceptual diagram illustrating an example data flow within a video encoder performing LCU level rate control. The example of FIG. 14 includes complexity estimator 1402, previous frame complexity estimator 1404, target bin allocator 1406, complexity based LCU matcher 1408, and QP determiner 1410. In some examples, video encoder 20 (FIG. 2) may implement the data flow of FIG. 14, e.g., using mode select unit 40, quantization unit 54, or other units.

In accordance with one or more techniques of this disclosure, complexity estimator 1402 may determine a plurality of respective complexity value for a plurality of respective LCUs and provide one or more of the determined complexity values to previous frame complexity estimator 1404, target bin allocator 1406, and complexity based LCU matcher 1408. Previous frame complexity estimator 1404 may determine, based on the received determined complexity values for the LCUs, a complexity value for a previously coded frame, and provide the determined complexity value for the previously coded frame to target bin allocator 1406. In other words, previous frame complexity estimator 1404 may store previously determined complexity values for later use, such as by target bin allocator 1406.

Target bin allocator 1406 may receive a target quantity of bins for a current frame and one or more constraints. Target bin allocator 1406 may determine a target quantity of bins for a current LCU of the current frame. In some examples, target bin allocator 1406 may determine the target quantity of bins for the current LCU based on one or more of the target quantity of bits for the current frame, the constraints, the complexity value for the previously coded frame, and a complexity value of an LCU of the previously coded frame. In any case, target bin allocator 1406 may provide the determined quantity of bins for the current LCU to QP determiner 1410. In some examples, target bin allocator 1406 may be configured to perform one or more of the operations of FIG. 13, such as LCU bin allocation 1304.

Complexity based LCU matcher 1408 may receive a complexity value for the current LCU and one or more complexity values that respectively correspond to one or more neighboring LCUs of the current LCU from complexity estimator 1402, and a QP for a previous LCU from QP determiner 1410. Complexity based LCU matcher 1408 may compare the complexity values of the neighboring LCUs with a complexity value of an LCU of the previously coded frame that is collocated with the current LCU to select one of the neighboring LCUs as a reference LCU. Complexity based LCU matcher 1408 may provide a complexity value of the reference LCU, a quantity of bins used to code the reference LCU, and a QP of the reference LCU to QP determiner 1410. In some examples, complexity based LCU matcher 1408 may be configured to perform one or more of the operations of FIG. 13, such as neighbor LCU selection 1306.

QP determiner 1410 may determine a QP for the current LCU based on one or more of the target quantity of bins for the current LCU received from target bin allocator 1406, the complexity value of the reference LCU, the quantity of bins used to code the reference LCU, and the QP of the reference LCU received from complexity based LCU matcher 1408. In some examples, QP determiner 1410 may be configured to perform one or more of the operations of FIG. 13, such as ratio computation 1308 and/or LCU QP determination 1310.

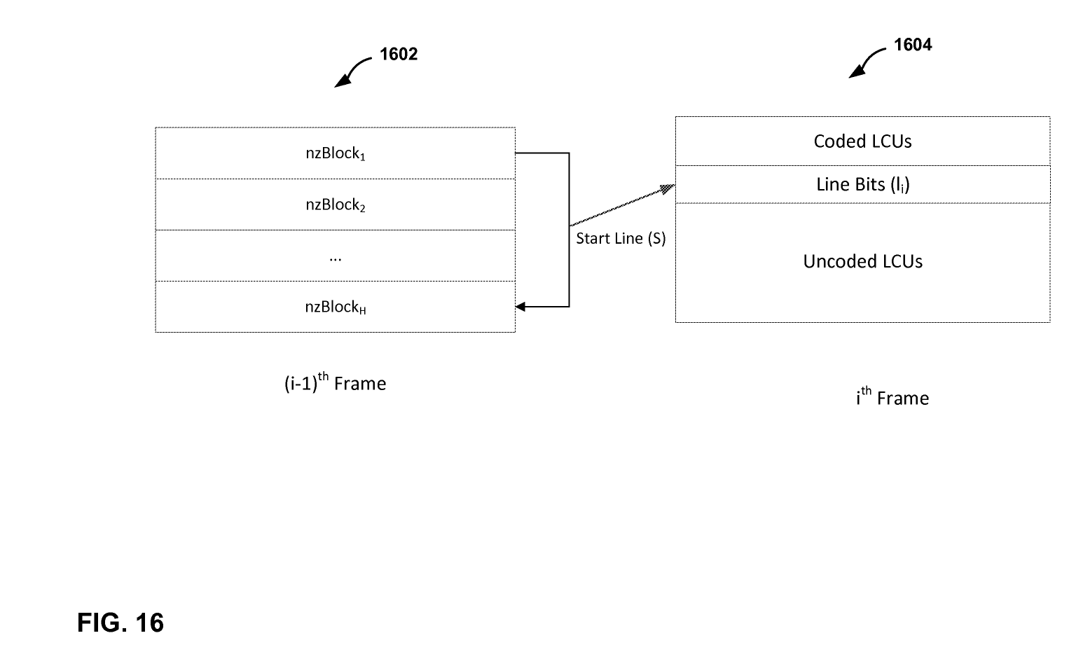

FIG. 15 is a flow diagram illustrating example operations of a video coder to initialize when performing LCU level rate control. As illustrated in FIG. 15, video coder 20 may initialize LCU level rate control by determining a start line (1502). For example, video encoder 20 may determine a start line of LCUs within the current frame such that video encoder 20 may skip performing LCU level rate control on LCUs in lines above the determined start line. By skipping performance of LCU level rate control on LCUs in lines above the determined start line, video coder 20 may reduce the computational load and cost in hardware. In some examples, video encoder 20 may determine the start line in accordance with the techniques illustrated in FIGS. 16-18.

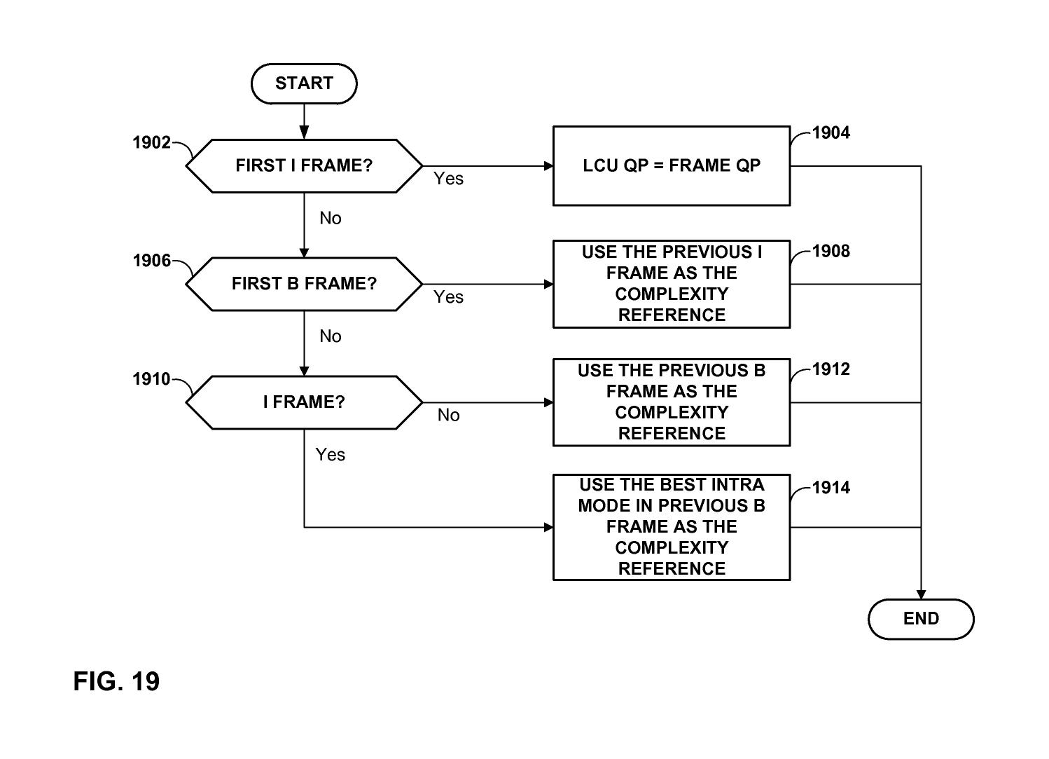

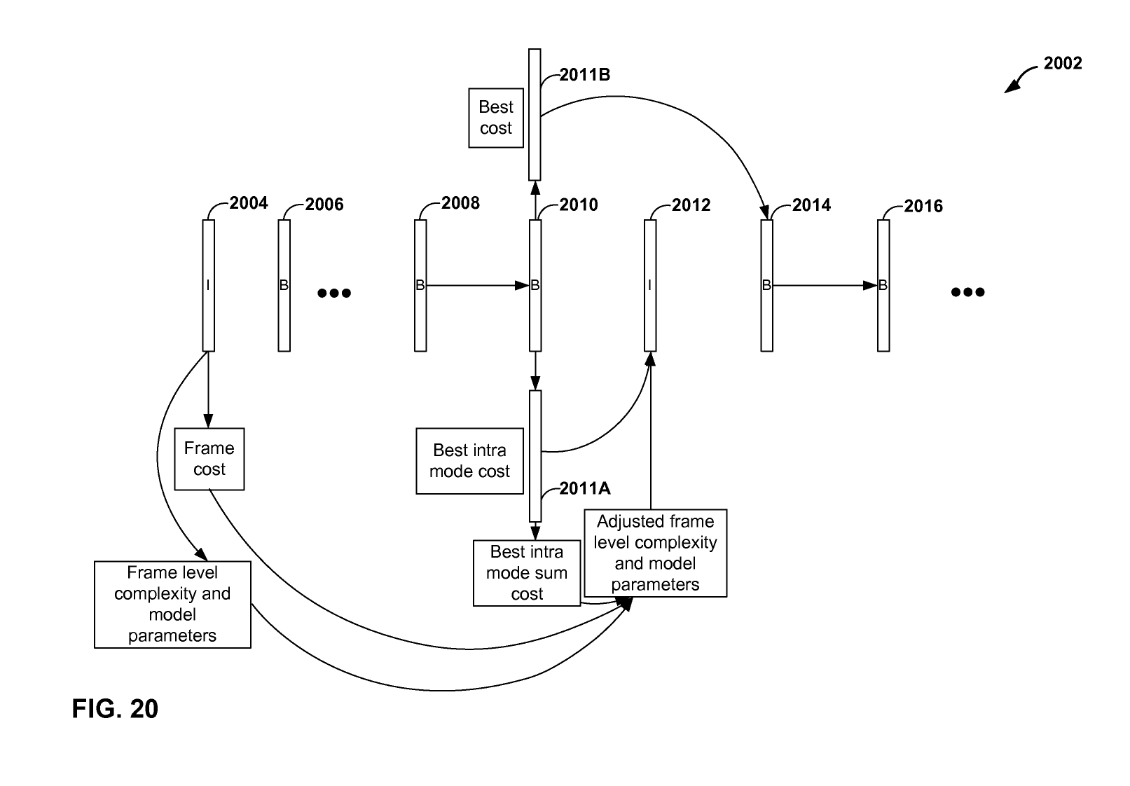

Video coder 20 may initialize LCU level rate control by determining a complexity reference frame (1504). For instance, video coder 20 may determine the complexity reference frame based on a frame-type of the current frame (e.g., I-frame, P-frame, or B-frame). As one example, when performing rate control on the first B frame after an I frame, video encoder 20 may select the last B frame as the complexity reference. As another example, when performing rate control on an I frame, video encoder 20 may select the complexity of the best intra mode in previous B frame as its complexity reference. In this way, video encoder 20 may increase the accuracy of the reference frame complexity information. Further details of example complexity reference frame determination operations are provided below with reference to FIGS. 19-20.

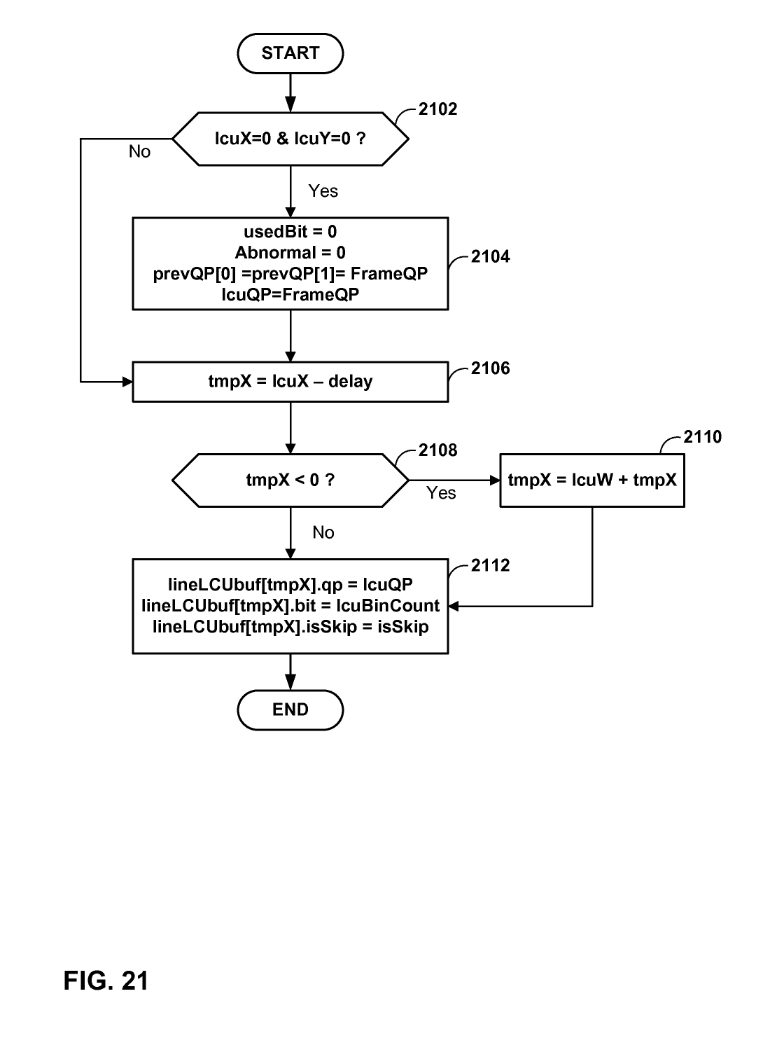

As stated above, video coder 20 may initialize LCU level rate control by initializing one or more parameters (1506). In some examples, video coder 20 may initialize one or more parameters in accordance with the techniques illustrated in FIG. 21.

As discussed above, in some examples, video encoder 20 may determine the start line in accordance with the techniques illustrated in FIGS. 16-18. As illustrated in FIG. 16, video encoder 20 may determine a start line for frame 1604 based on a previous frame 1602. For instance, video encoder 20 may determine the start line for frame 1604 based on a quantity of LCUs in each line of previous frame 1602 that have one or more non-zero quantized transform coefficients. In some examples, by determining a start line other than the first line, video encoder 20 may not adjust the QP for LCUs in lines above the determined start line. In this way, video encoder 20 may reduce the quantity of calculations needed to perform rate control.

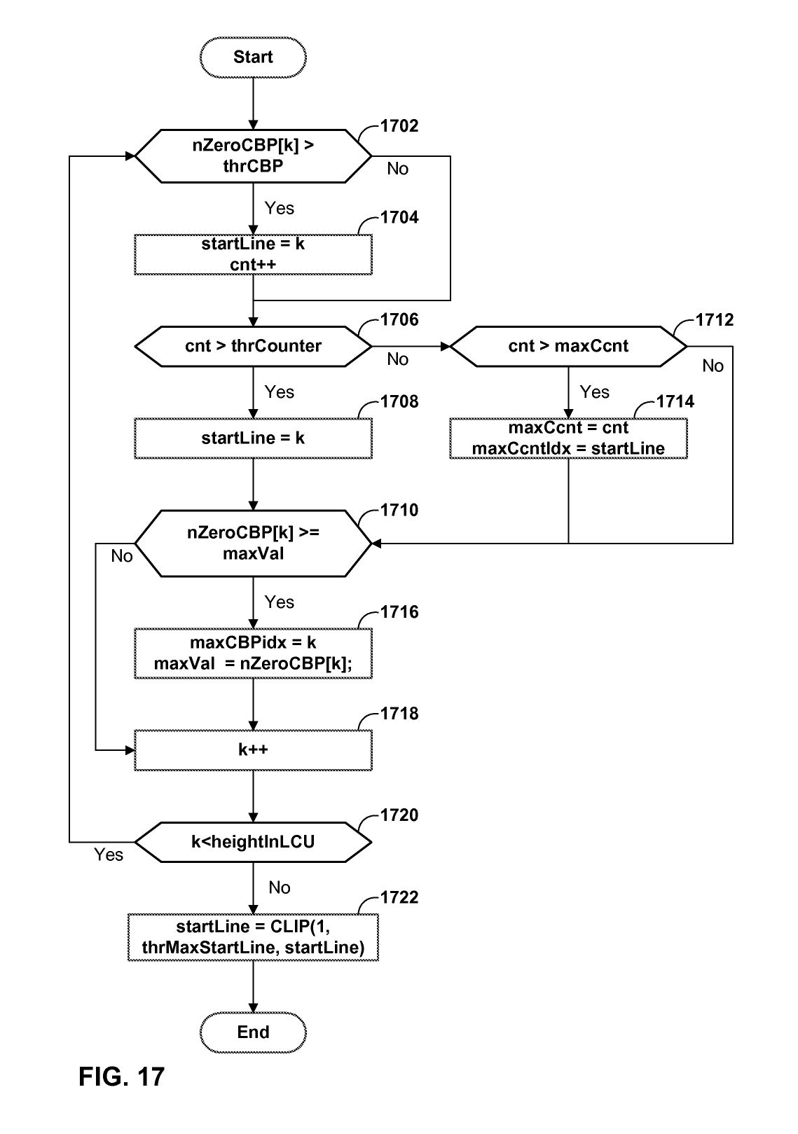

As illustrated in FIG. 17, video encoder 20 may determine a start line for a frame by determining whether a quantity of LCUs in a particular line of a previous frame (e.g., nZeroCBP[k] where k is the particular line of the previous frame) with non-zero transform coefficients is greater than a threshold quantity (e.g., “thrCBP”) (1702). In some examples, video encoder 20 may determine the quantity of LCUs in a line of a previous frame that have one or more non-zero quantized transform coefficients in accordance with the techniques of FIG. 18. If the quantity of LCUs in the particular line of the previous frame with non-zero transform coefficients is greater than the threshold quantity (“Yes” branch of 1702), video encoder 20 may assign the value of an index of the particular line of the previous frame (e.g., “k”) to the start line value and increment a value of an index variable (e.g., “cnt”) (1704), and determine whether the value of the index variable is greater than a threshold index value (e.g., “thrCounter) (1706). If the quantity of LCUs in the particular line of the previous frame with non-zero transform coefficients is not greater than the threshold quantity (“No” branch of 1702), video encoder 20 may determine whether the value of the index variable is greater than the threshold index value (e.g., “thrCounter) (1706).

If the value of the index variable is not greater than the threshold index value (e.g., “thrCounter) (“No” branch of 1706), video encoder 20 may determine whether the value of the index variable is greater than a variable that indicates maximum value (e.g., “maxCcnt”) (1712). If the value of the index variable is greater than the variable that indicates the maximum value (“Yes” branch of 1712), video encoder 20 may assign the value of the index variable (e.g. “cnt”) to the variable that indicates the maximum value (e.g., “maxCcnt”) and assign the value of the start line to a variable that indicates which line of the previous frame is currently determined to be the start line (e.g., “maxCcntIdx”) (1714), and determine whether to increase the start line value (1710). In some examples, video encoder 20 may determine to increase the start line value if the quantity of LCUs in the current line of the previous frame with non-zero transform coefficients (e.g., “nZeroCBP[k]”) is greater than or equal than a variable that indicates a maximum quantity of LCUs with non-zero transform coefficients in any line of the previous frame (e.g., “maxVal”) If the value of the index variable is not greater than the variable that indicates the maximum value (“No” branch of 1712), video encoder 20 may determine whether to increase the start line value (1710). If the value of the index variable is greater than the threshold index value (e.g., “thrCounter) (“Yes” branch of 1706), video encoder 20 may assign the value of an index of the particular line of the previous frame (e.g., “k”) to the start line value (1708), and determine whether to increase the start line value (1710).

If video encoder 20 determines to increase the start line value (“Yes” branch of 1710), video encoder 20 may assign the current line index value to a variable that indicates which line of the previous frame has the greatest quantity of non-zero LCUs (e.g., maxCBPidx), and assign the quantity of LCUs in the current line of the previous frame with non-zero transform coefficients (e.g., “nZeroCBP[k]”) to the variable that indicates a maximum quantity of LCUs with non-zero transform coefficients in any line of the previous frame (e.g., “maxVal”) (1716), and increment the line index value (1718). If video encoder 20 determines not to increase the start line value (“No” branch of 1710), video encoder 20 may increment the line index value (e.g., “k”) (1718). In either case, video encoder 20 may determine whether the incremented line index value (e.g., “k++”) is less than a variable that indicates a frame height in integer of LCUs (e.g., “heightlnLCU”) (1720). If the frame is N LCUs wide by M LCUs high, then the frame height in integer of LCUs may be M and the frame width in integer of LCUs may be N. If the incremented line index value is less than the variable that indicates the frame height in integer of LCUs (e.g., “heightlnLCU”) (“Yes” branch of 1720), video encoder 20 may determine whether or not a quantity of LCUs in a line of the previous frame that corresponds to the incremented line index value (e.g., line k++ of the previous frame) is greater than a threshold quantity (e.g., “thrCBP”) (1702). If the incremented line index value is less than the variable that indicates the frame height in integer of LCUs (e.g., “heightlnLCU”) (“Yes” branch of 1720), video encoder 20 may constrain the start line value between a maximum value (e.g. “theMaxStartLine” and a minimum value (e.g., 1) (1722).

As discussed above, in some examples, video encoder 20 may determine the quantity of LCUs in a line of a previous frame that have one or more non-zero quantized transform coefficients in accordance with the techniques of FIG. 18. As illustrated by FIG. 18, video encoder 20 may determine if a current LCU is the first LCU in a current line of a current frame (1802). If the current LCU is the first LCU in the current line (“Yes” branch of 1802), video encoder 20 may assign the value of zero to a variable that indicates how many LCUs in the current line have non-zero transform coefficients (e.g., “NoneZeroLCU”) (1804), and perform zero block detection (ZBD) (e.g., to determine whether to the quantized coefficients should be encoded or all set to zero) (1806). In some examples, the result of ZBD is that the quantized coefficients should be set to zero, video encoder 20 may set a coded block flag (CBF) to indicate that the coefficients of the current LCU are all zero. If the current LCU is the not first LCU in the current line (“No” branch of 1802), video encoder 20 may perform zero block detection (ZBD) (1806).

Video encoder 20 may determine whether the current LCU includes any non-zero transform coefficients (1808). For instance, video encoder 20 may determine whether the current LCU includes any non-zero transform coefficients based on a coded block flag (CBF) of the current LCU. If the current LCU includes any non-zero transform coefficients (“Yes” branch of 1808), video encoder 20 may increment the variable that indicates how many LCUs in the current line have non-zero transform coefficients (e.g., “NoneZeroLCU”) (1814), and determine whether or not the current LCU is the last LCU in the current line (1812). In some examples, the variable that indicates how many LCUs in the current line have non-zero transform coefficients (e.g., “NoneZeroLCU”) may be the same as nZeroCBP[k] as illustrated in FIG. 17. If the current LCU does not include any non-zero transform coefficients (“No” branch of 1808), video encoder 20 may determine whether or not a current TU is the last TU in the current LCU (1810). If the current TU is not the last TU in the current LCU (“No” branch of 1810), video encoder 20 may perform ZBD on another LCU from the current line (e.g., the next LCU) (1806). If the current TU is the last TU in the current LCU (“Yes” branch of 1810), video encoder 20 may determine whether or not the current LCU is the last LCU in the current line (1812). If the current LCU is not the last LCU in the current line (“No” branch of 1812), video encoder 20 may perform ZBD on another LCU from the current line (e.g., the next LCU) (1806). If the current LCU is the last LCU in the current line (“Yes” branch of 1812), video encoder 20 may determine whether the current line is the last line in the current frame (1816). If the current line is not the last line in the current frame (“No” branch of 1816), video encoder 20 may advance to the next line in the current frame and determine whether an LCU in the next line is the first LCU in the next line (1802). If the current line is the last line in the current frame (“Yes” branch of 1816), video encoder 20 may complete determining the quantity of LCUs in a previous frame that have one or more non-zero quantized transform coefficients.

As discussed above, in some examples, video encoder 20 may determine which frame to use as the complexity reference frame for the current frame in accordance with the techniques of FIG. 19. For instance, video encoder 20 may determine a complexity reference frame for a current frame by determining whether or not a current frame is a first I-frame (1902). If the current frame is a first I-frame (“Yes” branch of 1902), video encoder 20 may assign the QP for the current frame as the QP for the current LCU (1904).

If the current frame is not a first I-frame (“No” branch of 1902), video encoder 20 may determine whether or not the current frame is a first B-frame (1906). If the current frame is a first B-frame (“Yes” branch of 1906), video encoder 20 may use the previous I-frame as the complexity reference frame (1908).

If the current frame is not a first B-frame (“No” branch of 1906), video encoder 20 may determine whether or not the current frame is an I-frame (1910). If the current frame is not an I-frame (“No” branch of 1910), video encoder 20 may use the previous B-frame as the complexity reference frame (1912). If the current frame is an I-frame (“Yes” branch of 1910), video encoder 20 may use the best intra mode in the previous B-frame as the complexity reference frame (1914). In some examples, video encoder 20 may determine the best intra mode in the previous B-frame by determining which intra mode in the previous B-frame has the best RD cost.

FIG. 20 is a conceptual diagram illustrating example operations of a video encoder to determine a complexity reference frame when performing LCU level rate control. As illustrated by FIG. 20, video sequence 2002 includes I-frame 2004, B-frame 2006, B-frame 2008, B-frame 2010, and I-frame 2012. In accordance with the techniques of FIG. 19, video encoder 20 may determine that the no complexity reference frame is available for I-frame 2004 because e.g., it is a first I-frame and no other frames have been processed. Video encoder 20 may determine that the complexity reference frame for B-frame 2006 is I-frame 2004 because B-frame 2006 is a first B-frame after an I-frame. Video encoder 20 may determine that the complexity reference frame for B-frame 2010 is B-frame 2008 because B-frame 2010 is not an I-frame or a first B-frame. Video encoder 20 may determine that the complexity reference frame for I-frame 2012 is a best intra mode from previous B-frame 2010 (e.g., best intra mode cost 2011A of B-frame 2010). Video encoder 20 may determine that the complexity reference frame for B-frame 2014 is the best cost of the previous B-frame (e.g., best cost 2011B of B-frame 2010). Video encoder 20 may determine that the complexity reference frame for B-frame 2016 is B-frame 2014 because B-frame 2014 is the previous B-frame to B-frame 2016. As also illustrated in FIG. 20, video encoder 20 may determine a sum of the best intra mode costs (i.e., the sum of the best cost of all of the LCUs in a frame). Video encoder 20 may use the best intra mode sum cost, along with adjusted frame level complexity and model parameters, to perform rate control for frames.

As discussed above, in some examples, video encoder 20 may initialize one or more parameters in accordance with the techniques of FIG. 21. As illustrated in FIG. 21, video encoder 20 may determine whether or not a current LCU is the top-left LCU of a current frame (2102). If the current LCU is the top-left LCU of the current frame, video encoder 20 may assign the value of zero the a variable that indicates how many bits have been used to encode the current frame, assign the value of zero to a variable that indicates whether an abnormal condition exists, the value of a variable that indicates the determined QP for the current frame (e.g., FrameQP) to a first variable that indicates a QP of a previous frame (e.g., prevQP[0]), the value of a variable that indicates the determined QP for the current frame (e.g., FrameQP) to a second variable that indicates a QP of the previous frame (e.g., prevQP[1]), and the value of a variable that indicates the determined QP for the current frame (e.g., FrameQP) to a variable that indicates the QP for the current LCU (e.g., lcuQP) (2104). In either case, video encoder 20 may assign a difference of a column index of the current LCU (e.g., lcuX) and a delay value (e.g., delay) to a temporary value (2106), and determine whether the temporary value is less than zero (2108). In some examples, the delay value may be in the range of two to eight.

If the temporary value is not less than zero (“No” branch of 2108), video encoder 20 may assign one or more values to one or more parameters based on the temporary value (2112). If the temporary value is less than zero (“Yes” branch of 2108), video encoder 20 may assign a sum of the temporary value and a frame width in integer of LCUs (e.g., lcuW) to the temporary value (2110), and assign one or more values to one or more parameters based on the temporary value (2112). For instance, video encoder 20 may one or more parameters of the current LCU for later use, such as when coding a next LCU as a top line buffer. Some example parameters which may be stored include, but are not limited to, the QP of the current LCU (e.g., LcuQP), the quantity of bits or bins used to code the current LCU, and whether or not the current LCU is skipped.

FIG. 22 is a conceptual diagram illustrating example operations of a video encoder to allocate bits to an LCU when performing LCU level rate control. FIG. 22 includes previous frame 2202 and current frame 2204. In some examples, previous frame 2202 may be the reference complexity frame selected during operation 1504 of FIG. 15. As illustrated in FIG. 22, LCU 2206 of previous frame 2202 may be collocated with LCU 2208 of current frame 2204. In other words, LCU 2206 may occupy the same relative position within previous frame 2202 that LCU 2208 occupies in current frame 2204.

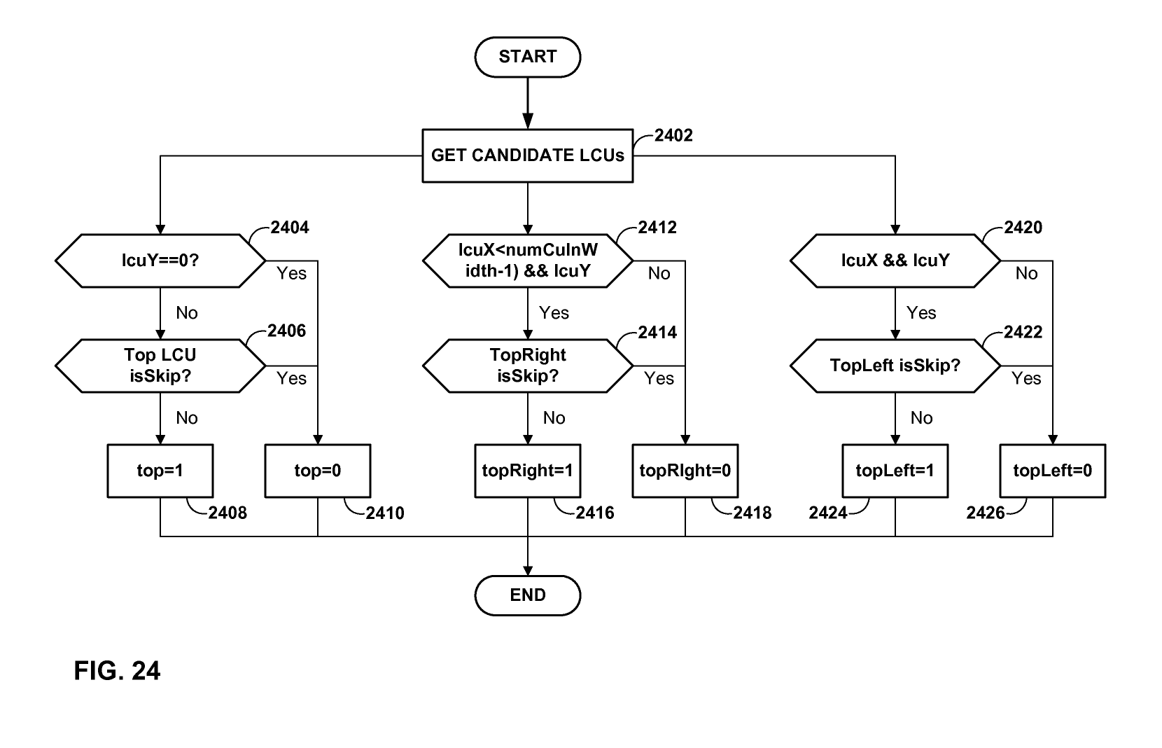

As discussed above, in some examples video encoder may determine a neighboring LCU for a current LCU when performing LCU level rate control in accordance with the techniques of FIG. 23. For instance, video encoder 20 may check the validity of the LCUs that neighbor the current LCU (e.g., the top-right LCU, the top LCU, and the top-left LCU relative to the current LCU) (2302). In some examples, video encoder 20 may check the validity because if a neighboring LCU is skipped, its QP may be useless for determining the QP for the current LCU. In some examples, video encoder 20 may check the validity of the neighboring LCUs in accordance with the techniques of FIG. 24 and FIG. 26.

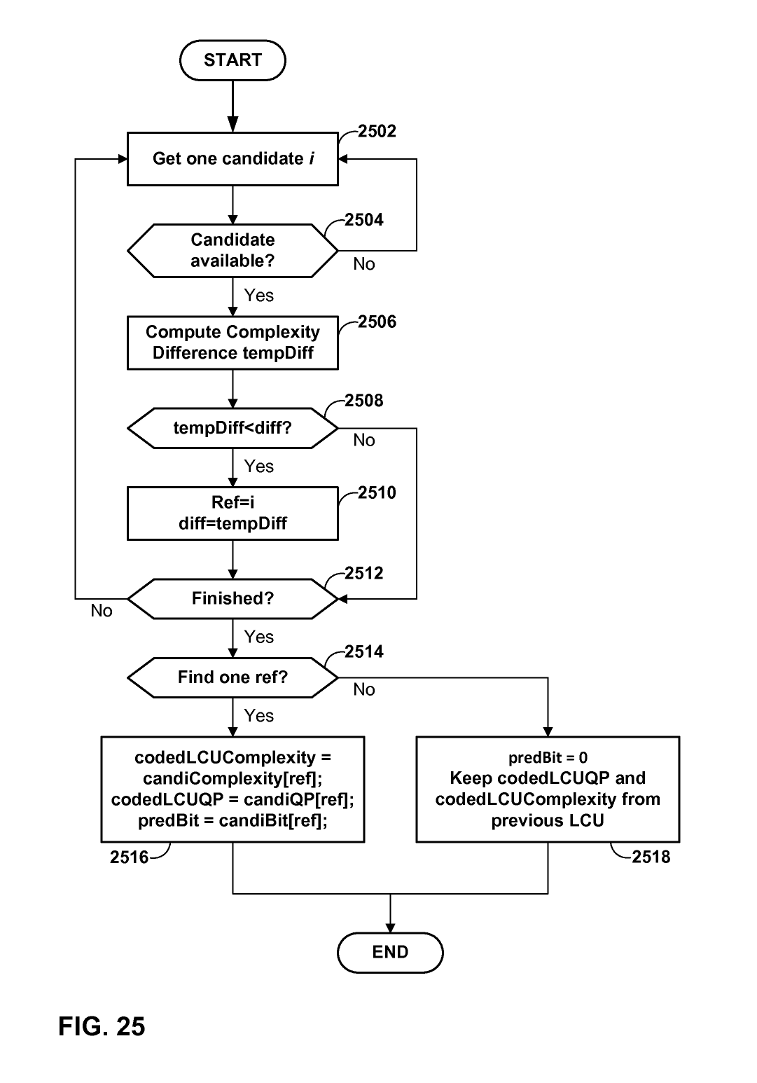

If at least one of the neighboring LCUs is valid, video encoder 20 may determine which of the valid neighboring LCUs is the most similar to the current LCU (2304). In some examples, video encoder 20 may determine which of the neighboring LCUs is the most similar to the current LCU in accordance with the techniques illustrated in FIG. 25. If none of the neighboring LCUs are valid, video encoder 20 may use the average ratio of the current frame as a reference. In some examples, video encoder 20 may determine the average ratio in accordance with equation (15), above, where C^{currentFrame} is the complexity of the current frame.

Video encoder 20 may determine one or more parameters of the determined most similar LCU. For instance, video encoder 20 may get the complexity, bits, and QP of the determined most similar LCU (2306). In some examples, video encoder 20 may determine the one or more parameters of the determined most similar LCU in accordance with the techniques illustrated in FIGS. 25-26.

As discussed above, in some examples, video encoder 20 may determine whether or not a candidate neighboring LCU is a valid reference LCU for a current LCU when performing LCU level rate control in accordance with the techniques of FIG. 24. For instance, video encoder 20 may get the candidate neighboring LCUs (2402). For instance, video encoder 20 may identify the top-left LCU relative to the current LCU (e.g., LCU 2606 of FIG. 26 relative to LCU 2604 of FIG. 26), the top LCU relative to the current LCU (e.g., LCU 2608 of FIG. 26 relative to LCU 2604 of FIG. 26), and the top-right LCU relative to the current LCU as illustrated in FIG. 26 (e.g., LCU 2610 of FIG. 26 relative to LCU 2604 of FIG. 26).

Video coder 20 may determine whether or not the current LCU is in the top row of the current frame (2404). If the current LCU is in the top row of the current frame (“Yes” branch of 2404), video coder 20 may determine that the top LCU may not be a valid reference LCU (2410). If the current LCU is not in the top row of the current frame (“No” branch of 2404), video coder 20 may determine whether or not the top LCU is skipped (2406). If the top LCU is skipped (“Yes” branch of 2406), video coder 20 may determine that the top LCU may not be a valid reference LCU (2410). If the top LCU is not skipped (“No” branch of 2406), video coder 20 may determine that the top LCU may be a valid reference LCU (2408).

Video coder 20 may determine whether or not the current LCU is both not in the top row and not in the right most column of the current frame (2412). If the current LCU is either in the top row or in the right most column of the current frame (“No” branch of 2412), video coder 20 may determine that the top-right LCU may not be a valid reference LCU (2418). If the current LCU is both not in the top row and not in the right most column of the current frame (“Yes” branch of 2412), video coder 20 may determine whether or not the top-right LCU is skipped (2414). If the top-right LCU is skipped (“Yes” branch of 2414), video coder 20 may determine that the top-right LCU may not be a valid reference LCU (2418). If the top-right LCU is not skipped (“No” branch of 2414), video coder 20 may determine that the top-right LCU may be a valid reference LCU (2416).

Video coder 20 may determine whether or not the current LCU is both not in the top row and not in the left most column of the current frame (2420). If the current LCU is either in the top row or in the left most column of the current frame (“No” branch of 2420), video coder 20 may determine that the top-left LCU may not be a valid reference LCU (2426). If the current LCU is both not in the top row and not in the left most column of the current frame (“Yes” branch of 2420), video coder 20 may determine whether or not the top-left LCU is skipped (2422). If the top-left LCU is skipped (“Yes” branch of 2422), video coder 20 may determine that the top-left LCU may not be a valid reference LCU (2426). If the top-left LCU is not skipped (“No” branch of 2422), video coder 20 may determine that the top-left LCU may be a valid reference LCU (2424).

As discussed above, in some examples, video encoder 20 may determine which candidate neighboring LCU is most similar to the current LCU in accordance with the techniques of FIG. 25. For instance, video encoder 20 may get a candidate neighboring LCU (2502) and determine whether or not the candidate neighboring LCU is available (2504). As discussed above, in some examples, video encoder 20 may determine whether or not the candidate neighboring LCU is available in accordance with the techniques of FIG. 24. If the candidate neighboring LCU is not available (“No” branch of 2504), video encoder 20 may get another candidate neighboring LCU (2502). If the candidate neighboring LCU is available (“Yes” branch of 2504), video encoder 20 may compute a complexity difference between the complexity value of the candidate neighboring LCU and the complexity value of an LCU of the determined complexity reference frame that is collocated with the current LCU (2506). In some examples, video encoder 20 may determine the complexity difference in accordance with equation (15), above.

Video encoder 20 may determine whether or not the determined complexity difference (i.e., tempDiff) is less than a threshold (i.e., diff) (2508). In some examples, video encoder 20 may initialize the threshold to zero prior to determining which candidate neighboring LCU is most similar to the current LCU. If the determined complexity difference is less than the threshold (“Yes” branch of 2508), video encoder 20 may update the value of the threshold with the determined complexity difference and indicate that the current candidate neighboring LCU is the closest match (2510). If the determined complexity difference is not less than the threshold (“No” branch of 2508) or after updating the value of the threshold with the determined complexity difference and indicating that the current candidate neighboring LCU is the closest match (2510), video encoder 20 determine whether or not there are other candidate LCUs available (2512). If there are other candidate LCUs available (“No” branch of 2512), video encoder 20 may get the next candidate LCU (2502).

If there are no other candidate LCUs available (“Yes” branch of 2512), video encoder 20 may determine whether or not any candidate LCUs were found (2514). For instance, video encoder 20 may determine that no candidate LCUs were found where all of the neighboring LCUs are not available. If a candidate LCU was found (“Yes” branch of 2514), video encoder 20 may store the complexity value of the found LCU as the coded LCU complexity value (i.e., C_{CodedLCU}^{real}), the QP of the found LCU as the coded LCU QP value, and the quantity of bits used to code the found LCU as the coded quantity of bits value (i.e., B_{CodedLCU}) (2516). If a candidate LCU was not found (“No” branch of 2514), video encoder 20 may set the coded quantity of bits value to zero, use the coded LCU complexity value and the coded LCU QP value from the previous LCU as the coded LCU complexity value and the coded LCU QP value for the current LCU (2518).

FIG. 26 is a conceptual diagram illustrating example operations of a video encoder to determine a neighboring LCU for an LCU when performing LCU level rate control. As illustrated in FIG. 26, current frame 2602 includes current LCU 2604, top-left neighboring LCU 2606, top neighboring LCU 2608, and top-right neighboring LCU 2610. As discussed above, video encoder 20 may determine which of top-left neighboring LCU 2606, top neighboring LCU 2608, and top-right neighboring LCU 2610 is both available and the best match to current LCU 2604.

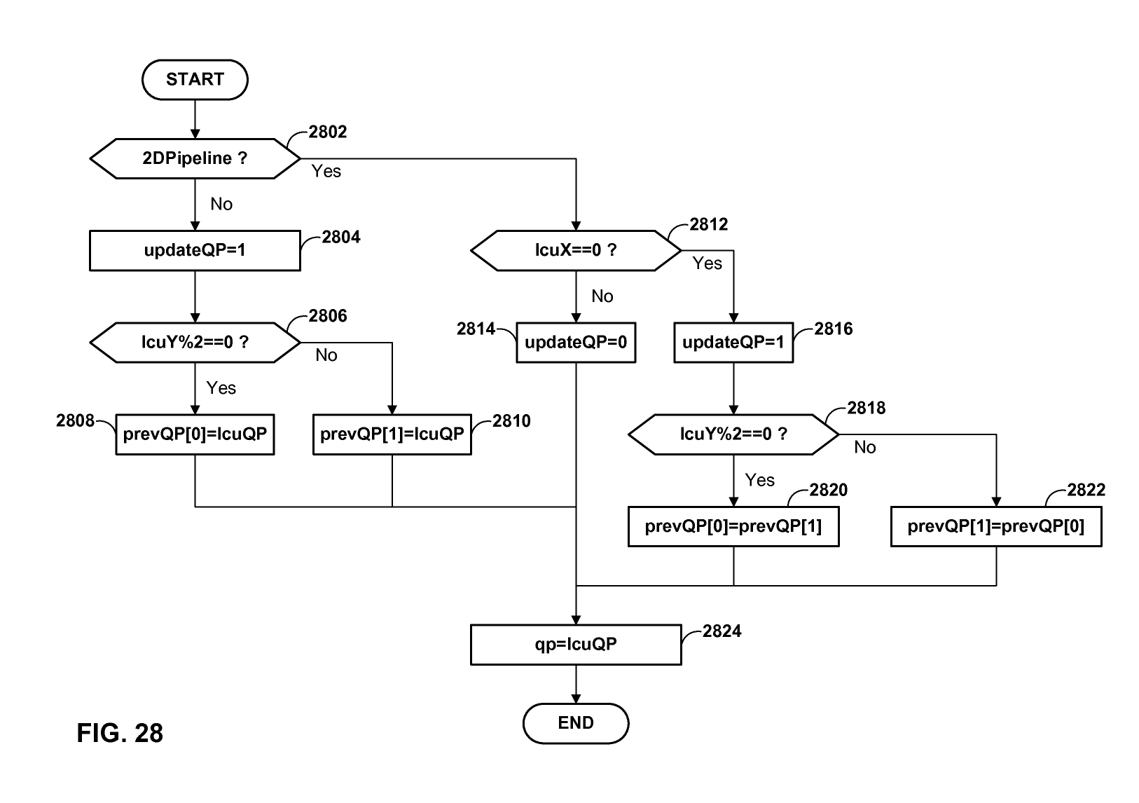

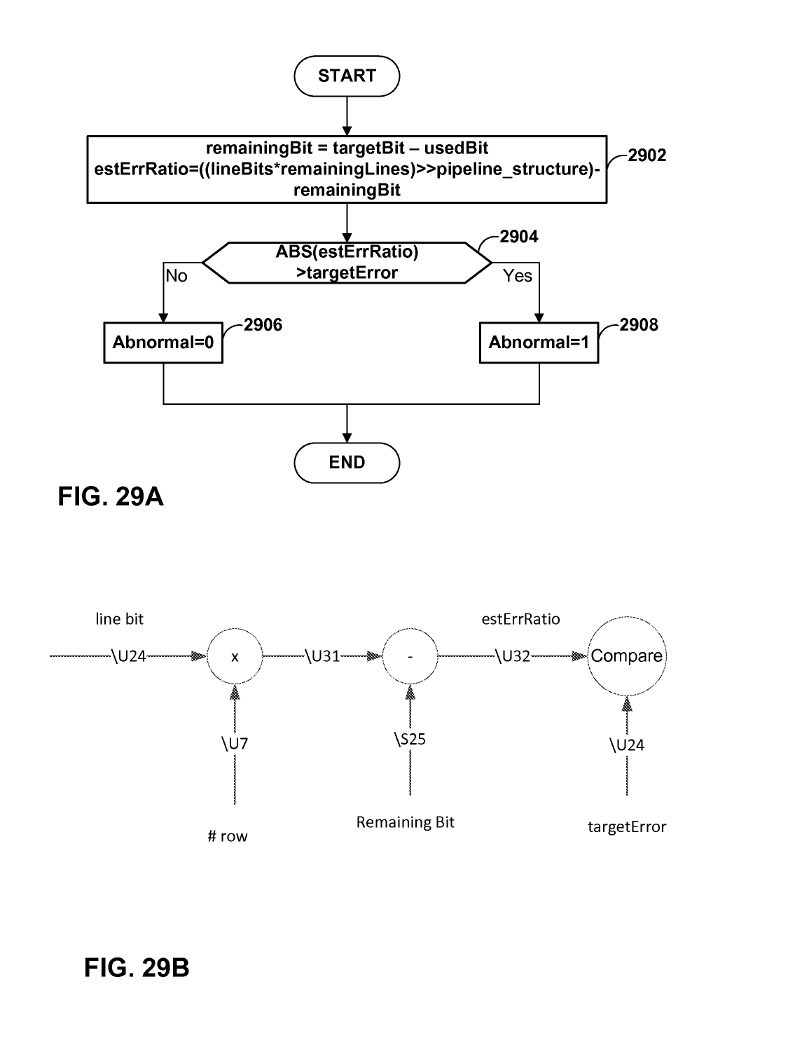

As discussed above, in some examples, video encoder 20 may determine the QP for the current LCU in accordance with the techniques of FIG. 27. As illustrated in FIG. 27, video encoder 20 may initialize a variable prevQP (2702). In some examples, video encoder 20 may initialize the variable prevQP in accordance with the techniques of FIG. 28. Video encoder 20 may determine whether or not a position of the current LCU satisfies one or more conditions with respect to the determined start line (2704). If the position of the current LCU does satisfy the one or more conditions (“Yes” branch of 2704), video encoder 20 may determine whether or not an abnormal condition exists (2706). In some examples, video encoder 20 may check for an abnormal condition before the coding process reaches the start line. In some examples, video encoder 20 may determine whether or not the abnormal condition exists in accordance with the techniques of FIGS. 29A-29B.

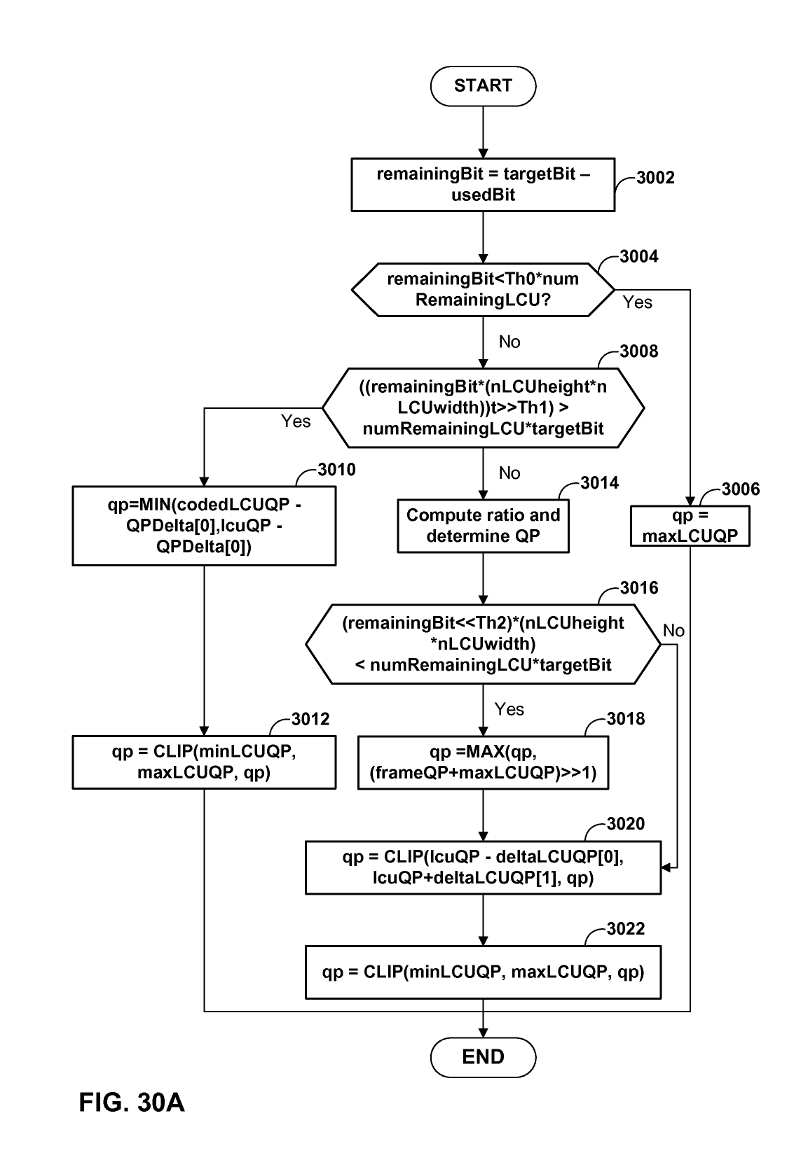

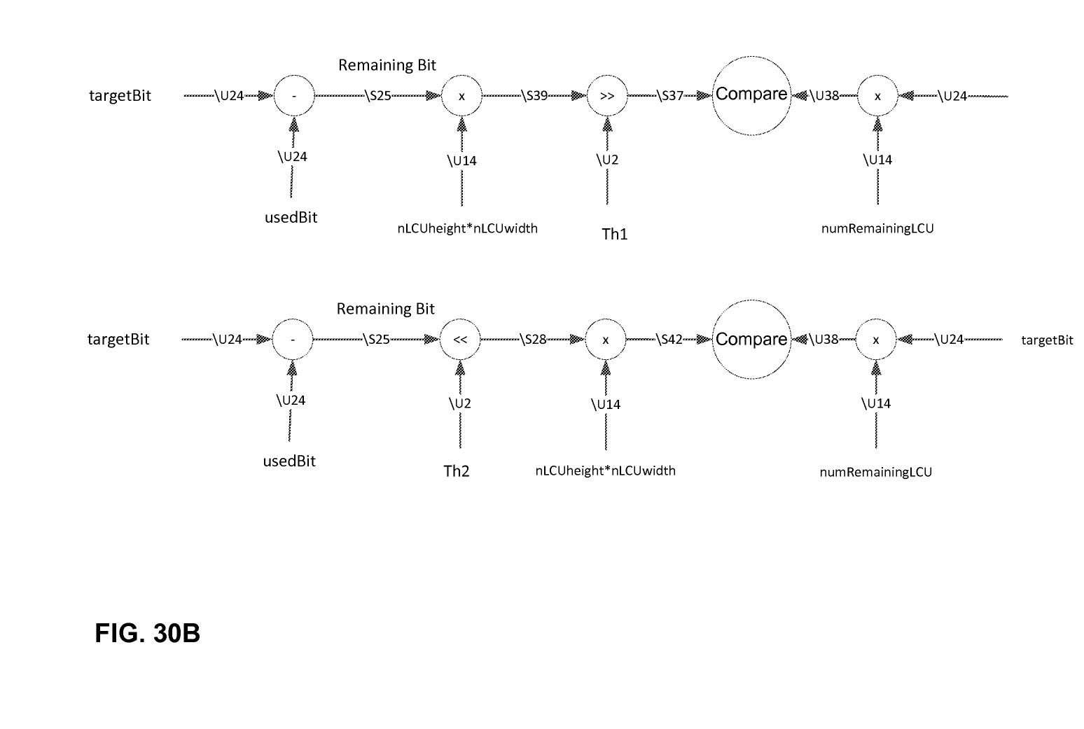

After checking the abnormal condition, video encoder 20 may then perform the QP determination process. As discussed above, video encoder 20 may determine the QP for the current LCU based on the complexity of reference frame. For instance, video encoder 20 may determine the QP for the current LCU based on the ratio of the complexity of the collocated LCU in the reference frame to the complexity of the LCUs in the reference frame collocated with the LCUs in the current frame remaining to be encoded. Video encoder 20 may multiply this ratio by the number of bits remaining for the current frame (i.e., the number of bits allocated to the current frame less the number of bits already used to encode the current frame). If the position of the current LCU does not satisfy the one or more conditions (“No” branch of 2704) or after determining whether or not the abnormal condition exists (2706), video encoder 20 may determine whether or not the pipeline structure satisfies one or more conditions (2708). If the pipeline structure satisfies the one or more conditions (“Yes” branch of 2708), video encoder 20 may determine whether or not at least one condition of one or more conditions is satisfied (2710). For instance, video encoder 20 may determine whether or not the position of the current LCU is after the determined start line, whether or not the abnormal condition exists, or whether or not the current LCU is predicted to exceed a slice boundary (e.g., if enFchangeQP is greater than 0). If at least one condition of the one or more conditions is satisfied (“Yes” branch of 2710), video encoder 20 may estimate the QP for the current LCU (2712). In some examples, video encoder 20 may estimate the QP for the current LCU in accordance with the techniques of FIGS. 30A-30B. If none of the one or more conditions are satisfied (“No” branch of 2710), video encoder 20 may perform one or more operations to update the determined QP for the current LCU (2716), and transform and quantize the current LCU (2718).

If the pipeline structure does not satisfy the one or more conditions (“No” branch of 2708), video encoder 20 may determine the QP for the current LCU based on a QP indicated by the prevQP variable (2714). In any case, video encoder 20 may then perform one or more operations to update the determined QP for the current LCU (2716), and transform and quantize the current LCU (2718).

As discussed above, in some examples, video encoder 20 may initialize the variable prevQP in accordance with the techniques of FIG. 28. As illustrated in FIG. 28, video encoder 20 may determine whether or not the pipeline is a 2D pipeline (2802). If the pipeline is not a 2D pipeline (“No” branch of 2802), video encoder 20 may assign the value of 1 to a variable updateQP to indicate that the QP of the current LCU may be updated (2804), and determine whether or not the current LCU is in an odd numbered row or an even numbered row (2806). For instance, video encoder 20 may determine whether or not the statement lcuY %2=0 evaluates to true. If the current LCU is in an even numbered row (“Yes” branch of 2806), video encoder 20 may assign the value of the variable lcuQP to the variable prevQP[0] (2808). If the current LCU is not in an even numbered row (“No” branch of 2806), video encoder 20 may assign the value of lcuQP to prevQP[1] (2810). In either case, video encoder 20 may assign the value of lcuQP to a variable qp (2824).

As illustrated in FIG. 21, in some examples, the variables lcuQP, prevQP[0], and prevQP[1] may be assigned the value of the variable FrameQP during initialization. Also, as illustrated in FIG. 27, the variable lcuQP may be updated with the determined QP value for a current LCU at operation (2716). In this way, the QP for the current frame may be used to determine the prevQP variable for the first LCU and the QP for the previous LCU may be used to determine the prevQP variable for subsequent LCUs.

If the pipeline is a 2D pipeline (“Yes” branch of 2802), video encoder 20 may determine whether or not the current LCU is in the left-most column (2812). In some examples, video encoder 20 may determine that the current LCU is in the left-most column where the statement lcuX=0 evaluates as true. If the current LCU is not in the left-most column (“No” branch of 2812), video encoder 20 may assign the value of 0 to the variable updateQP to indicate that the QP of the current LCU may not be updated (2814), and may assign the value of lcuQP to a QP for the current LCU (2824). If the current LCU is in the left-most column (“Yes” branch of 2812), video encoder 20 may assign the value of 1 to the variable updateQP to indicate that the QP of the current LCU may be updated (2816), and determine whether or not the current LCU is in an odd numbered row or an even numbered row (2818). For instance, video encoder 20 may determine whether or not the statement lcuY %2=0 evaluates to true. If the current LCU is in an even numbered row (“Yes” branch of 2818), video encoder 20 may assign the value of the variable prevQP[1] to the variable prevQP[0] (2820). If the current LCU is not in an even numbered row (“No” branch of 2818), video encoder 20 may assign the value the variable prevQP[0] to the variable prevQP[1] (2822). In either case, video encoder 20 may assign the value of lcuQP to the QP for the current LCU (2824).

As discussed above, in some examples, video encoder 20 may determine whether or not the abnormal condition exists in accordance with the techniques of FIGS. 29A-29B. FIG. 29B illustrates an example data flow within video encoder 20 that may correspond to the techniques of FIG. 29A.

In some examples, video encoder 20 may check the abnormal condition before the encoding process reaches the determined start line. As illustrated in FIG. 29A, video encoder 20 may determine a value for a variable that indicates a quantity of bits remaining to encode the current frame, and determine an estimated error ratio based on the determined quantity of remaining bits (2902). For instance, video encoder 20 may determine the value for the variable that indicates the quantity of bits remaining to encode the current frame (e.g., remainingBit) by determining a difference between the quantity of bits allocated to the current frame (e.g., targetBit) and the quantity of bits already used to encode the current frame (e.g., usedBit). Video encoder 20 may determine whether or not an absolute value of the determined estimated error ratio is greater than a target error (2904). In some example, the target error may be equal to targetFrameBit>>1. If the absolute value of the determined estimated error ratio is not greater than a target error (“No” branch of 2904), video encoder 20 may determine that the abnormal condition is not present and assign the value of 0 to an abnormal variable (2906). If the estimated err ratio is too large, video encoder 20 may wake up the rate control process. For instance, if the absolute value of the determined estimated error ratio is greater than a target error (“Yes” branch of 2904), video encoder 20 may determine that the abnormal condition is not present and assign the value of 1 to the abnormal variable (2908).

As discussed above, in some examples, video encoder 20 may estimate the QP for the current LCU in accordance with the techniques of FIGS. 30A-30B. FIG. 30B illustrates an example data flow within video encoder 20 that may correspond to the techniques of FIG. 30A.

As illustrated in FIG. 30A, video encoder may determine a value for a variable that indicates a quantity of bits remaining to encode the current frame (3002). For instance, video encoder 20 may determine the value for the variable that indicates the quantity of bits remaining to encode the current frame (e.g., remainingBit) by determining a difference between the quantity of bits allocated to the current frame (e.g., targetBit) and the quantity of bits already used to encode the current frame (e.g., usedBit). Video encoder 20 may determine whether or not the determined quantity of remaining bits satisfies a condition with respect to a quantity of remaining LCUs in the current frame (3004). For instance, video encoder 20 may determine that the determined quantity of remaining bits satisfies the condition where the statement remainingBit<Th0*numRemainingLCU evaluates as true, where remainingBit is the determined quantity of remaining bits, Th0 is a threshold value, and numRemainingLCU is the quantity of remaining LCUs in the current frame. In some examples, the value of the Th0 may be four. If the determined quantity of remaining bits satisfies the condition with respect to the quantity of remaining LCUs in the current frame (“Yes” branch of 3004), video encoder 20 may assign a value of a variable that indicates a maximum allowable QP for all LCUs (e.g., maxLCUQP) to the QP for the current LCU (3006).

If the determined quantity of remaining bits does not satisfy the condition with respect to the quantity of remaining LCUs in the current frame (“No” branch of 3004), video encoder 20 may determine whether or not the determined quantity of remaining bits satisfies a condition with respect to a quantity of remaining LCUs in the current frame and the quantity of bits allocated to the current frame (3008). For instance, video encoder 20 may determine that the determined quantity of remaining bits satisfies the condition where the quantity of remaining bits is too large. Video encoder 20 may determine that the quantity of remaining bits is too large if the statement ((remainingBit*(nLCUheight*nLCUwidth))t>>Th1)>numRemainingLCU*targetBit evaluates as true, where remainingBit is the determined quantity of remaining bits, nLCUheight represents a height of the LCUs, nLCUwidth represents a width of the LCUs, Th1 is a threshold value, numRemainingLCU is the quantity of remaining LCUs in the current frame, and targetbit is the quantity of bits allocated to the current frame. In some examples, the value of the Th1 may be three. If the determined quantity of remaining bits satisfies the condition with respect to the quantity of remaining LCUs in the current frame and the quantity of bits allocated to the current frame (“Yes” branch of 3008), video encoder 20 may assign the lesser of a first value and a second value to the QP for the current LCU (3010). In some examples, the first value may be determined based on a difference between variable that indicates the QP of the neighboring reference LCU (e.g., codedLCUQP as determined in accordance with the techniques of FIG. 25) and QPDelta[0]. In some examples, the second value may be determined based on a difference between the variable lcuQP and QPDelta[0]. After assigning the lesser of the first value and the second value to the QP for the current LCU, video encoder 20 may constrain the QP for the current LCU between a maximum value and a minimum value (3012). For instance, video encoder 20 may constrain the QP for the current LCU such that the value of the variable is between the value of the variable that indicates a maximum allowable QP for all LCUs (e.g., maxLCUQP), and a variable that indicates a minimum allowable QP for all LCUs (e.g., minLCUQP).

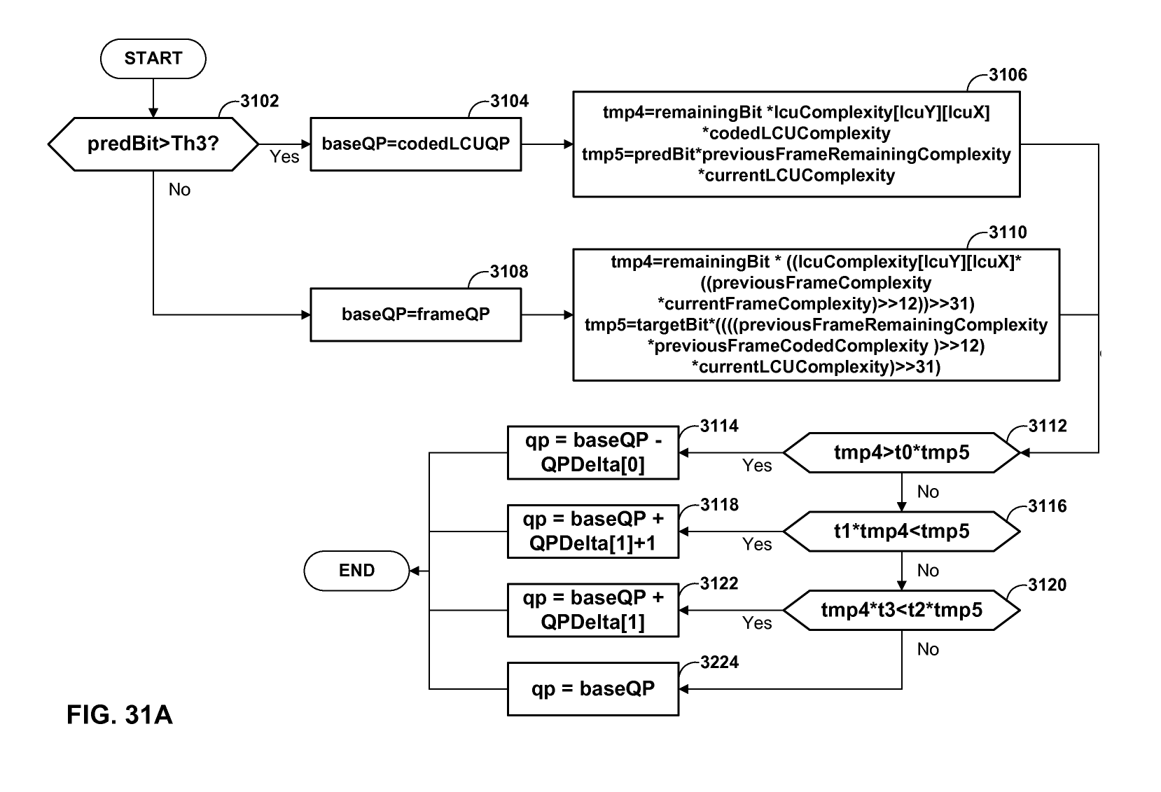

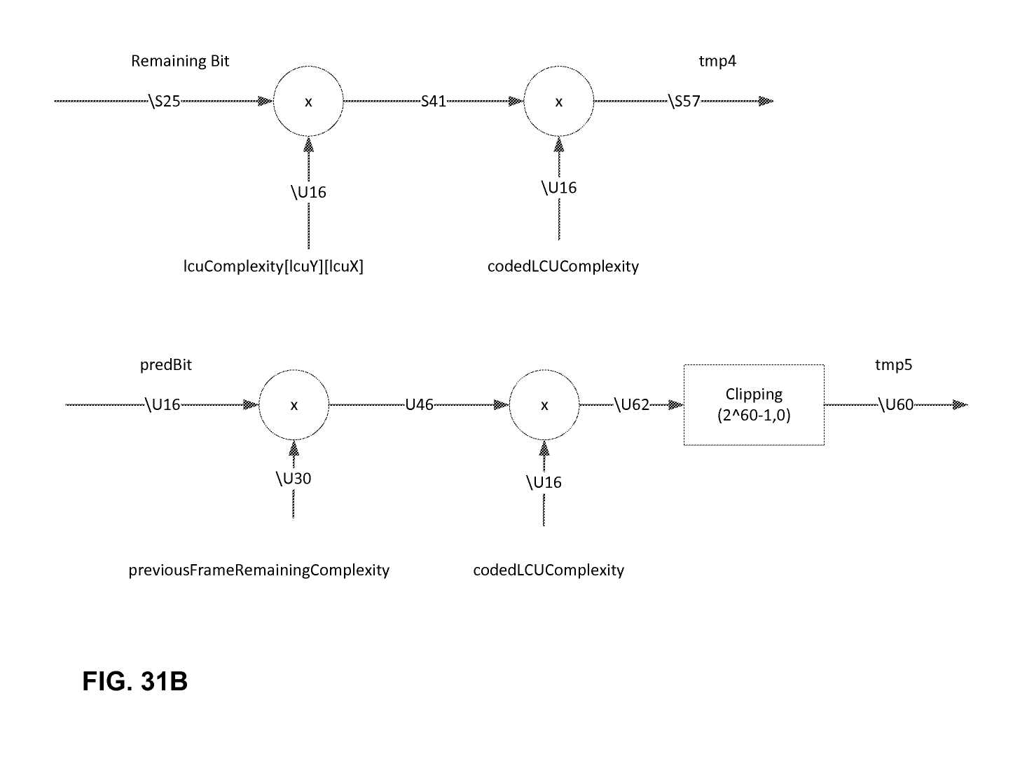

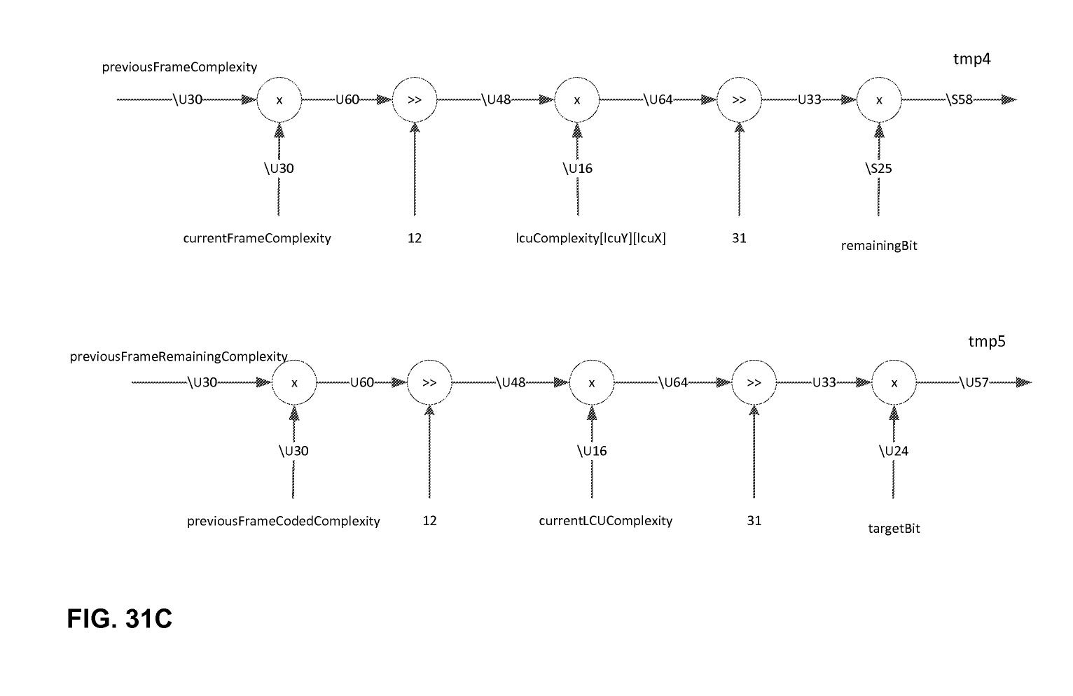

If the determined quantity of remaining bits does not satisfy the condition with respect to the quantity of remaining LCUs in the current frame and the quantity of bits allocated to the current frame (“No” branch of 3008), video encoder 20 may compute one or more ratios and determine a QP value for the current LCU (3014). In some examples, video encoder 20 may compute the one or more ratios and determine the QP value for the current LCU in accordance with the techniques of FIGS. 31A-31C.

Video encoder 20 may determine, based at least on the quantity of remaining bits, a threshold value, the quantity of LCUs remaining to be encoded, whether or not the QP for the current LCU should be increased (3016). For instance, video encoder 20 may determine that the QP for the current LCU should be increased if the expression (remainingBit<<Th2)*(nLCUheight*nLCUwidth)<numRemainingLCU*targetBit evaluates to true. In some examples, the value of Th2 may be three. If the QP for the current LCU should be increased (“Yes” branch of 3016), video encoder 20 may assign a value based on the greater of the QP for the current LCU and a value based on the frameQP variable and the variable that indicates a maximum allowable QP for the current LCU (3018). In either case, (i.e., after assigning the value based on the greater of the QP for the current LCU and the value based on the frameQP variable and the variable that indicates the maximum allowable QP for the current LCU to the QP for the current LCU, or if the QP for the current LCU should not be increased (“No” branch of 3016)), video encoder 20 may constrain the value of the QP for the current LCU to between a maximum and a minimum value (3020). For instance, video encoder 20 may constrain the value of the QP for the current LCU to between a first value based on the lcuQP variable and the deltaLCUQP[0] variable, and a second value based on the lcuQP value and the deltaLCUQP[1] variable.

After constraining the value of the qp variable (3020), video encoder 20 may again constrain the QP for the current LCU between a maximum value and a minimum value (3022). For instance, video encoder 20 may constrain the QP for the current LCU such that the value of the variable is between the value of the variable that indicates a maximum allowable QP for all LCUs (e.g., maxLCUQP), and the variable that indicates the minimum allowable QP for all LCUs (e.g., minLCUQP).

As discussed above, in some examples, video encoder 20 may compute the one or more ratios and determine the QP value for the current LCU in accordance with the techniques of FIGS. 31A-31C. FIGS. 31B-31C illustrates an example data flow within video encoder 20 that may correspond to the techniques of FIG. 31A.

As illustrated in FIG. 31A, video coder 20 may determine whether or not a variable that indicates a quantity of bits predicted to encode the current LCU (e.g., the variable predBit determined in accordance with the techniques of FIG. 25) is greater than a threshold value (e.g., Th3) (3102). In some examples, the value of the Th3 may be four. If the variable that indicates the quantity of bits predicted to encode the current LCU is greater than the threshold value (“Yes” branch of 3102), video encoder 20 may assign the value of the variable that indicates the QP of the neighboring reference LCU (e.g., codedLCUQP as determined in accordance with the techniques of FIG. 25) to a baseQP variable that indicates a QP value on which the QP value for the current LCU may be based (3104), determine a first value (i.e., tmp4) and a second value (i.e., tmp5) (3106). If the variable that indicates the quantity of bits predicted to encode the current LCU is not greater than the threshold value (“No” branch of 3102), video encoder 20 may assign the value of the variable that indicates the QP of the current frame (e.g., the QP for the current frame as determined in accordance with the techniques of FIG. 6) to the baseQP variable (3108), determine a first value (i.e., tmp4) and a second value (i.e., tmp5) (3110).

In either case, video encoder 20 may determine whether or not the first value satisfies a first condition with respect to the second value (3112). In some examples, video encoder 20 may determine that the first value satisfies the first condition with respect to the second value where the first value is greater than the second value scaled by a first threshold (i.e., t0). In some examples, the value of the first threshold may be four. If the first value satisfies the first condition with respect to the second value (“Yes” branch of 3112), video encoder 20 may determine that a difference between the baseQP variable and the QPDelta[0] variable is the QP for the current LCU (3114).

If the first value does not satisfy the first condition with respect to the second value (“No” branch of 3112), video encoder 20 may determine whether or not the first value satisfies a second condition with respect to the second value (3116). In some examples, video encoder 20 may determine that the first value satisfies the second condition with respect to the second value where the first value, when scaled by a second threshold (i.e., t1), is less than the second value. In some examples, the value of the second threshold may be five. If the first value satisfies the second condition with respect to the second value (“Yes” branch of 3116), video encoder 20 may determine that a sum of the baseQP variable and the QPDelta[1] variable plus one is the QP for the current LCU (3118).

If the first value does not satisfy the second condition with respect to the second value (“No” branch of 3116), video encoder 20 may determine whether or not the first value satisfies a third condition with respect to the second value (3120). In some examples, video encoder 20 may determine that the first value satisfies the third condition with respect to the second value where the second value, when scaled by a third threshold (i.e., t2) is less than the first value, when scaled by a fourth threshold (i.e., t3). In some examples, the value of the third threshold may be six. In some examples, the value of the fourth threshold may be ten. If the first value satisfies the third condition with respect to the second value (“Yes” branch of 3120), video encoder 20 may determine that a sum of the baseQP variable and the QPDelta[1] variable is the QP for the current LCU (3122). If the first value does not satisfy the third condition with respect to the second value (“No” branch of 3120), video encoder 20 may determine that the baseQP variable is the QP for the current LCU (3124).

Video encoder 20 may then use the determined QP for the current LCU to quantize the coefficients of the current LCU. In some examples, video encoder 20 may then update the LCU rate control data. As discussed above, in some examples, video encoder 20 may then update the LCU rate control data in accordance with the techniques of FIG. 32. In some examples, video encoder 20 may update the LCU rate control data by assigning a quantity of bits predicted based on a number of non-zero transform coefficients to a variable that represents a quantity of bits predicted for future encoding use (e.g., predBit[0])

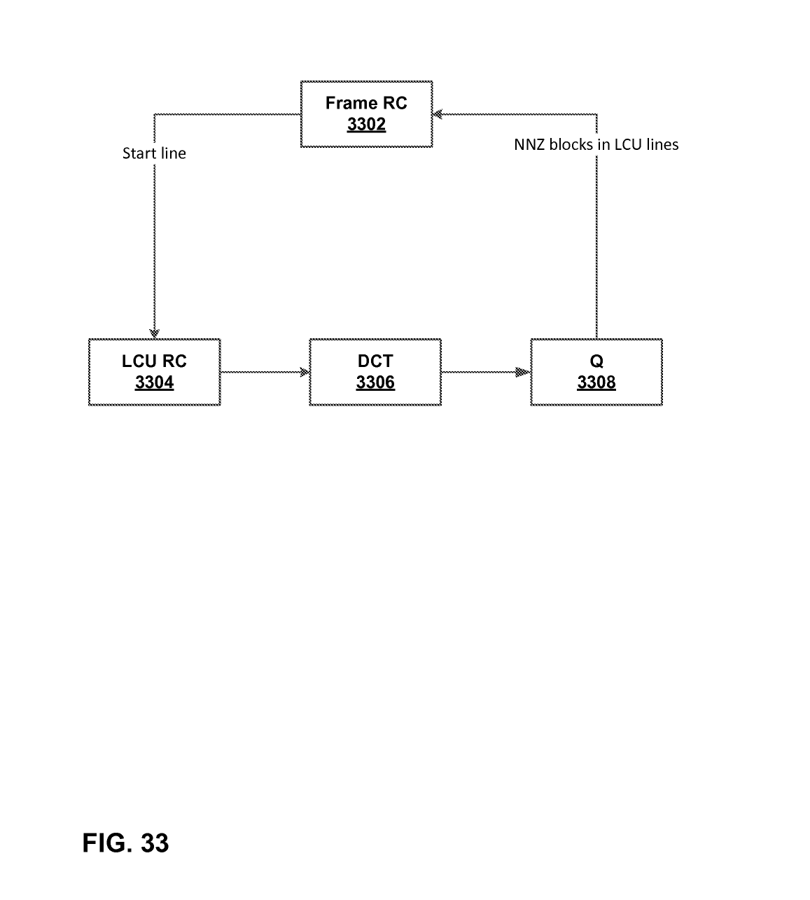

In some examples, after quantization, the number of nonzero blocks in each line may be accumulated for use when determining the start line for a subsequent frame as discussed above in LCU-level RC. In some examples, video encoder 20 may accumulate the number of nonzero blocks in each line in accordance with the techniques illustrated in FIG. 34. In other words, the number of LCUs which have non-zero quantized levels after quantization in each row may be returned back to the start line decision block in the firmware of video encoder 20. In some examples, a non-zero CBP accumulator of video encoder 20 may manage the number of nonzero blocks and write back to firmware memory, which may specified by firmware, after quantizing all MBs within a frame. In some examples, the data may flow within video encoder 20 in accordance with the illustration in FIG. 33. For a 4096×2160 frame, 128×8 bit buffers of firmware memory may be used. In some examples, the nonzero block is decided by the final CBF flags. For instance, if all the fields of CBF are zero, the nonzero block is zero.

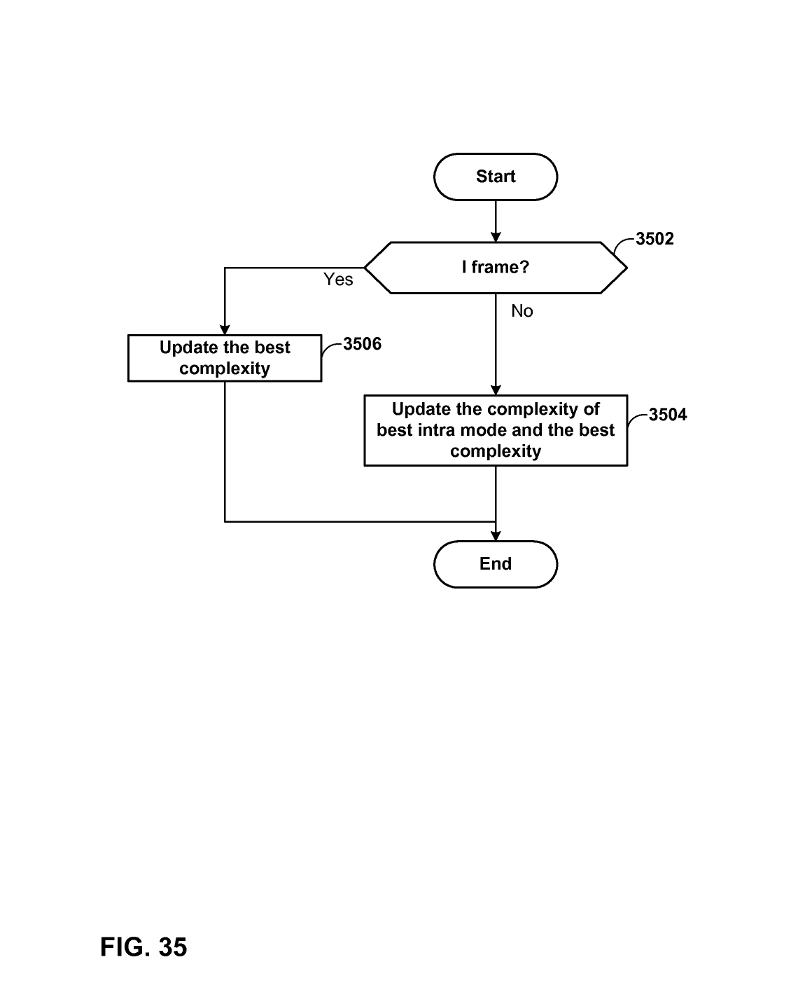

Additionally, as subsequent frames may utilize the current frame as a complexity reference, video encoder 20 may update the complexity of the current frame. In some examples, video encoder 20 may update the complexity of each frame in accordance with the techniques illustrated in FIG. 35.

In some examples, after the QP is determined by the rate control module of video encoder 20, the lambda may be changed accordingly. For instance, the QP-rLambda (which is the relationship between QP and sqrt(Lambda)) may be calculated in the firmware of video encoder 20 and then may be passed to transform and rate control engine (TRE) via software interface (SWI). In some examples, the LUT used for QP-rLambda may be 52*8 bits.

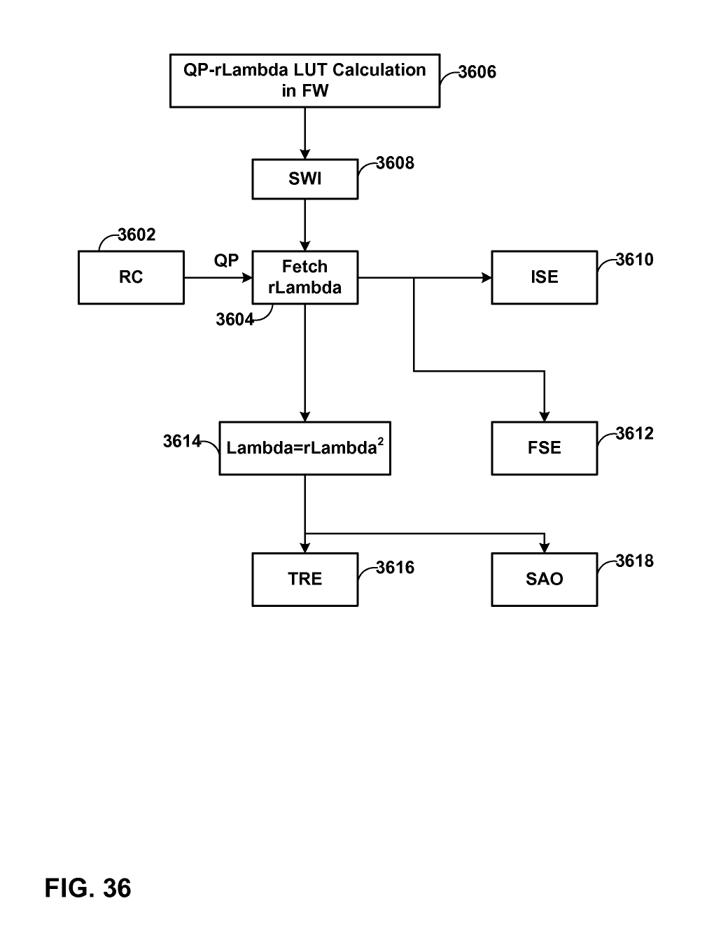

In some examples, video encoder 20 may perform the lambda updating process in accordance with the techniques illustrated in FIG. 36. For instance, after rate control, video encoder 20 may use the QP to look up the QP-rLambda LUT for the rLambda and calculate Lambda. In some examples, rLambda may be used for integer search engine (ISE) and fractional search engine (FSE), and Lambda may be used in TRE and sample adaptive offset (SAO).

As discussed above, in some examples, video encoder 20 may update the LCU rate control data in accordance with the techniques of FIG. 32. As illustrated in FIG. 32, video encoder 20 may update the LCU rate control data by updating the value of the variable that indicates how many bits are predicted to code the current LCU (e.g., predBit[0]) based on a quantity of bits predicted to code the current LCU determined using NNZ bit prediction (e.g., NNZPredBit), and update the value of a variable that indicates a quantity of bits used to code the current frame (e.g., usedBit) based on the updated value of the variable that indicates how many bits are predicted to code the current LCU (e.g., predBit[0]), and further update the value of the variable that indicates the quantity of bits used to code the current frame (e.g., usedBit) based on the previously updated value of the variable, a value of a variable that indicates a quantity of bits predicted to code a previous LCU (e.g., predBit[delay], where a delay value of 1 indicates a quantity of bits predicted to code the immediately previous LCU), and a variable that indicates a quantity of bits actually used to code the previous LCU (e.g., codedBit) (3202).

Video encoder 20 may determine whether the pipeline structure satisfies one or more conditions (3204). If the pipeline structure satisfies the one or more conditions (“Yes” branch of 3204), video encoder 20 may assign zero to the value of a variable that indicates a quantity of bits used to code a current line (e.g., lineBit) (3206), and update the value of a variable that indicates a quantity of bits used to code a current line (e.g., lineBit) based on the variable that indicates a quantity of bits actually used to code the previous LCU (e.g., codedBit), the value of the variable that indicates the quantity of bits predicted to code a previous LCU (e.g., predBit[delay], and the value of the variable that indicates how many bits are predicted to code the current LCU (e.g., predBit[0]) (3208). If the pipeline structure does not satisfy the one or more conditions (“No” branch of 3204), video encoder 20 update the value of a variable that indicates a quantity of bits used to code a current line (e.g., lineBit) based on the variable that indicates a quantity of bits actually used to code the previous LCU (e.g., codedBit), the value of the variable that indicates the quantity of bits predicted to code a previous LCU (e.g., predBit[delay], and the value of the variable that indicates how many bits are predicted to code the current LCU (e.g., predBit[0]) (3208). In either case, video encoder 20 may determine whether or not the current LCU is skipped (3210).

If the current LCU is skipped (“Yes” branch of 3210), video encoder 20 may assign the QP of a previous LCU (e.g., the LCU in a row defined by lcuY mod 2) to the QP for the current LCU (3212, 3214), and update one or more variables based on the complexity of the current LCU (3216). If the current LCU is not skipped (“No” branch of 3210), video encoder 20 may update one or more variables based on the complexity of the current LCU (3216). For instance, video encoder 20 may update the variable that indicates the remaining complexity of the previous frame based on the complexity of the previous LCU, the variable that indicates the complexity of the current frame based on the complexity of the current LCU, and store the complexity of the current LCU in a matrix that indicates the complexities of a plurality of LCUs.

As discussed above, in some examples, data may flow within video encoder 20 in accordance with the illustration in FIG. 33. As illustrated by FIG. 33, frame level rate controller 3302 may receive information that indicates a quantity of blocks in lines of LCUs that include non-zero quantized transform coefficients. Based on the quantity of blocks in lines of LCUs that include non-zero quantized transform coefficients, frame level rate controller 3302 may determine a start line for a current LCU and provide the determined start line to LCU level rate controller 3304. LCU level rate controller 3304 may perform LCU level rate control to determine a QP for a current LCU and provide the determined QP to quantizer (Q) 3308. Transformer 3306 may perform a transform, such as a discrete cosine transform (DCT), on the current LCU and provide the resulting transform coefficients to quantizer 3308. Quantizer 3308 may quantize the transform coefficients based on the QP determined by LCU rate controller 3304 and determine a quantity of blocks in lines the current LCU that include non-zero quantized transform coefficients.

As discussed above, in some examples, video encoder 20 may accumulate the number of nonzero blocks in each line in accordance with the techniques illustrated in FIG. 34. As illustrated by FIG. 34, video encoder 20 may initialize a row index, a column index, and a variable that indicates a quantity of blocks in a current row of a current LCU that include non-zero quantized transform coefficients (3402). In some examples, video encoder 20 may initialize the row index, the column index, and the variable that indicates the quantity of blocks in the current row of the current LCU that include non-zero quantized transform coefficients to zero. Video encoder 20 may determine whether an LCU indicated by the row index and the column index includes any non-zero quantized transform coefficients (3404). In some examples, video encoder 20 may determine whether the LCU indicated by the row index and the column index includes any non-zero quantized transform coefficients based on a coded block flag of the LCU indicated by the row index and the column index.

If the LCU indicated by the row index and the column index does not include any non-zero quantized transform coefficients (“Yes” branch of 3404), video encoder 20 may set the value of a syntax element that indicates whether or not the LCU indicated by the row index and the column index is skipped to true (3410), and determine whether or not the there are any more LCUs in the current row (3408). If the LCU indicated by the row index and the column index does include some non-zero quantized transform coefficients (“No” branch of 3404), video encoder 20 may increment the variable that indicates the quantity of blocks in the current row of the current LCU that include non-zero quantized transform coefficients, and set the value of the syntax element that indicates whether or not the LCU indicated by the row index and the column index is skipped to false (3406), and determine whether or not the there are any more LCUs in the current row (3408). If there are more LCUs in the current row (“No” branch of 3408), video encoder 20 may advance to another LCU in the current row (e.g., increment the column index) and determine whether the other LCU in the current row includes any non-zero quantized transform coefficients (3404). If there are not any more LCUs in the current row (“Yes” branch of 3408), video encoder 20 may determine whether the current row is the last row in the current frame (3410). If the current row is not the last row in the current frame (“No” branch of 3410), video encoder 20 may advance to the next row and determine whether an LCU in the next row includes any non-zero quantized transform coefficients (3404).

As discussed above, video encoder 20 may select a complexity reference frame based on the frame type of a particular frame. As one example, if the particular frame is an I-frame, video encoder 20 may select the best intra mode cost of a previous B-frame as the complexity reference frame. As another example, if the particular frame is a B-frame, video encoder 20 may select the best complexity of a previous B-frame as the complexity reference frame. As such, after determining the complexity of a current frame, video encoder 20 may update the complexity of each frame so, e.g., the current frame may be used as a reference frame. As discussed above, in some examples, video encoder 20 may update the complexity of each frame in accordance with the techniques illustrated in FIG. 35. As illustrated by FIG. 35, video encoder 20 may determine whether or not a current frame is an I-frame (3502). If the current frame is not an I-frame (“No” branch of 3502), video encoder 20 may update the complexity of the best intra mode and the best complexity (3504). If the current frame is an I-frame (“Yes” branch of 3502), video encoder 20 may update the best complexity (3506).

As discussed above, in some examples, video encoder 20 may perform the lambda updating process in accordance with the techniques illustrated in FIG. 36. For instance, after rate control (3602), video encoder 20 may use the QP to determine rLambda (3604). For instance, video encoder 20 may access the QP-rLambda LUT (3606) via software interface (SWI) (3608) to determine rLambda. In some examples, video encoder 20 may utilize the determined rLambda for integer search engine (ISE) (3610) and/or fractional search engine (FSE) (3612). In some examples, video encoder 20 may determine Lambda as rLambda squared (3614). In some examples, video encoder 20 may utilize the determined Lambda for transform and rate control (TRE) (3616) and sample adaptive offset (SAO) (3618).

As discussed above, in some examples, video encoder 20 may perform slicing to determine the slice boundary for each frame in accordance with the techniques of FIGS. 37A-37B. In accordance with one or more techniques of this disclosure, video encoder 20 may make two slice boundary decisions. For instance, video encoder 20 may make a first conservative slice boundary decision which will try to be conservative and early determinate the slice boundary. When determining the conservative slice boundary, video encoder 20 may some information shared by rate control (if enabled) to predict the bits for current LCU and also the bit for the right LCU. Video encoder 20 may then use this information to predict if current LCU will exceed the slice boundary or if the next LCU will possibly exceed the slice boundary. Video encoder 20 may also consider the number of remaining allocated bits to check if the current LCU will exceed the slice boundary when the target allocated bits is achieved.

If rate control is enabled, video encoder 20 may modify the QP of one or more LCUs to prevent the bits from exceeding the slice boundary. Video encoder 20 may use the exceedSlice variable to measure possibility of the LCU exceeding the slice and to change the QP of current LCU. Video encoder 20 may then make a second, more accurate, slice boundary decision using the NNZ information to predict the bit which is more accurate and make the final slice boundary decision.

As illustrated by FIG. 37A, video encoder 20 may determine whether a slice number of the current LCU (i.e., sliceNumLCU) satisfies a condition with respect to a delay value (3702). In some examples, video encoder 20 may determine that the slice number of the current LCU satisfies the condition with respect to the delay value where the slice number of the current LCU is greater than or equal to the delay value. If the slice number of the LCU satisfies the condition with respect to the delay value (“Yes” branch of 3702), video encoder 20 may determine a difference between a quantity of bits used to code a previous LCU and a quantity of bits predicted to code the current LCU (i.e., slicePredBit[delay]) (3704), and determine whether or not the current LCU is both not in the top row or the left most column (3706). If the slice number of the LCU does not satisfy the condition with respect to the delay value (“No” branch of 3702), video encoder 20 may determine whether or not the current LCU is both not in the top row or the left most column (3706).

If the current LCU is both in the top row and in the left most column (“Yes” branch of 3706), video encoder 20 may initialize one or more variables (3708) and determine whether or not the current LCU is in the left most column (3710). For instance, video encoder 20 may initialize a numSlice variable to zero, a variable that indicates a quantity of bits used to code the current slice to zero, assign a frame width in integer of LCUs to a leftSlicePos variable, a absTopSlicePos variable to zero, and a variable that indicates that possibility of an LCU exceeding a slice boundary (e.g., exceedSlice) to zero. If the current LCU is either not in the top row or not in the left most column (“No” branch of 3706), video encoder 20 may determine whether or not the current LCU is in the left most column (3710).

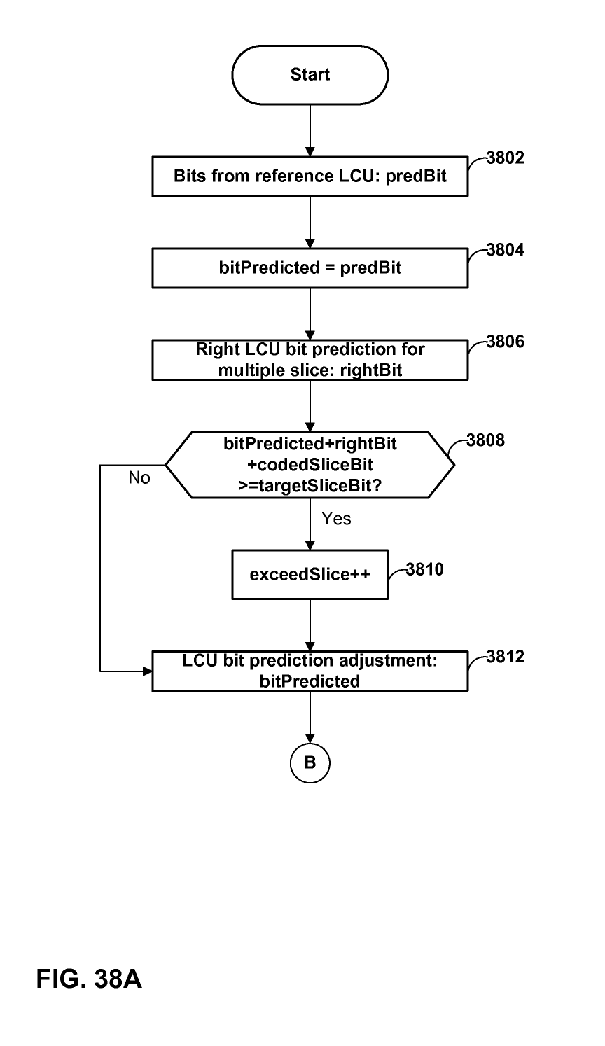

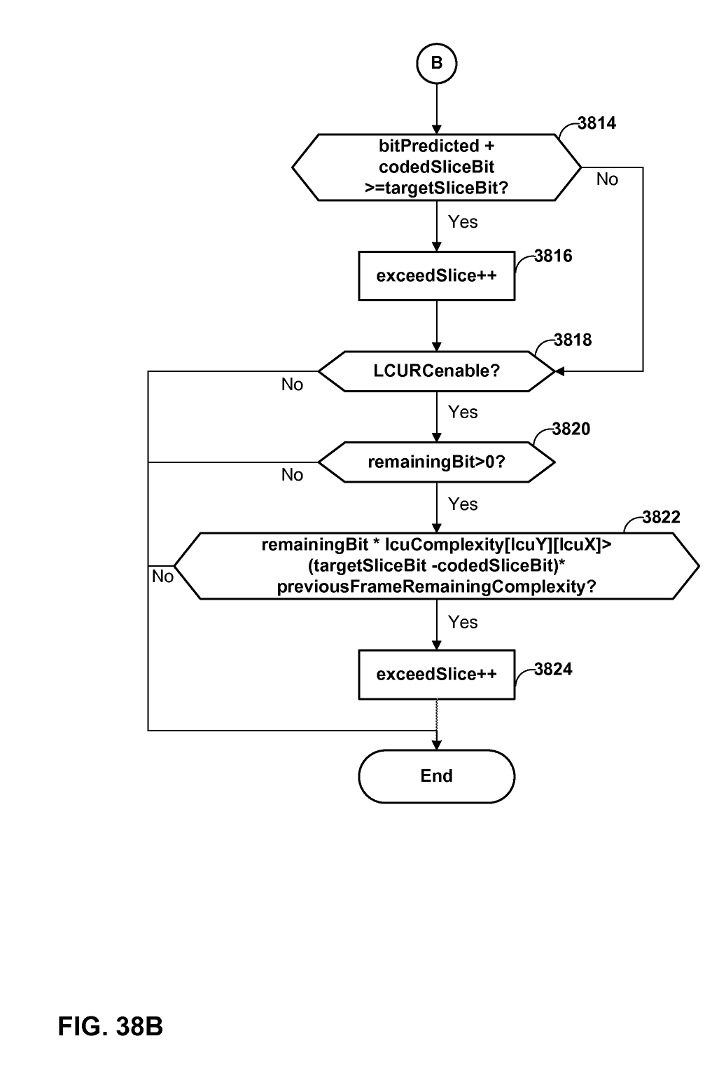

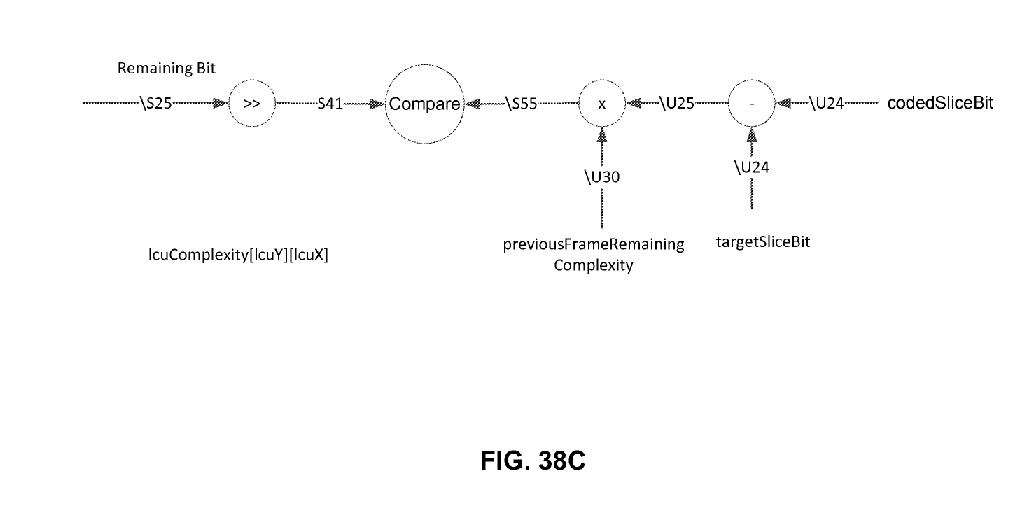

If the current LCU is not in the left most column (“Yes” branch of 3710), video encoder 20 may perform a conservative slice boundary decision (3712), and (advancing through “A” to FIG. 37B) determine whether or not LCU level rate control is enabled (3714). In some examples, video encoder 20 may perform the conservative slice boundary decision in accordance with the techniques of FIGS. 38A-38C. If the current LCU is in the left most column (“No” branch of 3710), video encoder 20 may (advancing through “A” to FIG. 37B) determine whether or not LCU level rate control is enabled (3714).

If LCU level rate control is not enabled (“No” branch of 3714), video encoder 20 may perform an accurate slice boundary decision (3728) and add the value of the quantity of bits used to code a previous LCU and a quantity of bits predicted to code the current slice (i.e., slicePredBit[0]) to the quantity of bits allocated to code the current slice (3730). If LCU level rate control is enabled (“Yes” branch of 3714), video encoder 20 may determine if the value of an exceedslice variable is greater than zero (3716). If the value of the exceedslice variable is greater than zero (“Yes” branch of 3716, video encoder 20 may set the value of a variable that indicates whether or not the QP of the current LCU should be changed to true (3718). In either case (i.e., after setting the value of the variable that indicates whether or not the QP of the current LCU should be changed to true or if the value of the exceedslice variable is not greater than zero (“No” branch of 3716), video encoder 20 may perform rate control to determine the QP for the current LCU (3720). In some examples, video encoder 20 may perform rate control in accordance with the techniques of FIG. 4.

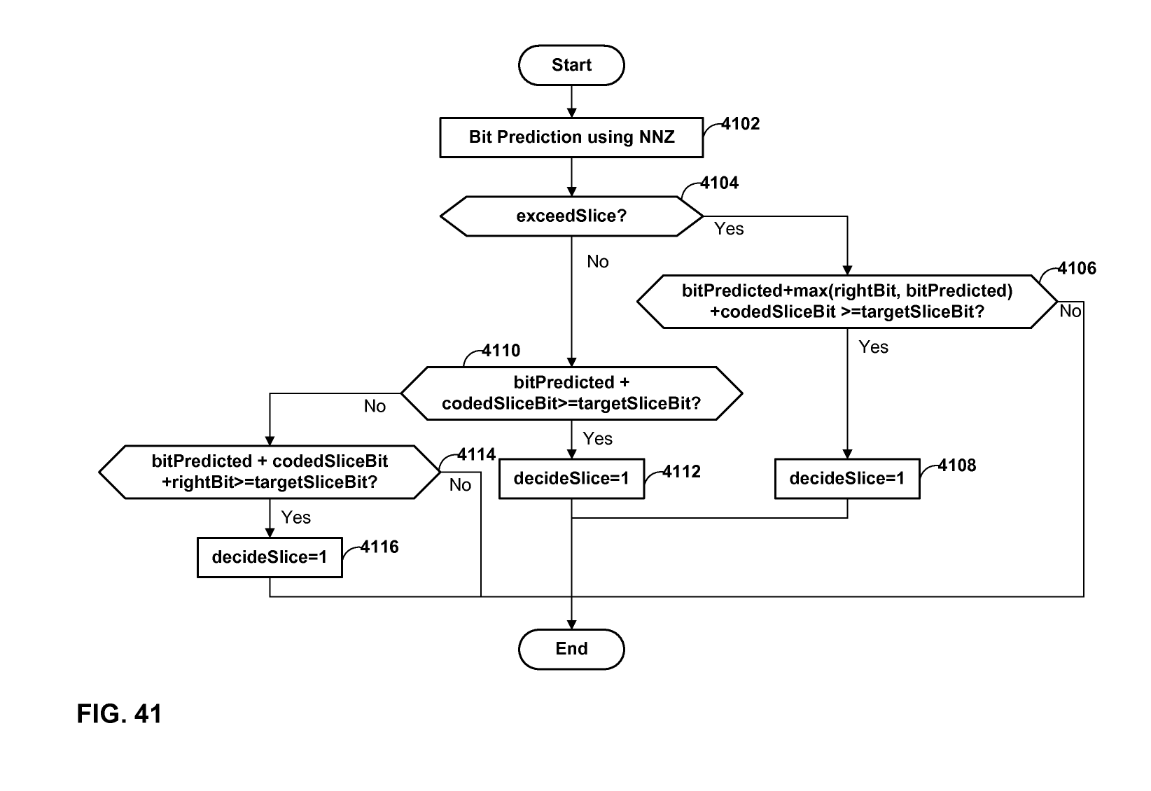

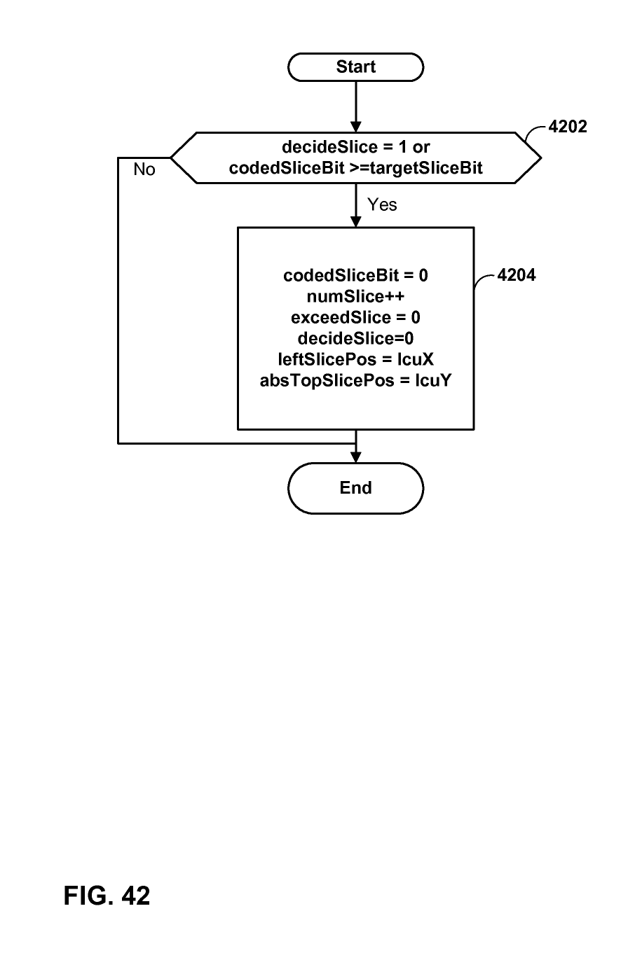

After performing rate control, video encoder 20 may determine whether the value of the exceedslice variable is greater than 1 (3722). If the value of the exceedslice variable is not greater than 1 (“No” branch of 3722), video encoder 20 may perform an accurate slice boundary decision (3728) and add the value of the quantity of bits used to code a previous LCU and a quantity of bits predicted to code the slice (i.e., slicePredBit[0]) to the quantity of bits allocated to code the current slice (3730). If the value of the exceedslice variable is greater than 1 (“Yes” branch of 3722), video encoder 20 may modify the determined QP value for the current LCU based on the value of the exceedslice variable (3724). For instance, video encoder 20 may add the value of the exceedslice variable minus one to the determined QP value for the current LCU. Video encoder 20 may constrain the QP for the current LCU between a maximum value and a minimum value (3726). For instance, video encoder 20 may constrain the QP for the current LCU such that the value of the variable is between the value of the variable that indicates a maximum allowable QP for all LCUs (e.g., maxLCUQP), and a variable that indicates a minimum allowable QP for all LCUs (e.g., minLCUQP). Video encoder 20 may perform an accurate slice boundary decision (3728) and add the value of the quantity of bits used to code a previous LCU and a quantity of bits predicted to code the slice (i.e., slicePredBit[0]) to the quantity of bits allocated to code the current slice (3730). In some examples, video encoder 20 may perform the accurate slice boundary decision in accordance with the techniques of FIG. 41. Video encoder 20 may then perform the slice decision in accordance with the techniques of FIG. 42.

As discussed above, in some examples, video encoder 20 may perform a conservative slice boundary decision in accordance with the techniques of FIGS. 38A-38C. FIG. 38C illustrates an example data flow within video encoder 20 that may correspond to the techniques of FIGS. 38A-38B.

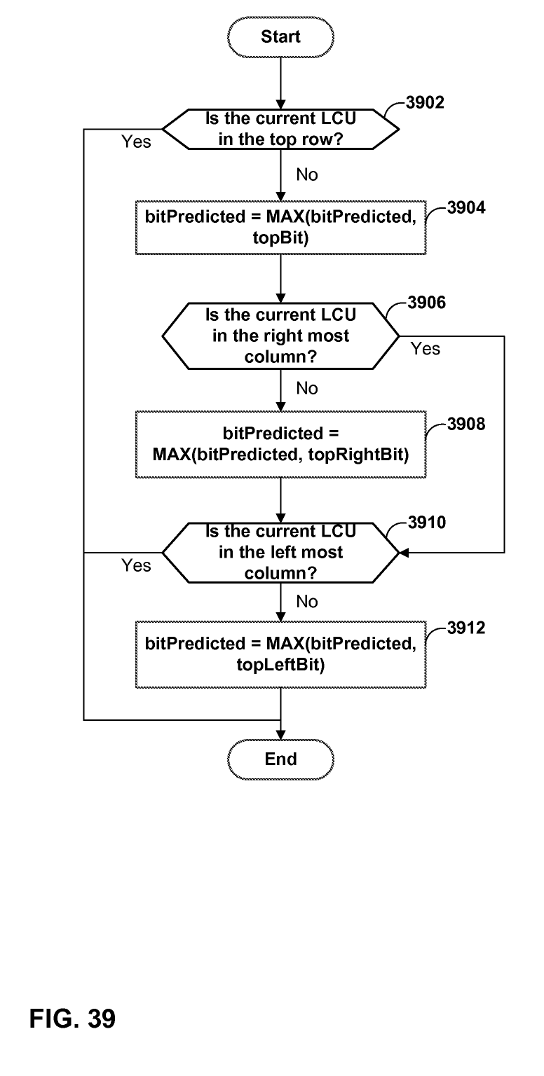

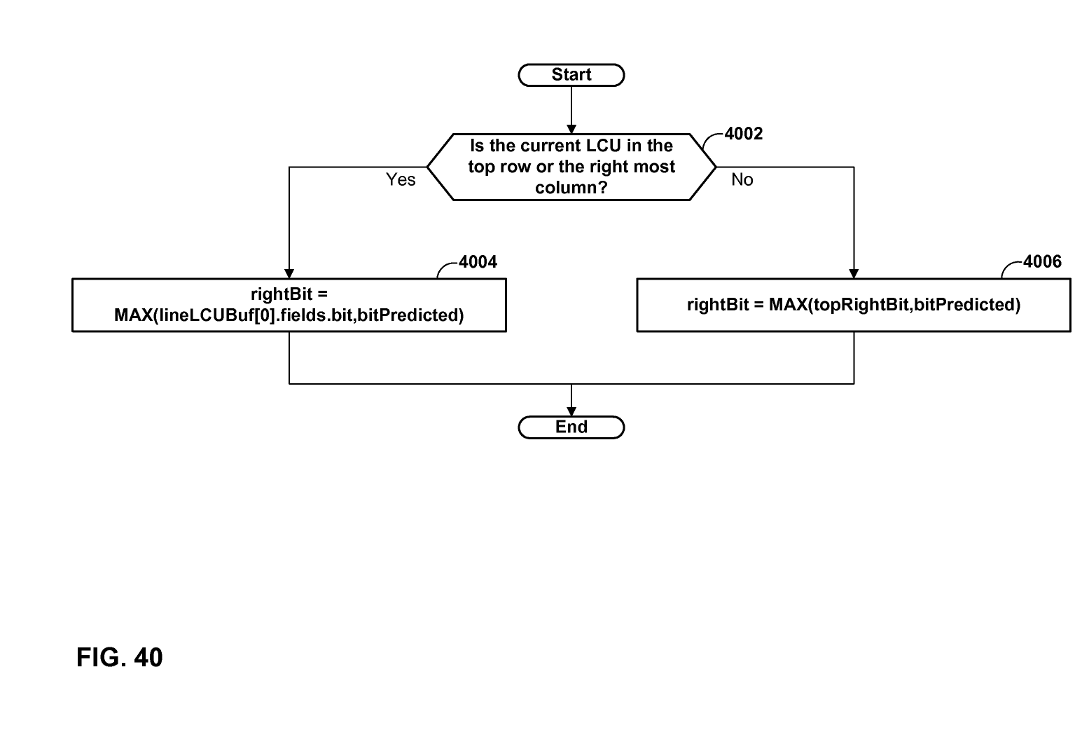

As illustrated by FIG. 38A, video encoder 20 may determine a quantity of bits used to coder a reference LCU (3802). As discussed above, the reference LCU may be a neighboring LCU of the current LCU. Video encoder 20 may assign the value of the quantity of bits predicted to code the current LCU from the predBit variable to a bitPredicted variable (3804). Video encoder 20 may perform right LCU bit prediction to determine a rightBit variable that indicates a quantity of bits likely needed to code the next LCU (3806). In some examples, video encoder 20 may perform right LCU bit prediction in accordance with the techniques of FIG. 40. Video encoder 20 may determine whether encoding the current LCU and the next LCU in the current slice would exceed the current slice (3808). Video encoder 20 may determine that the current slice would be exceeded if a sum of the quantity of bits predicted to code the current LCU (e.g., bitPredicted), the quantity of bits predicted to code the next LCU (e.g., rightBit), and the quantity of bits already used to code the current slice (e.g., codedSliceBit) is greater than the target quantity of bits for the current slice (e.g., targetSliceBit). If encoding the current LCU and the next LCU in the current slice would exceed the current slice (“Yes” branch of 3808), video encoder 20 may increment the exceedSlice variable (3810). In either case, video encoder 20 may perform LCU bit prediction adjustment (3812), and (advancing through “B” to FIG. 38B) determine whether encoding the current LCU in the current slice would exceed the current slice (3814). In some examples, video encoder 20 may perform LCU bit prediction adjustment in accordance with the techniques of FIG. 39. In some examples, video encoder 20 may determine that the sum satisfies the condition with respect to the targetSliceBit variable where the sum is greater than or equal to the targetSliceBit variable.

If encoding the current LCU in the current slice would exceed the current slice (“Yes” branch of 3814), video encoder 20 may increment the exceedSlice variable (3816) and determine whether or not LCU level rate control is enabled (3818). If encoding the current LCU in the current slice would not exceed the current slice (“No” branch of 3814), video encoder 20 may determine whether or not LCU level rate control is enabled (3818). If LCU rate control is not enabled (“No” branch of 3818), video encoder 20 may complete the conservative slice boundary decision. If LCU level rate control is enabled (“Yes” branch of 3818), video encoder 20 may determine whether or not the value of the remainingBit variable is greater than zero (3820). If the value of the remainingBit variable is not greater than zero (“No” branch of 3820), video encoder 20 may complete the conservative slice boundary decision. If the value of the remainingBit variable is greater than zero (“Yes” branch of 3820), video encoder 20 may determine, based on the complexity of the previous frame, whether encoding the current LCU in the current slice would exceed the current slice (e.g., whether the remainingBit variable times the complexity of the current LCU is greater than the quantity of bits remaining to code the current slice times the remaining complexity of the previous frame) (3822). If encoding the current LCU in the current slice would exceed the current slice (“Yes” branch of 3822), video encoder 20 may increment the value of the exceedSlice variable (3824). If encoding the current LCU in the current slice would not exceed the current slice (“No” branch of 3822), video encoder 20 may complete the conservative slice boundary decision.

As discussed above, in some examples, video encoder 20 may perform LCU bit prediction adjustment in accordance with the techniques of FIG. 39. As illustrated by FIG. 39, video encoder 20 may determine whether the current LCU is in the top row of the current frame (3902). If the current LCU is not in the top row (“No” branch of 3902), video encoder 20 may predict the quantity of bits to encode the current LCU as the greater of the previously predicted quantity of bits needed to encode the current LCU (e.g. bitPredicted) and the quantity of bits used to encode the LCU positioned above the current LCU (e.g., topBit) (3904), and determine whether the current LCU is in the right most column of the current frame (3906). If the current LCU is in the top row (“Yes” branch of 3902), video encoder 20 may complete the LCU bit prediction adjustment.

If the current LCU is in the right most column of the current frame (“Yes” branch of 3906), video encoder 20 may determine whether the current LCU is in the left most column of the current frame (3910). If the current LCU is not in the right most column of the current frame (“No” branch of 3906), video encoder 20 may predict the quantity of bits to encode the current LCU as the greater of the previously predicted quantity of bits needed to encode the current LCU (e.g. bitPredicted) and the quantity of bits used to encode the LCU positioned above and to the right of the current LCU (e.g., topRightBit) (3908), and determine whether the current LCU is in the left most column of the current frame (3910).

If the current LCU is not in the left most column of the current frame (“No” branch of 3910), video encoder 20 may predict the quantity of bits to encode the current LCU as the greater of the previously predicted quantity of bits needed to encode the current LCU (e.g. bitPredicted) and the quantity of bits used to encode the LCU positioned above and to the left of the current LCU (e.g., topLeftBit) (3912), and complete the LCU bit prediction adjustment. If the current LCU is in the left most column of the current frame (“Yes” branch of 3910), video encoder 20 may complete the LCU bit prediction adjustment.

As discussed above, in some examples, video encoder 20 may perform right LCU bit prediction in accordance with the techniques of FIG. 40. For instance, video encoder 20 may perform right LCU bit prediction to predict a quantity of bits which may be used to encode the next LCU. As illustrated in FIG. 40, video encoder 20 may determine whether the current LCU is in the top row or in the right most column of the current frame (4002). If the current LCU is either in the top row or in the right most column of the current frame (“Yes” branch of 4002), video encoder 20 may determine the rightBit variable based on the a quantity of bits used to encode a first LCU in a row adjacent to the current row (e.g., lineLCUBuf[0].fields.bit) and a quantity of bits previously predicted to encode the current LCU (4004). If the current LCU is both not in the top row and not in the right most column of the current frame (“No” branch of 4002), video encoder 20 may determine the rightBit variable based on the a quantity of bits used to encode LCU located to the top-right of the current LCU (e.g., topRightBit) and a quantity of bits previously predicted to encode the current LCU (4006). In either case, video encoder 20 may determine the rightBit variable as the greater of the two variables.

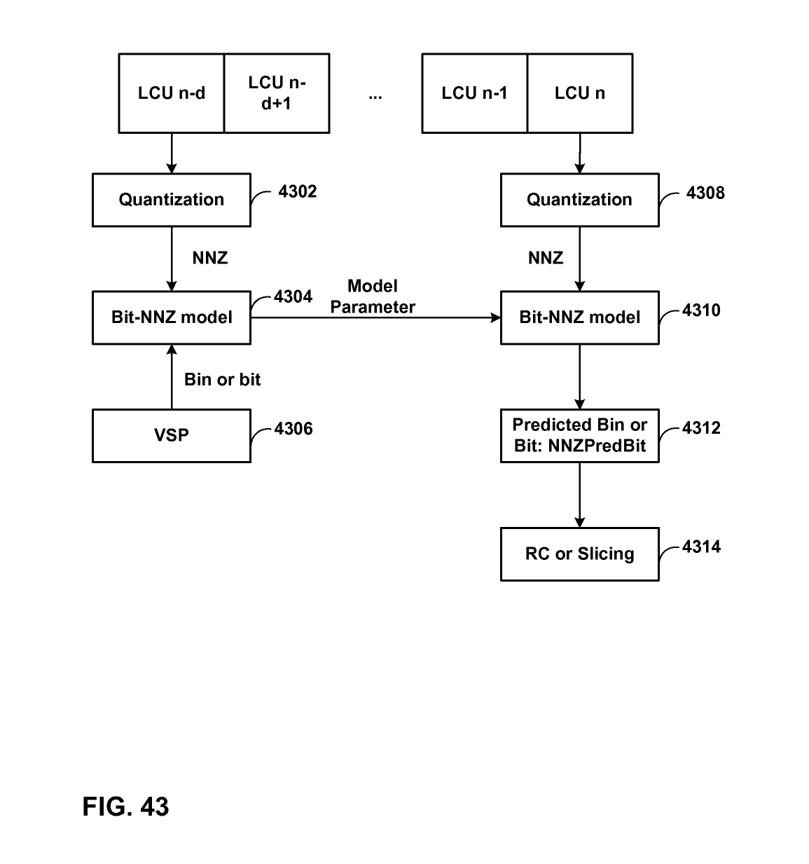

As discussed above, in some examples, video encoder 20 may perform an accurate slice boundary decision in accordance with the techniques of FIG. 41. As illustrated in FIG. 41, video encoder 20 may perform bit prediction (4102). In some examples, video encoder 20 may perform bit prediction using NNZ in accordance with the techniques of FIG. 43. Video encoder 20 may determine whether or not the value of the exceedSlice variable is equal to zero (e.g., whether or not the current LCU and or the next LCU are predicted to exceed the current slice) (4104). If the value of the exceedSlice variable is not equal to zero (“Yes” branch of 4104), video encoder 20 may determine whether a sum of the quantity of bits predicted to encode the current LCU, the quantity of bits already used to encode the current slice, and the greater of the quantity of bits predicted to encode the current LCU and the quantity of bits predicted to encode the next LCU is greater than or equal to the target quantity of bits for the current slice (e.g., whether the expression bitPredicted+max(rightBit, bitPredicted)+codedSliceBit>=targetSliceBit evaluates to true) (4106). If the expression evaluates to true (“Yes” branch of 4106), video encoder 20 may set the value of a decideSlice variable to 1 (4108). If the value of the exceedSlice variable is equal to zero (“No” branch of 4104), video encoder 20 may determine whether a sum of the quantity of bits predicted to encode the current LCU and the quantity of bits already used to encode the current slice is greater than or equal to the target quantity of bits for the current slice (e.g., whether the expression bitPredicted+codedSliceBit>=targetSliceBit evaluates to true) (4110). If the expression evaluates to true (“Yes” branch of 4110), video encoder 20 may set the value of a decideSlice variable to 1 (4112). If the expression does not evaluate to true (“No” branch of 4110), video encoder 20 may determine whether a sum of the quantity of bits predicted to encode the current LCU, the quantity of bits already used to encode the current slice, and the quantity of bits predicted to encode the next LCU is greater than or equal to the target quantity of bits for the current slice (e.g., whether the expression bitPredicted+codedSliceBit+rightBit>=targetSliceBit evaluates to true) (4114). If the expression evaluates to true (“Yes” branch of 4114), video encoder 20 may set the value of a decideSlice variable to 1 (4116).

As discussed above, video encoder 20 may then perform the slice decision in accordance with the techniques of FIG. 42. As illustrated in FIG. 42, video encoder 20 may determine whether the decideSlice variable is one or the quantity of bits used to encode the current slice is greater than or equal to the target quantity of bits for the current slice (4202). If the decideSlice variable is one or the quantity of bits used to encode the current slice is greater than or equal to the target quantity of bits for the current slice (“Yes” branch of 4202), video encoder 20 may advance to the next slice and initialize one or more variables for the next slice (4204). If the decideSlice variable is zero and the quantity of bits used to encode the current slice is not greater than or equal to the target quantity of bits for the current slice (“No” branch of 4202), video encoder 20 may advance to the next LCU.

As discussed above, in some examples, video encoder 20 may perform bit prediction using NNZ in accordance with the techniques of FIG. 43. As illustrated in FIG. 43, video encoder 20 may quantize a previous LCU (e.g., LCU n-d) (4302). Video encoder 20 may determine a number of transform units in the previous LCU that have non-zero transform coefficients. Video encoder 20 may then update a bit-NNZ model based on the determined number of transform units in the previous LCU that have non-zero transform coefficients (4304). In some examples, the bit-NNZ model may also be updated based on a quantity of bits or bins received from video signal processor (VSP) (4306).

When processing a subsequent LCU (e.g., LCU n), video encoder 20 may perform quantization to determine a quantity of non-zero transform units in the subsequent LCU (4308). Video encoder 20 may use bit-NNZ model as updated by the previous LCU and/or the determined quantity of non-zero transform units in the subsequent LCU (4310) to predict a quantity of bits to encode the subsequent LCU (e.g., LCU n) (4312). As discussed above, video encoder 20 may use the predicted quantity of bits to perform rate control or slicing for the current LCU (4314).

In some examples, the Bit-NNZ model may be a linear model. An example linear model for Bit-NNZ is Bit=A NNZ, where NNZ is the number of nonzero quantized coefficient of each LCU (p of each LCU) which may be 11 bits. InvNNZ may be the inverse of NNZ which may be shifted to maximal 16 bit. Video encoder 20 may use InvNNZ to update parameter A which may be 16 bits. In some examples, such as where the value of NNZ is larger than 256, video encoder 20 may not use NNZ to update A. In some examples, encoder 20 may left shift A by a number of bits (e.g., 8) for precision. In equation form, A=(Bit*InvNNZ)>>8. Therefore, the predicted bit may be PredBit=(A*NNZ)>>8.

In some examples, TRE of video encoder 20 may track the slice boundary for each LCU and may detect the availabilities of its neighbors to do mode correction and MVP correction. Then TRE will pass these availabilities to FE.

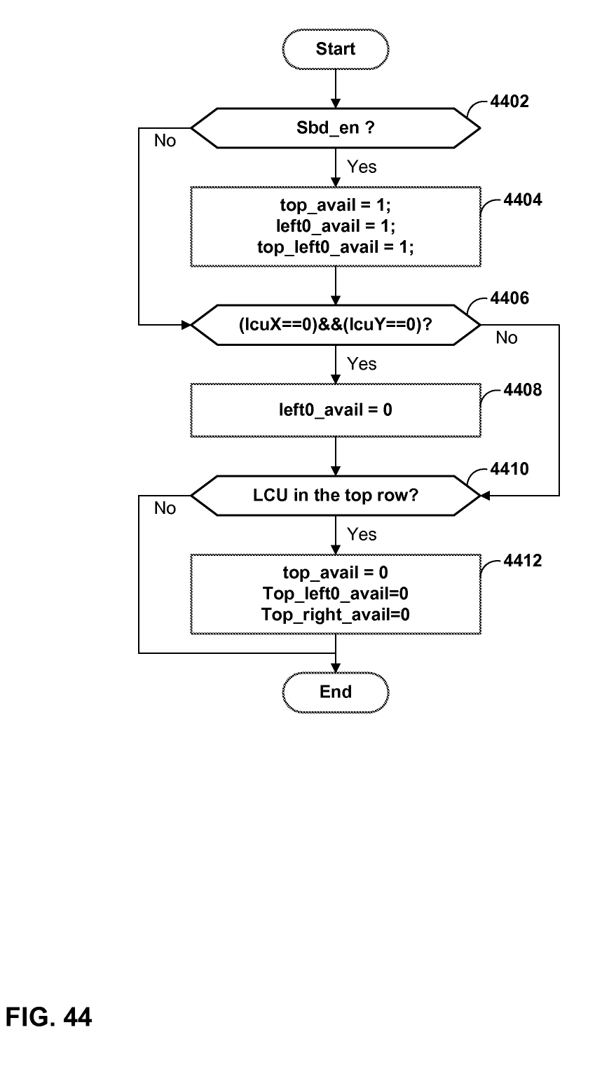

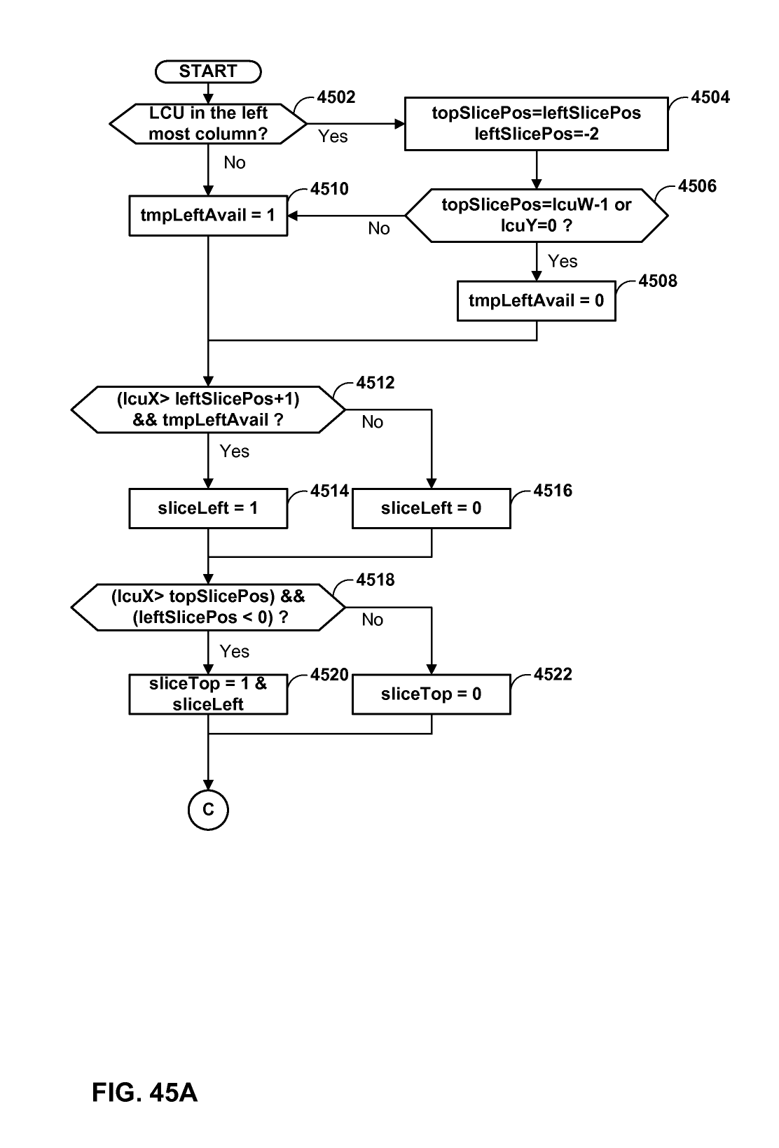

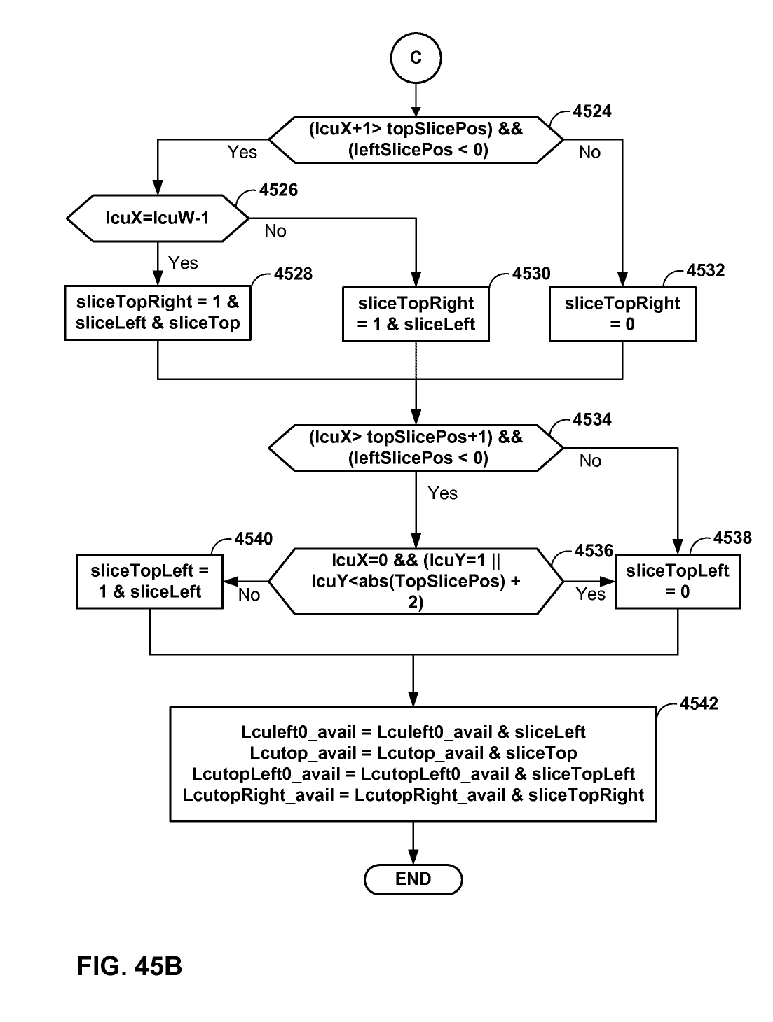

In some examples, at the beginning of TRE, video encoder 20 may initialize the LCU neighbor availability. In some examples, top_avail is top LCU availability; left0_avail is left LCU availability; top_left0_avail is top−left LCU availability; top_right_avail is top-right LCU availability; leftSlicePos is Left slice position; and topSlicePos is top slice position. In some examples, video encoder 20 may initialize the LCU neighbor availability in accordance with the technique illustrated in FIG. 44. In some examples, video encoder 20 may determine the availability of the LCU neighbors in accordance with the technique illustrated in FIGS. 45A-45B. In some examples, there may be 4 flags for topLeft, top, left and topRight that may be sent to a filter engine.

As discussed above, in some examples, video encoder 20 may initialize the LCU neighbor availability in accordance with the technique illustrated in FIG. 44. For instance, video encoder may initialize a flag for one or more of the following neighboring LCUs: a top LCU (e.g., top_avail), a top left LCU (e.g., top_left0_avail), a left LCU (e.g., left0_avail), and a top right LCU (e.g., top_right_avail).

As illustrated in FIG. 44, video encoder 20 may determine whether the slice boundary decision process is enabled (4402). If the slice boundary decision process is enabled, video encoder 20 may initialize one or more of the flags that indicates whether the neighboring LCUs are available (4404), and determine whether the current LCU is in the top left corner of the current frame (4406). For instance, video encoder 20 may initialize the flags for the top LCU, the left LCU, and the top left LCU to one.

If the current LCU is in the top left corner of the current frame (“Yes” branch of 4406), video encoder 20 may initialize the flag for the left LCU to zero (4408), and determine whether the current LCU is in the top row (4410). If the current LCU is not in the top left corner of the current frame (“No” branch of 4406), video encoder 20 may determine whether the current LCU is in the top row (4410).

If the current LCU is in the top row (“Yes” branch of 4410), video encoder 20 may initialize the flags for the top LCU, the top left LCU, and the top right LCU to zero (4412) and complete initialization of neighboring LCU availability. If the current LCU is not in the top row (“No” branch of 4410), video encoder 20 may complete initialization of neighboring LCU availability.

As discussed above, in some examples, video encoder 20 may determine the availability of the LCU neighbors in accordance with the technique illustrated in FIGS. 45A-45B. As illustrated in FIG. 45A, video encoder 20 may determine whether the current LCU is in the left most column (4502). If the current LCU is in the left most column (“Yes” branch of 4502), video encoder 20 may determine that the top slice position (e.g., topSlicePos) is the left slice position (e.g., leftSlicePos) that the left slice position is minus two (4504), and determine whether the current LCU is in the top row or the top slice position equals the width of the slice in integer LCUs less one (4506). If the current LCU is in the top row or the top slice position equals the width of the slice in integer LCUs less one (“Yes” branch of 4506), video encoder 20 may determine that the tmpLeftAvail is zero (4508), and determine whether the column index of the current LCU is greater than the left slice position plus one and the tmpLeftAvail is greater than zero (4512). If the current LCU is both not in the top row and the top slice position does not equal the width of the slice in integer LCUs less one (“No” branch of 4506), video encoder 20 may determine the tmpLeftAvail is one (4510), and determine whether the column index of the current LCU is greater than the left slice position plus one and the tmpLeftAvail is greater than zero (4512). If the current LCU is not in the left most column (“No” branch of 4502), video encoder 20 may determine the tmpLeftAvail is one (4510), and determine whether the column index of the current LCU is greater than the left slice position plus one and the tmpLeftAvail is greater than zero (4512).

If the column index of the current LCU is greater than the left slice position plus one and the tmpLeftAvail is greater than zero (“Yes” branch of 4512), video encoder 20 may determine that the left slice is available (4514), and determine whether the column index of the current LCU is greater than the top slice position and whether the left slice position is less than zero (4518). If either the column index of the current LCU is not greater than the left slice position plus one or if the tmpLeftAvail is not greater than zero (“No” branch of 4512), video encoder 20 may determine that the left slice is not available (4516), and determine whether the column index of the current LCU is greater than the top slice position and whether the left slice position is less than zero (4518).

If the column index of the current LCU is greater than the top slice position and whether the left slice position is less than zero (“Yes” branch of 4518), video encoder 20 may determine that the top slice is available if the left slice is available (4520), and (advancing through “C” to FIG. 45B) determine whether the column index of the current LCU plus one is greater than the top slice position and whether the left slice position is less than zero (4524). If the column index of the current LCU is either not greater than the top slice position or the left slice position is not less than zero (“No” branch of 4518), video encoder 20 may determine that the top slice is not available (4522), and (advancing through “C” to FIG. 45B) determine whether the column index of the current LCU plus one is greater than the top slice position and whether the left slice position is less than zero (4524).

If the column index of the current LCU plus one is greater than the top slice position and the left slice position is less than zero (“Yes” branch of 4524), video encoder 20 may determine whether the current LCU is in the right most column (e.g., whether lcuX equals lcuW−1) (4526). If the current LCU is in the right most column (“Yes” branch of 4526), video encoder 20 may determine that the top right slice is available if the left slice and the top slice are both available (4528), and determine whether the column index of the current LCU is greater than the top slice position plus one and whether the left slice position is less than zero (4534). If the current LCU is not in the right most column (“No” branch of 4526), video encoder 20 may determine that the top right slice is available if the left slice is available (4530), and determine whether the column index of the current LCU is greater than the top slice position plus one and whether the left slice position is less than zero (4534). If either the column index of the current LCU plus one is not greater than the top slice position or the left slice position is not less than zero (“No” branch of 4524), video encoder 20 may determine that the top right slice is not available (4532), and determine whether the column index of the current LCU is greater than the top slice position plus one and whether the left slice position is less than zero (4534).

If the column index of the current LCU is not greater than the top slice position plus one or the left slice position is not less than zero (“No” branch of 4534), video encoder 20 may determine that the top left slice is not available (4538). If the column index of the current LCU is greater than the top slice position plus one and the left slice position is less than zero (“Yes” branch of 4534), video encoder 20 may determine whether the current LCU is in the left most column and either the current LCU is in the second row from the top (e.g., whether lcuY equals one) or the row index of the current LCU is less than the absolute top slice position plus two (e.g., whether lcuY<absTopSlicePos+2) (4536). If the current LCU is in the left most column and either the current LCU is in the second row from the top (e.g., whether lcuY equals one) or the row index of the current LCU is less than the absolute top slice position plus two (e.g., whether lcuY<absTopSlicePos+2) (“Yes” branch of 4536), video encoder 20 may determine that the top left slice is not available (4538). If the current LCU is either not in the left most column or the current LCU is not in the second row from the top (e.g., whether lcuY equals one) and the row index of the current LCU is not less than the absolute value of the top slice position plus two (e.g., whether lcuY<abs(TopSlicePos)+2) (“No” branch of 4536), video encoder 20 may determine that the top left slice is available if the left slice is available (4540).

In any case, video encoder 20 may determine whether the left, top, top left, and top right LCUs are available based on the availability of the corresponding slices and the initialization states of the LCUs (4542). For instance, video encoder 20 may determine that: the left LCU is available if the left slice is available and the left LCU was initialized as available, the top LCU is available if the top slice is available and the top LCU was initialized as available, the top left LCU is available if the top left slice is available and the top left LCU was initialized as available, the top right LCU is available if the top right slice is available and the top right LCU was initialized as available.

As discussed above, the techniques shown in FIGS. 4-45B may be incorporated in, or implemented by video encoder 20, video decoder 30, or a variety of other processor(s) configured for coding video data. For example, as noted above, video encoder 20 (or one or more units of video encoder 20, such as quantization unit 54) may implement the techniques shown and described with respect to FIG. 4-45B to perform rate control in video encoding.

According to a first example of this disclosure, the complexity of each hierarchical level may be used to allocate bits to each frame, where the complexity is based on the coded bits and QP of previous coded same level frame, and may be updated frame to frame.

According to a second example of this disclosure, a temporal complexity calculation may be used for bit and remaining bit allocation to each LCU based on the complexity of LCUs in previous frame.

In this way, a video encoder performing one or more techniques of this disclosure may not only consider the coded LCUs but may also consider the content of remaining LCUs. The rate-distortion (RD) cost may be used to measure the complexity which may include both the header and texture information. This complexity may be computed during MEC itself, therefore may not increase the computation cost or time. The ratio between the complexities of collocated LCU and collocated remaining LCUs in previous frame may be used to allocate the bits of current LCU, which may avoid the impact of different hierarchical level. The RD cost of previous frame may be used instead of the previous frame in the same level, because of the following two reasons: firstly, it can save storage cost of the complexity of each frame in each level and may avoid access cost for hardware implementation. Secondly, the previous frame may be closer than the previous frame in the same level, for one LCU, the content in near frame may be more similar than that in faraway frames. This may reduce the impact of motion and scene change.

According to a third aspect of this disclosure, a content adaptive QP determination may be made based on the content similarity of each LCU

Different from those methods using RD model to model the relationship between rate and QP, and using previous coded LCUs to update the parameters irrespective of their similarity in the content. In some examples, “similar LCU” may be determined and may be used as a reference LCU to determine the QP for a current LCU. “Similar LCU or Reference LCU” may be determined by determining availability and comparing the complexity of each neighbor. The complexity parameter is a measurement of video content and the cost to encode the content using current codec. A neighbor may be determined “available” if it is not skipped or IPCM. Then, from the available neighbors, the one with minimum complexity difference may be determined as the most similar LCU, which may act as a reference for current LCU. After that, the ratio of the bits per complexity information of current LCU and its reference LCU may be used to determine the QP of the current LCU. This method may increase the adaptation of QP determination according to the content of different LCUs. In case of non-availability of all its neighbors, the average bit per complexity of the whole frame may be used to determine the QP of current LCU.

According to a fourth aspect of this disclosure, the complexity reference frame used may be determined based on the encoding type (intra or inter) of the current frame. The previous frame of I frame is B frame and the previous available I frame may be very far away in the sequence. The collocated LCU may be totally different when these two I frames are far away. So the estimation may be inaccurate for both the cases of either using previous B frame LCU complexity or using previous I frame LCU complexity. Further, for frame level rate allocation, the previous I frame complexity may be used to allocate the bits to current frame, which may introduce error because the content of these I frames may be quite different due to their distance in the video sequence.

Therefore, the RD cost of best intra mode cost other than the best mode of previous frame (B or P frame) may be used as the reference for current I frame. This may not result in an increase of the complexity because it may be directly computed during MEC. With this frame complexity information, the reference frame may be the previous frame of current frame. This frame complexity may be used to allocate the bits for each LCU in current I frame. This may decrease the mismatch between current frame and reference frame.

Also the frame level I frame complexity may be adjusted by the accumulated complexity of the best intra mode RD cost of previous frame. This may lead to more accurate bit allocation for current I frame. After the bits are allocated to current I frame, because the R-ρ model is based on previous I frame, the R-ρ model parameter may also be adjusted using the complexity of previous frame to achieve a more accurate QP for current I frame.

According to a fifth aspect of this disclosure, QP determination may be selectively enabled for LCUs on an as-needed basis to save computational cost and power.

For example, based on the number of non-zero LCUs in the (previous) frame, firmware may determine a row number called “Start line”, which may act as starting point for enabling QP determination for current frame. For the rows before the start line, the QP determination may be enabled only if the estimated error crosses a threshold. In addition, QP determination may also be split into two stages—QP estimation and QP calculation. QP calculation may be enabled if certain flags of QP estimation process are set. These two schemes may help in shutting down certain stages of QP determination to save computational cost which may enable savings in terms of power consumption during hardware implementation.

According to a sixth aspect of this disclosure, information from rate control may be used to perform accurate byte-based slicing.

The rate control algorithm may provide the complexity and bits of its neighbors as well as the collocated complexity. This information along with the feedback to rate control may be used to adjust the QP according to bit usage in one slice. In this way, more accurate byte based slicing may be achieved.

### Example 1

A method of encoding video data, the method comprising: allocating, based on a complexity of a reference frame and a quantity of bits allocated to a current frame, a quantity of bits to a current largest coding unit (LCU) included in the current frame; determining, based on the quantity of bits allocated to the current LCU, a quantization parameter (QP) for the current LCU; and encoding the current LCU with the determined QP.

### Example 2

The method of example 1, wherein allocating the quantity of bits to the current LCU comprises: determining a ratio of a complexity value of an LCU of a complexity reference frame to a complexity value of the LCUs remaining in the complexity reference frame; and allocating the quantity of bits to the current LCU based on the determined ratio, wherein the LCU of the complexity reference frame is collocated with the current LCU.

### Example 3

The method of any combination of examples 1-2, wherein allocating the quantity of bits to the current LCU further comprises allocating the quantity of bits to the current LCU based on: the determined ratio; a target quantity of bits for the current frame; and a quantity of bits already used to code the current frame.

### Example 4

The method of any combination of examples 1-3, wherein the complexity reference frame is a previous frame.

### Example 5

The method of any combination of examples 1-4, further comprising: responsive to determining that the current frame is a first I frame, determining that the QP for the current LCU is a QP for the current frame; responsive to determining that the current frame is a first B frame after an I frame, using a previous B frame as the complexity reference frame; responsive to determining that the current frame is an I frame other than a first I frame, using a best intra mode of the previous B frame as the complexity reference frame; and responsive to determining that the current frame is a B frame other than a first B frame after an I frame, using the previous B frame as the complexity reference frame;

### Example 6

The method of any combination of examples 1-5, wherein determining the QP for the current LCU further comprises determining the QP for the current LCU based on: the complexity value of the LCU of the complexity reference frame; the quantity of bits allocated to the current LCU; a complexity value of a reference LCU of the current frame; and a quantity of bits used to code the reference LCU of the current frame.

### Example 7

The method of any combination of examples 1-6, further comprising: determining a complexity difference between the current LCU and at least one candidate LCU of a group of candidate LCUs from neighboring LCUs; and selecting the candidate LCU of the group of candidate LCUs with the lowest complexity difference as the reference LCU.

### Example 8

The method of any combination of examples 1-7, wherein the group of candidate LCUs comprises one or more of: an LCU positioned on the top of the current LCU; an LCU positioned on the top-right of the current LCU; and an LCU positioned on the top-left of the current LCU.

### Example 9

The method of any combination of examples 1-8, further comprising wherein determining the group of candidate LCUs by: determining whether an LCU from the group of candidate LCUs is available for use as the reference LCU; and in response to determining that the LCU is not available for use as a reference LCU, not using the LCU as the reference LCU.

### Example 10

The method of any combination of examples 1-9, further comprising: determining a quantity of non-zero LCUs in a line of the complexity reference frame; determining a start line based on the quantity; and responsive to determining that the current LCU is positioned above the start line in the current frame, determining that the QP for the current LCU is a QP for the current frame.

### Example 11

The method of any combination of examples 1-10, further comprising determining the quantity of bits allocated to the current frame by: allocating, based on the complexity of frames from a plurality of hierarchical layers, the quantity of bits to the current frame.

### Example 12

The method of any combination of examples 1-11, further comprising: determining, based on a quantity of bits used to encode a reference LCU, a predicted quantity of bits to encode the current LCU; responsive to determining that the predicted quantity of bits to encode the current LCU is greater than a target quantity of bits allocated to a current slice, determining that the current LCU is expected to exceed a slice boundary, wherein the current LCU is included in the current slice; and responsive to determining that the current LCU is expected to exceed the slice boundary, adjusting the QP for the current LCU such that the current LCU does not exceed the slice boundary estimate.

### Example 13

A device for encoding video data, the device comprising a video encoder configured to: allocate, based on a complexity of a reference frame and a quantity of bits allocated to a current frame, a quantity of bits to a current largest coding unit (LCU) included in the current frame; determine, based on the quantity of bits allocated to the current LCU, a quantization parameter (QP) for the current LCU; and encode the current LCU with the determined QP.

### Example 14

The device of example 13, wherein allocating the quantity of bits to the current LCU comprises: determining a ratio of a complexity value of an LCU of a complexity reference frame to a complexity value of the LCUs remaining in the complexity reference frame; allocating the quantity of bits to the current LCU based on the determined ratio, wherein the LCU of the complexity reference frame is collocated with the current LCU.

### Example 15

The device of any combination of examples 13-14, wherein allocating the quantity of bits to the current LCU further comprises allocating the quantity of bits to the current LCU based on: the determined ratio; a target quantity of bits for the current frame; and a quantity of bits already used to code the current frame.

### Example 16

The device of any combination of examples 13-15, wherein the complexity reference frame is a previous frame.

### Example 17

The device of any combination of examples 13-16, further comprising: responsive to determining that the current frame is a first I frame, determining that the QP for the current LCU is a QP for the current frame; responsive to determining that the current frame is a first B frame after an I frame, using a previous B frame as the complexity reference frame; responsive to determining that the current frame is an I frame other than a first I frame, using a best intra mode of the previous B frame as the complexity reference frame; and responsive to determining that the current frame is a B frame other than a first B frame after an I frame, using the previous B frame as the complexity reference frame;

### Example 18

The device of any combination of examples 13-17, wherein determining the QP for the current LCU further comprises determining the QP for the current LCU based on: the complexity value of the LCU of the complexity reference frame; the quantity of bits allocated to the current LCU; a complexity value of a reference LCU of the current frame; and a quantity of bits used to code the reference LCU of the current frame.

### Example 19

The device of any combination of examples 13-18, further comprising: determining a complexity difference between the current LCU and at least one candidate LCU of a group of candidate LCUs from neighboring LCUs; and selecting the candidate LCU of the group of candidate LCUs with the lowest complexity difference as the reference LCU.

### Example 20

The device of any combination of examples 13-19, wherein the group of candidate LCUs comprises one or more of: an LCU positioned on the top of the current LCU; an LCU positioned on the top-right of the current LCU; and an LCU positioned on the top-left of the current LCU.

### Example 21

The device of any combination of examples 13-20, further comprising wherein determining the group of candidate LCUs by: determining whether an LCU from the group of candidate LCUs is available for use as the reference LCU; and in response to determining that the LCU is not available for use as a reference LCU, not using the LCU as the reference LCU.

### Example 22

The device of any combination of examples 13-21, further comprising: determining a quantity of non-zero LCUs in a line of the complexity reference frame; determining a start line based on the quantity; and responsive to determining that the current LCU is positioned above the start line in the current frame, determining that the QP for the current LCU is a QP for the current frame.

### Example 23

The device of any combination of examples 13-22, further comprising determining the quantity of bits allocated to the current frame by: allocating, based on the complexity of frames from a plurality of hierarchical layers, the quantity of bits to the current frame.

### Example 24

The device of any combination of examples 13-23, further comprising: determining, based on a quantity of bits used to encode a reference LCU, a predicted quantity of bits to encode the current LCU; responsive to determining that the predicted quantity of bits to encode the current LCU is greater than a target quantity of bits allocated to a current slice, determining that the current LCU is expected to exceed a slice boundary, wherein the current LCU is included in the current slice; and responsive to determining that the current LCU is expected to exceed the slice boundary, adjusting the QP for the current LCU such that the current LCU does not exceed the slice boundary estimate.

### Example 25

A device for encoding video data, the device comprising: means for allocating, based on a complexity of a reference frame and a quantity of bits allocated to a current frame, a quantity of bits to a current largest coding unit (LCU) included in the current frame; means for determining, based on the quantity of bits allocated to the current LCU, a quantization parameter (QP) for the current LCU; and means for encoding the current LCU with the determined QP.

### Example 26

The device of example 25, wherein the means for allocating the quantity of bits to the current LCU comprise: means for determining a ratio of a complexity value of an LCU of a complexity reference frame to a complexity value of the LCUs remaining in the complexity reference frame; and means for allocating the quantity of bits to the current LCU based on the determined ratio, wherein the LCU of the complexity reference frame is collocated with the current LCU.

### Example 27

The device of any combination of examples 25-26, further comprising means for performing any combination of the methods of examples 3-12.

### Example 28

A computer-readable storage medium having stored thereon instructions that, when executed, cause one or more processors to: allocate, based on a complexity of a reference frame and a quantity of bits allocated to a current frame, a quantity of bits to a current largest coding unit (LCU) included in the current frame; determine, based on the quantity of bits allocated to the current LCU, a quantization parameter (QP) for the current LCU; and encode the current LCU with the determined QP.

### Example 29

The computer-readable storage medium of example 28, wherein the instructions that cause the one or more processors to allocate the quantity of bits to the current LCU comprise instructions that cause the one or more processors to: determine a ratio of a complexity value of an LCU of a complexity reference frame to a complexity value of the LCUs remaining in the complexity reference frame; and allocate the quantity of bits to the current LCU based on the determined ratio, wherein the LCU of the complexity reference frame is collocated with the current LCU.

### Example 30

The computer-readable storage medium of any combinations of examples 28-29, wherein the computer-readable has further stored instructions that cause the one or more processors to perform any combination of the methods of examples 3-12.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Certain aspects of this disclosure have been described with respect to the developing HEVC standard for purposes of illustration. However, the techniques described in this disclosure may be useful for other video coding processes, including other standard or proprietary video coding processes not yet developed.

The techniques described above may be performed by video encoder 20 (FIGS. 1 and 2) and/or video decoder 30 (FIGS. 1 and 3), both of which may be generally referred to as a video coder. Likewise, video coding may refer to video encoding or video decoding, as applicable.

It should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

What is claimed is:

1. A method of encoding video data, the method comprising:
allocating, based on a complexity of a reference frame and a quantity of bits allocated to a current frame, a quantity of bits to a current largest coding unit (LCU) included in the current frame;
determining, based on the quantity of bits allocated to the current LCU, a quantization parameter (QP) for the current LCU; and
encoding the current LCU with the determined QP.

2. The method of claim 1, wherein allocating the quantity of bits to the current LCU comprises:
determining a ratio of a complexity value of an LCU of a complexity reference frame to a complexity value of the LCUs remaining in the complexity reference frame; and
allocating the quantity of bits to the current LCU based on the determined ratio, wherein the LCU of the complexity reference frame is collocated with the current LCU.

3. The method of claim 2, wherein allocating the quantity of bits to the current LCU further comprises allocating the quantity of bits to the current LCU based on:
the determined ratio;
a target quantity of bits for the current frame; and
a quantity of bits already used to code the current frame.

4. The method of claim 2, wherein the complexity reference frame is a previous frame.

5. The method of claim 2, further comprising:
responsive to determining that the current frame is a first I frame, determining that the QP for the current LCU is a QP for the current frame;
responsive to determining that the current frame is a first B frame after an I frame, using a previous B frame as the complexity reference frame;
responsive to determining that the current frame is an I frame other than a first I frame, using a best intra mode of the previous B frame as the complexity reference frame; and
responsive to determining that the current frame is a B frame other than a first B frame after an I frame, using the previous B frame as the complexity reference frame.

6. The method of claim 2, wherein determining the QP for the current LCU further comprises determining the QP for the current LCU based on:
the complexity value of the LCU of the complexity reference frame;
the quantity of bits allocated to the current LCU;
a complexity value of a reference LCU of the current frame; and
a quantity of bits used to code the reference LCU of the current frame.

7. The method of claim 6, further comprising:
determining a complexity difference between the current LCU and at least one candidate LCU of a group of candidate LCUs from neighboring LCUs; and
selecting the candidate LCU of the group of candidate LCUs with the lowest complexity difference as the reference LCU.

8. The method of claim 7, wherein the group of candidate LCUs comprises one or more of:
an LCU positioned on the top of the current LCU;
an LCU positioned on the top-right of the current LCU; and
an LCU positioned on the top-left of the current LCU.

9. The method of claim 8, further comprising wherein determining the group of candidate LCUs by:
determining whether an LCU from the group of candidate LCUs is available for use as the reference LCU; and
in response to determining that the LCU is not available for use as a reference LCU, not using the LCU as the reference LCU.

10. The method of claim 2, further comprising:
determining a quantity of non-zero LCUs in a line of the complexity reference frame;
determining a start line based on the quantity; and
responsive to determining that the current LCU is positioned above the start line in the current frame, determining that the QP for the current LCU is a QP for the current frame.

11. The method of claim 1, further comprising determining the quantity of bits allocated to the current frame by:
allocating, based on the complexity of frames from a plurality of hierarchical layers, the quantity of bits to the current frame.

12. The method of claim 1, further comprising:
determining, based on a quantity of bits used to encode a reference LCU, a predicted quantity of bits to encode the current LCU;
responsive to determining that the predicted quantity of bits to encode the current LCU is greater than a target quantity of bits allocated to a current slice, determining that the current LCU is expected to exceed a slice boundary, wherein the current LCU is included in the current slice; and
responsive to determining that the current LCU is expected to exceed the slice boundary, adjusting the QP for the current LCU such that the current LCU does not exceed the slice boundary estimate.

13. A device for encoding video data, the device comprising a video encoder configured to:
allocate, based on a complexity of a reference frame and a quantity of bits allocated to a current frame, a quantity of bits to a current largest coding unit (LCU) included in the current frame;
determine, based on the quantity of bits allocated to the current LCU, a quantization parameter (QP) for the current LCU; and
encode the current LCU with the determined QP.

14. The device of claim 13, wherein allocating the quantity of bits to the current LCU comprises:
determining a ratio of a complexity value of an LCU of a complexity reference frame to a complexity value of the LCUs remaining in the complexity reference frame;
allocating the quantity of bits to the current LCU based on the determined ratio, wherein the LCU of the complexity reference frame is collocated with the current LCU.

15. The device of claim 14, wherein allocating the quantity of bits to the current LCU further comprises allocating the quantity of bits to the current LCU based on:
the determined ratio;
a target quantity of bits for the current frame; and
a quantity of bits already used to code the current frame.

16. The device of claim 14, wherein the complexity reference frame is a previous frame.

17. The device of claim 14, further comprising:
responsive to determining that the current frame is a first I frame, determining that the QP for the current LCU is a QP for the current frame;
responsive to determining that the current frame is a first B frame after an I frame, using a previous B frame as the complexity reference frame;
responsive to determining that the current frame is an I frame other than a first I frame, using a best intra mode of the previous B frame as the complexity reference frame; and
responsive to determining that the current frame is a B frame other than a first B frame after an I frame, using the previous B frame as the complexity reference frame.

18. The device of claim 14, wherein determining the QP for the current LCU further comprises determining the QP for the current LCU based on:
the complexity value of the LCU of the complexity reference frame;
the quantity of bits allocated to the current LCU;
a complexity value of a reference LCU of the current frame; and
a quantity of bits used to code the reference LCU of the current frame.

19. The device of claim 18, further comprising:
determining a complexity difference between the current LCU and at least one candidate LCU of a group of candidate LCUs from neighboring LCUs; and
selecting the candidate LCU of the group of candidate LCUs with the lowest complexity difference as the reference LCU.

20. The device of claim 19, wherein the group of candidate LCUs comprises one or more of:
an LCU positioned on the top of the current LCU;
an LCU positioned on the top-right of the current LCU; and
an LCU positioned on the top-left of the current LCU.

21. The device of claim 20, further comprising wherein determining the group of candidate LCUs by:
determining whether an LCU from the group of candidate LCUs is available for use as the reference LCU; and
in response to determining that the LCU is not available for use as a reference LCU, not using the LCU as the reference LCU.

22. The device of claim 14, further comprising:
determining a quantity of non-zero LCUs in a line of the complexity reference frame;
determining a start line based on the quantity; and
responsive to determining that the current LCU is positioned above the start line in the current frame, determining that the QP for the current LCU is a QP for the current frame.

23. The device of claim 13, further comprising determining the quantity of bits allocated to the current frame by:
allocating, based on the complexity of frames from a plurality of hierarchical layers, the quantity of bits to the current frame.

24. The device of claim 13, further comprising:
determining, based on a quantity of bits used to encode a reference LCU, a predicted quantity of bits to encode the current LCU;
responsive to determining that the predicted quantity of bits to encode the current LCU is greater than a target quantity of bits allocated to a current slice, determining that the current LCU is expected to exceed a slice boundary, wherein the current LCU is included in the current slice; and
responsive to determining that the current LCU is expected to exceed the slice boundary, adjusting the QP for the current LCU such that the current LCU does not exceed the slice boundary estimate.

25. A device for encoding video data, the device comprising:
means for allocating, based on a complexity of a reference frame and a quantity of bits allocated to a current frame, a quantity of bits to a current largest coding unit (LCU) included in the current frame;
means for determining, based on the quantity of bits allocated to the current LCU, a quantization parameter (QP) for the current LCU; and
means for encoding the current LCU with the determined QP.

26. The device of claim 25, wherein the means for allocating the quantity of bits to the current LCU comprise:
means for determining a ratio of a complexity value of an LCU of a complexity reference frame to a complexity value of the LCUs remaining in the complexity reference frame; and
means for allocating the quantity of bits to the current LCU based on the determined ratio, wherein the LCU of the complexity reference frame is collocated with the current LCU.

27. The device of claim 26, wherein the means for determining the QP for the current LCU comprise means for determining the QP for the current LCU based on:
the complexity value of the LCU of the complexity reference frame;
the quantity of bits allocated to the current LCU;
a complexity value of a reference LCU of the current frame; and
a quantity of bits used to code the reference LCU of the current frame.

28. A computer-readable storage medium having stored thereon instructions that, when executed, cause one or more processors to:
allocate, based on a complexity of a reference frame and a quantity of bits allocated to a current frame, a quantity of bits to a current largest coding unit (LCU) included in the current frame;
determine, based on the quantity of bits allocated to the current LCU, a quantization parameter (QP) for the current LCU; and
encode the current LCU with the determined QP.

29. The computer-readable storage medium of claim 28, wherein the instructions that cause the one or more processors to allocate the quantity of bits to the current LCU comprise instructions that cause the one or more processors to:
determine a ratio of a complexity value of an LCU of a complexity reference frame to a complexity value of the LCUs remaining in the complexity reference frame; and
allocate the quantity of bits to the current LCU based on the determined ratio, wherein the LCU of the complexity reference frame is collocated with the current LCU.

30. The computer-readable storage medium of claim 29, wherein the instructions that cause the one or more processors to determine the QP for the current LCU comprise instructions that cause the one or more processors to determine the QP for the current LCU based on:
the complexity value of the LCU of the complexity reference frame;
the quantity of bits allocated to the current LCU;
a complexity value of a reference LCU of the current frame; and
a quantity of bits used to code the reference LCU of the current frame.
